(19) United States
(12) Patent Application Publication
(10) Pub. No.: US 2013/0302765 A1
(43) Pub. Date: Nov. 14, 2013

(54) METHODS AND SYSTEMS FOR ASSESSING AND DEVELOPING THE MENTAL ACUITY AND BEHAVIOR OF A PERSON

(71) Applicants: Mark Mangum, Austin, TX (US); Lew Williams, Austin, TX (US); Richard Daniels, St. David's, PA (US); Nancy Olsen, Austin, TX (US)

(72) Inventors: Mark Mangum, Austin, TX (US); Lew Williams, Austin, TX (US); Richard Daniels, St. David's, PA (US); Nancy Olsen, Austin, TX (US)

(21) Appl. No.: 13/862,279

(22) Filed: Apr. 12, 2013

Related U.S. Application Data
(63) Continuation of application No. 13/746,285, filed on Jan. 21, 2013.
(60) Provisional application No. 61/646,231, filed on May 11, 2012.

(51) Int. Cl. G09B 19/00

(52) U.S. Cl. CPC G09B 19/00
USPC 434/236

(57) ABSTRACT

Methods and systems for assessing and developing the mental acuity and behavior of a person are provided. A method of assessing mental acuity and character can include using a computer system to executing user interactive exercises involving the use of at least one of visual acuity skills, operational thinking skills and behavioral skills of the user. During execution of each user interactive exercise, the computer system can receive user inputs including body movement of a user and touch interaction between the user and a user interface in communication with the computer system. The computer system can measure and record performance data related to the timing and accuracy of the user inputs in each user interactive exercise. The computer system can processes the performance data to generate scores in assessment categories that provide measurements of at least one of the visual acuity skills, operational thinking skills and behavioral skills of the user. Computer systems and memory devices for implementing the disclosed methods are also disclosed.

### CROSS-REFERENCE TO RELATED APPLICATIONS

This application is a continuation application of U.S. patent application Ser. No. 13/746,285, filed on Jan. 21, 2013, and claims the benefit of U.S. Provisional Patent Application No. 61/589,230, filed on Jan. 20, 2012 and U.S. Provisional Patent Application No. 61/646,231 filed on May 11, 2012, the entire disclosures of which are incorporated herein by reference as if set forth in full herein.

### BACKGROUND

Knowing how to understand and develop a person mentally is critical to maximizing that person's performance in athletic professions, other professions educational environments. In athletic professions and activities, players' physical abilities are known and cross checked thoroughly. Height, weight, speed, agility, strength and skill are precisely measured and benchmarked continuously. However, in order to fully maximize an athlete's physical skills we must first know how the athlete acquires and applies instructional information (i.e., how the athlete learns). To be more specific, we must know how that athlete defines, processes and executes information and instruction.

In the National Football League (NFL), for example, players are analyzed based on three areas:
1) Skill—the physical ability, knowledge and capacity to carry out required responsibilities;
2) Critical Factors—the athletic skills necessary to implement techniques that are required to execute instructions during competition;
3) Mental Acuity and Character—the ability to process instructional information that leads to accurate application under competitive conditions and the ability to emotionally overcome the success or failure of the application, establishing cognitive mental attitude which eliminates distraction in the next phase of future competition or responsibilities.

Mental acuity and character drives and directs performance of skills in application of critical factors necessary to execute technique during competition.

During NFL player analyses, for example, players are graded and acquired according to an anticipated third season's production ratio (the total number of plays a player participates in for an entire season, added to his graded performance in execution of his assignments and divided by two for an entire season), which requires contribution of all three areas described above.

NFL player analyses are merely one example of athlete analyses during which athletes' mental acuity and character come into play. Player analyses in other sports and organizations also depend on athletes' mental acuity and character. Accordingly, it is desirable to provide methods and systems for discovering and assessing an athlete's mental acuity and character and thereby enabling an athlete, the athlete's coaches and the athlete's team to understand how the athlete learns. It is further desirable to provide methods and systems that provide improved development of an athlete's skills based on assessment of the athlete's mental acuity and character.

Furthermore, mental acuity and character also affect the performance of people in many different professions and educational endeavors. Accordingly, it is desirable to provide methods and systems for discovering and assessing a student's or employee's or student's mental acuity and character that enable an employee and the employee's employer and colleagues, or a student and the student's instructors and educational institution, to understand how the employee or student learns for the purpose of providing improved development of the employee's or student's relevant skills.

### SUMMARY

Most athletes who reach peak performance possess elements of superior form of body kinesthetic, which is the ability to acquire and apply knowledge through body movement and sensation. The systematic application of body kinesthetic requires combing an athlete's interpersonal feelings with intrapersonal self-motivation (referred to as behavior or character), with knowledge acquired through linguistics, visual logic and spatial thinking and reasoning (referred to as mental acuity).

The methods and systems disclosed herein assess mental acuity and character. Detailed, analyzed assessments showing how a person defines, processes and executes information and instructions in a complex, competitive and ever-changing environment are provided. These methods and systems are designed to assess an individual's interpersonal and intrapersonal skills in conjunction with their ability to assimilate and correctly apply information needed to function in their specific athletic, professional or educational environment. There is no “pass” or “fail” determination in the disclosed assessment methods and systems. Instead, the disclosed methods and systems are designed to define the best and quickest methods by which a person may acquire and apply instructional information (i.e. how one learns) and how success and failure may affect overall athletic, professional or educational performance. The potential for bias in assessing a person's skills and attributes is greatly reduced or removed using controlled, objective and consistent controls in the measurement of human behavior.

The methods and systems disclosed herein couple advancements in behavioral science, leadership and technology to provide assessments of how a person defines, processes and executes information and instruction. According to an embodiment, an assessment of mental acuity can include an assessment of visual acuity (optional), operational thinking and behavior.
According to an embodiment, an assessment according to the inventions disclosed herein can answer the following questions (among others) about a person's learning characteristics:
Is the person a verbal learner or a visual learner?
How does the person process written instructions?
What is the person's visual acumen in time and space?
How does the person recognize patterns (e.g. a playbook) and once these patterns are reversed, how does the person process and adjust his or her approach?
How does the person handle job-related or field-related problem solving when the solution is unknown and personal judgment and split second decision making become paramount?

According to preferred embodiments, the disclosed systems and methods can implement computer devices such as, but not limited to, tablet PCs (e.g., Apple iPad) with touch screen interfaces, smart phones, or personal computers with touch screen, keyboard, mouse, trackball and/or touchpad interfaces to administer a plurality of interactive, hands-on exercises adapted to assess mental acuity and character. Data from these exercises is collected, measured, reported and stored.

According to an embodiment, a method of assessing mental acuity and character comprises, using a computer system, executing user interactive exercises involving the use of at least one of visual acuity skills, operational thinking skills and behavioral skills of a user. During execution of each user interactive exercise, the computer system receives user inputs including body movement of a user and touch interaction between the user and a user interface in communication with the computer system. The computer system measures and records performance data related to the timing and accuracy of the user inputs in each user interactive exercise, and processes the performance data to generate scores in assessment categories that provide measurements of at least one of the visual acuity skills, operational thinking skills and behavioral skills of the user.

According to another embodiment, a programmable computer memory comprises stored instructions executable to conduct user interactive exercises involving the use of at least one of visual acuity skills, operational thinking skills and behavioral skills of a user. While each user interactive exercise is conducted, the instructions are executable to process user inputs including body movement of the user and touch interaction between the user and a user interface in communication with a computer system. For each user interactive exercise, the instructions are executable to measure and record performance data related to the timing and accuracy of the user inputs. The instructions are further executable to process the performance data to generate scores in assessment categories that provide measurements of at least one of the visual acuity skills, operational thinking skills and behavioral skills of the user.

According to another embodiment, a computer system comprises a user interface, one or more processors and one or more memories, and is configured to execute user interactive exercises involving the use of at least one of visual acuity skills, operational thinking skills and behavioral skills. The computer system is configured to measure and record performance data related to the timing and accuracy of user inputs for each user interactive exercise. The computer system is further configured to process the performance data to generate scores in assessment categories that provide measurements of at least one of the visual acuity skills, operational thinking skills and behavioral skills of a user.

According to another embodiment, a method of assessing performance abilities and tendencies of an athlete comprises, using a computer system, executing user interactive exercises involving the use of visual acuity skills, operational thinking skills and behavioral skills of an athlete. During execution of each user interactive exercise, the computer system receives user inputs including body movement of a user and touch interaction between the athlete and a user interface in communication with the computer system. The computer system measures and records performance data related to timing and accuracy of the user inputs in each user interactive exercise, and processes the performance data to generate scores in assessment categories that provide measurements of at least one of the visual acuity skills, operational thinking skills and behavioral skills of the athlete.

The disclosed inventions enable participants to be assessed more quickly and efficiently. In athletic professions or activities, quality and efficient practice repetitions increase and practice sessions are optimized. Team acclimation increases, mastery quickens, and performance improves. Athletes become “game ready” more quickly than previously thought possible. Similarly, in other professional fields or educational fields, work or study performance becomes more efficient and optimized, and mastery of professional or educational activities quickens. The inventions mitigate risk and maximize investments in developing athletes, employees and students.

Additional features and benefits of the inventions will be apparent to those of skill in the art from the following detailed description.

### BRIEF DESCRIPTION OF THE DRAWINGS

FIGS. 1-2 show screenshots of a first assessment exercise of a computer-implemented assessment tool, according to an embodiment.

FIGS. 3-4 show screenshots of a second assessment exercise of the computer-implemented assessment tool, according to an embodiment.

FIGS. 5-6 show a screenshots of a third assessment exercise of the computer-implemented assessment tool, according to an embodiment.

FIGS. 7-8 show a screenshots of a fourth assessment exercise of the computer-implemented assessment tool, according to an embodiment.

FIGS. 9-10 show screenshots of a fifth assessment exercise of a computer-implemented assessment tool, according to an embodiment.

FIGS. 11-12 show screenshots of a sixth assessment exercise of the computer-implemented assessment tool, according to an embodiment.

FIGS. 13-15 show screenshots of a seventh assessment exercise of the computer-implemented assessment tool, according to an embodiment.

FIGS. 16-17 show screenshots of an eighth assessment exercise of the computer-implemented assessment tool, according to an embodiment.

FIGS. 18-20 show screenshots of a ninth assessment exercise of the computer-implemented assessment tool, according to an embodiment.

FIGS. 21-23 show screenshots of a tenth assessment exercise of the computer-implemented assessment tool, according to an embodiment.

FIGS. 24-34 illustrate various sections of an example assessment report that can be generated from a participant's participation in the assessment exercises of FIGS. 1-23, according to an embodiment.

FIGS. 35-37 show example personalized assessment summaries that can be generated based on specific data in an assessment report, according to an embodiment.

### DETAILED DESCRIPTION

The following detailed description relates to methods and systems for discovering, assessing the mental acuity and character of an individual. The methods and systems disclosed herein can be used to assess and develop athletes, employees, students and individuals in general.

According to the inventions, mental acuity and character can be assessed based on three assessment categories: visual acuity; operational thinking; and behavior.

Visual Acuity

Visual acuity can be defined as including the following visual characteristics:
1) overall vision or ocular health—the physical/medical condition of the eye, degree of freedom from disease so that the eye may perform proper eye movement and sight;
2) peripheral vision—the external or outer boundary of the line of vision or sight;
3) hand-eye coordination—the ability to see and use the hand(s) to actively arrange what is seen in harmonious order according to proper relationships;
4) speed and agility of visual adaptation with logic and accuracy—the ability to quickly see and mentally incorporate the physical to adjust what is seen in accordance with principles of logic; and
5) imagery or stereoptic—the ability of each eye to look upon an object as one picture so that the two images are conveyed to brain as one picture.
   In the context of football, the category of visual acuity is often referred to as “read and react.”

Accordingly, the inventions disclosed herein are adapted to assess visual acuity through assessment of these characteristics. More specifically, these characteristics can be effectively assessed through the assessment of:
a) spatial thinking and reasoning, which can be defined as:
   1. the ability to acquire knowledge through images, pictures, mazes, jigsaw puzzles, free drawings;
   2. building with objects and/or imaginable images; and
   3. the ability to be a discriminating listener who can reference unusual sounds; and
b) visualization, which can be defined as the ability to clearly see and draw the correct mental understanding or conclusion to what is seen that can invoke action.

Operational Thinking

Operational thinking can be defined as including:
1) Linguistics, which includes the ability to read, understand and comprehend written language; and
2) Logical reasoning, which includes the ability to reason in accordance with principles of logic.
   In the context of football, the category of operational thinking is often referred to as “teach-ability.”

According to the inventions, linguistics can be assessed through the assessment of the following categories:
a) accuracy of thinking—the intellectual process of correct, efficient mental examination of something and forming an opinion or idea that could lead to an action;
b) fast-thinking logic—to quickly, intellectually and mentally examine through reasoning of logical principles; and
c) divergent thinking—to speculate or form a mental conclusion on things that may derive from the same point of origin and proceed in different directions as they move farther apart.
   For example, linguistic activities can include writing, reading, telling stories and doing crossword puzzles.

Logical reasoning can be assessed through the assessment of the following categories:
a) Right & Left Differentiation—the ability to distinguish and determine the difference between right and left from multiple perspectives;
b) Directional Thinking—to intellectually speculate, conceive or form a mental conclusion that directs along a course line or indicator of direction;
c) Instructional Thought—gathering information that teaches knowledge that can direct towards a conclusion or points of view that can lead to performance of an action;
d) Organizational Thought—to contemplate, think or meditate on independent, inter-dependent or coordinated parts, arranging them to draw a united conclusion that can lead to a united action.
   Logical reasoning activities can include, for example, recognizing patterns or related categories, solving math problems and solving strategic games.

Accordingly, the inventions disclosed herein are adapted to assess operational thinking through assessment of linguistics and logical reasoning as characterized above.

Behavior or Character

Behavior can be defined as including:
1) interpersonal skills (i.e., feelings)—inner feelings an individual possesses, such as aggression and self-image; and
2) intrapersonal skills (i.e., self-motivation)—intra-feelings an individual possesses, such as competitiveness and involvement.
   In the context of football, the category of behavior or character is often referred to as “on-the-field/off-the-field character, mental toughness and passion.”

The assessment of behavior or character can be accomplished through the assessment of:
a) aggression—the overt or suppressed hostility, either innate or resulting from feelings and/or desires and directed outward;
b) self-image—an individual's perception of oneself, and an individual's awareness of, and attitudes toward, his/her own physical and/or biological person;
c) competitiveness—an individual's interest in and/or suitability for competition and desire to compete; and
d) involvement—the act of participating.

Accordingly, the methods and systems disclosed herein are adapted to assess behavior/character through the assessment of the characteristics above.

Assessment Category Methodology

Athletes implement the following four phases during their physical performance:

1) Seeing;

2) Diagnosing the situation;

3) Positioning the body; and

4) Execution

These phases are implemented during physical performance in the order in which they are listed above. Accordingly, the assessment/development methods and tools according to the inventions can be adapted to monitor these phases in the order specified above.

With this in mind, an assessment according to an embodiment of the inventions can be a three-category assessment for the purpose of defining the following in accordance with the four phases noted above in a specific and related order:
1) Visual Acuity:
   a) ocular—quick and clear visualization (i.e. seeing) of the situation in reference to responsibility and/or required achievement;
   b) spatial—use of vision to quickly and accurately diagnose the situation based upon the rules and application process instructed to apply.
2) Operational thinking: through ocular and incorporated with spatial, simultaneous application of organized directed instructions with athletic skill and physical positioning to perform a functional responsibility and/or task.
3) Behavior: through best effort and without fear, the execution of performance anticipating a successful outcome.

It is noted that the ocular aspect (quick and clear visualization, or seeing, of a situation in reference to responsibility and/or required achievement) and spatial aspect (the use of vision to quickly and accurately diagnose a situation based upon the rules and application process a person is instructed to apply) of visual performance are closely interlocked in the disclosed assessments, and therefore are treated as one area. However, it may be desirable to separately assess the ocular and spatial aspects of visual performance in some circumstances, because proper eye health affects how a person relates to what is seen.

Assessment Tool and Process Overview

An assessment conducted pursuant to the inventions can include a collection of assessment exercises performed by the person being assessed (“participant” or “user”) in sequential order. Each assessment exercise can include body movement of the participant and touch interaction between the participant and a computer device/system (e.g., tablet computer, iPad, personal computer (PC), smartphone, etc.) including one or more processors, one or more memories and a user interface. The user interface can include one or more of the following devices: a touch-screen display, a non-touch-screen display, a keyboard, a mouse, a trackball, a trackpad and a stylus, for example. Touch inputs for the assessment can be accomplished by the user's finger(s) and/or other body parts interacting with one or more of the user interface devices listed above. It should be understood that embodiments that are described as involving the use of a participant's finger(s) or hand(s) operating a touch screen display can alternatively be carried out by the participant using a stylus to operate the touch screen.

An assessment tool for executing the assessment exercises can be in the form of a software program installed or operating on a computer device, or installed or operating on a remote computer/server in communication with the computer device (e.g., via the Internet or a local network connection). The software program can include programmed instructions that are stored on a computer hard drive or a memory device/storage medium (e.g., CD, DVD, memory card, a memory stick, etc.). Generally speaking, a method of using the assessment tool can include:
using the computer system to conduct user interactive exercises involving the use of visual acuity skills, operational thinking skills and behavioral skills of the user;
during execution of each user interactive exercise, receiving user inputs at the user interface of the computer system, the user inputs including body movement of the user and touch interaction between the user and the user interface;
for each user interactive exercise, measuring and recording performance data related to the timing and accuracy of the user inputs; and
processing the performance data to generate assessment scores that measure the visual acuity, operational thinking and behavior skills of the user.
   As is discussed later in more detail, the performance from the user interactive exercises can be used to generate a customized report for the user, including suggestions for developing the visual acuity skills, operational thinking skills and behavioral skills of the user and observations related to the visual acuity skills, operational thinking skills and behavioral characteristics of the user.

According to a preferred embodiment, the assessment exercises can be performed in sequential order in two rounds. During the first round, each exercise can be performed under written instruction. The written instruction can be read by an administrator and then the exercise is performed by the person being assessed. During the second round, each exercise is performed in the same sequential order followed in the first round, under written and oral/auditory instruction. The written and oral instructions can be read and heard at the same time and then the exercise is performed by the person being evaluated. Alternatively, the written and/or auditory instructions can be generated by the assessment tool software/computer system.

According to alternate embodiments an exercise round including oral-only instructions can be provided in addition to the first and second rounds above, or in place of the first or second round.

According to preferred embodiments, each exercise includes body movement and touch. This is important in assessing athletes because athletics, at its core, requires body kinesthetic and sensations, which are the primary correlating aspects that influence the assessment measurements.

Detailed descriptions of exemplary assessment exercises are provided below. Although the exemplary embodiments provided below provide a specific number and type of exercises, it should be understood that an assessment according to the invention can include different exercises and/or variations of the described exercises. Furthermore, it should be understood that more or fewer exercises than the number disclosed can be provided in an assessment.

Assessment Exercises

According to exemplary embodiments of the inventions, an assessment can include one or more of the following exercises: 1) an exercise involving drawing a person; 2) an exercise involving drawing a three-dimensional structure; 3) a route reconstruction exercise; 4) a spatial orientation exercise; 5) an exercise involving drawing a pilot's view of a structure; 6) a crossword puzzle exercise; 7) a letter/symbol placement exercise; 8) a letter/symbol maze exercise; 9) a finger/stylus reaction and placement exercise; and 10) an icon interception exercise. According to a preferred embodiment, an assessment includes all of the aforementioned exercises.

Exercise No. 1: Draw a Person

There are often circumstances where players are required to generate creative solutions to complex challenges with no prototypes or comparisons, and for rewards that are primarily intrinsic. In athletic, work and educational endeavors, people are asked to take on additional responsibilities that are very reflective of them and have more to do with their reputation and image than their physical abilities.

People develop in different developmental areas at different times in their lives, and at different rates. It may be a faulty assumption that experience inherently produces creative ability, communication skills, and leadership. The inventors have discovered that, when presented with a complex challenge requiring a creative solution that is closely tied to self-image, people perform very differently. Accordingly, the “Draw a Person” exercise involves having the person being assessed draw an image of himself or herself.

Fundamental Phases

In performing tasks that require some degree of creativity, everyone moves through distinct phases of creative innovation. We first strategize, then initiate action, reevaluate and adjust, and then finally complete execution. Knowing how a person progresses through each phase provides the unique opportunity to lead them to optimal performance when we ask them to perform outside their comfort zone.

Strategy and Initiation Phases

The inventors have discovered that the mental and physical steps of generating and executing a creative solution are relatively intertwined. Research shows that the initial cognitive effort in generating a creative solution is the most deliberate mental phase, and that physically initiating a course of action is the most deliberate motor skill phase.

Reevaluation and Adjustment Phase

The inventors have further discovered that after creating and testing a solution, people take time to cognitively reevaluate their efforts and adjust their physical technique prior to moving forward with full implementation of their course of action. Whereas some spend more time in the initial phases, others spend more time in this second phase prior to performing more efficiently and effectively.

Completion Phase

Similar to differences in the initial two phases discussed above, people complete the cognitive and physical cycles necessary to fulfill all elements of a complex and unique challenge at different speeds and with varying effectiveness.

Complexity and Accuracy

Some people produce very simple and parsimoniously effective solutions, while others produce equally effective but more elaborate solutions to complex and unique solutions. The inventors have discovered that the level of accuracy or relevancy of a solution is not always related to simplicity or complexity. Whereas simple solutions often produce quick and effective results, more creatively complex solutions may facilitate positive outcomes in different settings.

The ability to generate creative solutions to complex challenges is vital for all positions in the game today. It is also trainable, but only if you know how a person defines his/her environment, processes ambiguity, and executes a creative and effective solution.

With this in mind, the inventors developed the “draw a person” exercise. Generally stated, in this exercise, the user/participant imagines himself or herself as a person involved with a particular activity and then interacts with the user interface of the computer system to draw: a physical form of the person on the touch screen or display of the user interface; and clothing or equipment on the physical form that would be worn for the particular activity. The “draw a person” exercise is a timed exercise that assesses visual acuity, operational thinking and behavior and can be completed in one part. The

### Example

### Draw a Person Exercise

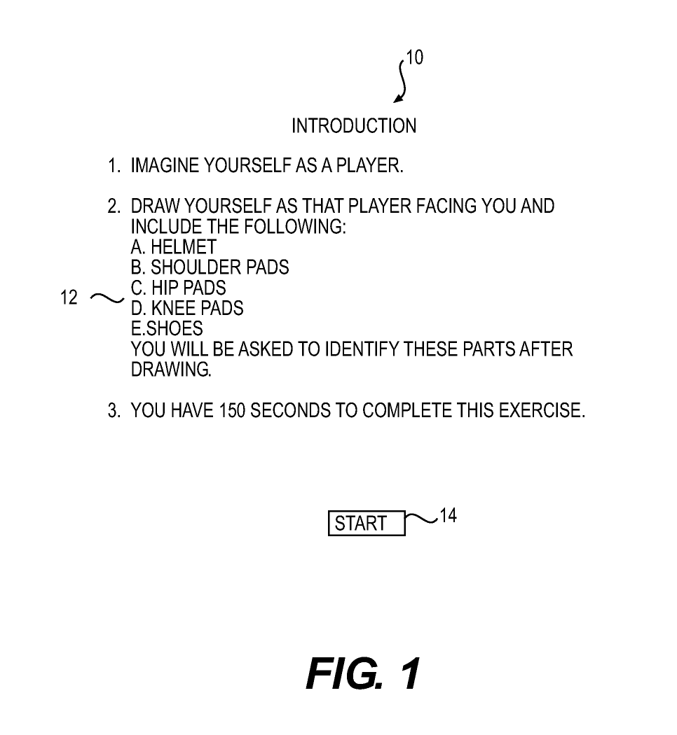

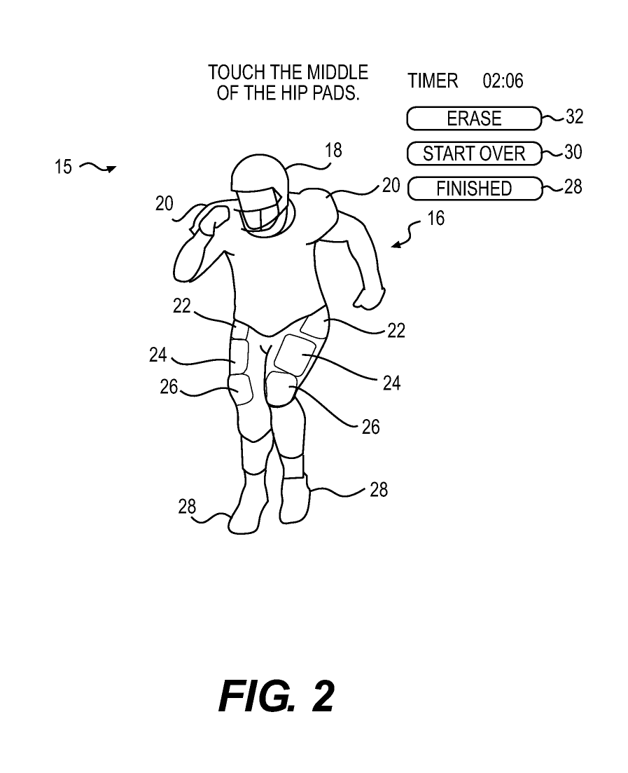

FIGS. 1 and 2 illustrate an exemplary embodiment of the “draw a person” exercise. As shown in FIG. 1, at the beginning of the exercise, the assessment program can display a start screen 10 on the display including instructions 12 and a “start” icon 14. The instructions 12 can instruct the participant to imagine himself as a person who is getting dressed for a predetermined activity (e.g., a football game, work, etc.), draw his physical form (e.g., body, arms, legs, head, etc.) on the display screen of the computer device and then draw clothing or gear that is worn in the predetermined activity on the physical form. For example, the participant may be instructed to imagine he is a football player getting dressed for a football game, and therefore draw his physical form and football equipment on his physical form.

As shown in FIG. 2, upon selecting the start button 14, the exercise will begin on an exercise screen 15, and the participant can attempt to draw a physical form 16 of a person, and equipment including a helmet 18, shoulder pads 20, hip pads 22, thigh pads 24, knee pads 26 and shoes 28 on the physical form 16. According to certain embodiments, this exercise can be available for 2½ minutes (150 seconds), for example. The participant can be told/shown how much time is available to complete the exercise. During the exercise, the amount of time left can remain displayed on the display screen and “count down” on the display screen. The time taken to read instructions 12 can be subtracted from the time provided to complete the exercise. If the participant finishes the exercise prior to the time allotted, he can indicate that he is finished with the exercise by selecting a “finished” icon 28 on the display screen. Otherwise, the exercise will end when the predetermined allotted time expires. Optionally, the participant can start the exercise over by selecting a “start over” icon 30 on the display screen during the exercise or erase part of the image drawn by the participant by selecting an “erase” icon 32 and then using the user interface to erase part or all of the drawing on the display screen. If the participant elects to start the exercise over, the time allotted to complete the exercise will not be reset.

In embodiments in which a combination of written and oral instructions are to be provided to the participant, the instructions 12 can be displayed on the screen as well as read aloud via a computerized voice. The written and oral instructions can include the exact same wording. Time breakdown of each part can follow the same format as the written part noted above.

It is envisioned that this exercise can be offered in an advanced version (e.g., for professional/collegiate athletes) and a standard version (e.g., for high school athletes). In the advanced version, the participant could use his finger to draw on a touch screen in order to perform the exercise. In the standard version, the participant could use a touch screen device and, secondarily, a mouse to perform the exercise. Participants must be involved in the exercise (i.e., be hands-on through the drawing of specific parts of a person) to maintain self-involvement. Ideally, choices of pre-rendered drawing parts may not be displayed on the screen, because providing such choices on screen reduces self-involvement.

Data Collection

Timing and accuracy data related to the user inputs can be measured and recorded. This data can be processed to generate assessment scores that measure visual acuity, operational thinking and behavior skills of the participant. Timing and accuracy data measured and recorded by the assessment program can include the following:
The length of time it takes to read instructions;
The length of time it takes to complete a drawing of a person and submit the drawing;
The number of items that are accurately placed on the drawing;
The number of items that are inaccurately placed and/or omitted on the drawing; and
The number of times the participant starts over (provided this is allowed).

Instruction comprehension determination can be measured by the amount of time is takes to read (written) and/or read/hear (written/oral) the instructions. Comprehension should be quicker with the written/oral instruction (both instruction delivery formats as well as the second time around). Performance can be measured by the frequency and accuracy of the drawing description (i.e. proportions not artistry). High-level exercise performance equates to short lengths of instruction time (e.g., less than 15 seconds), one attempt and high accuracy of player drawing description. Mid-level exercise performance equates to a combination of:
Short lengths of instruction time (e.g., less than 15 seconds), two (2) to three (3) attempts, and low-to-middle accuracy of player drawing description;
Middle lengths of instruction time (e.g., greater than 15 seconds but not longer than 45 seconds) and two (2) to three (3) attempts, and middle accuracy player drawing description.
   Low-level exercise performance equates to long lengths of instruction time (e.g., greater than 45 seconds), four (4) or more attempts, and/or low accuracy of the drawing description (i.e. proportions).

It should be understood that this exercise could involve drawing person of a certain profession, sport, educational field or other activity, based on the field for which the assessment is being provided. It should also be understood that a stylus or other input device can be used in place of a participant's finger to perform this exercise.

Exercise No. 2: Three-Dimensional Structure

Whether engaged in a professional activity, sports activity, educational activity or other activity, people are often required to quickly solve problems with limited or specific information. Quite often, more than one suitable solution to a problem is achievable, but what matters most is working with colleagues or team members, adjusting and getting the job done.

People solve problems differently as they make decisions and act on them individually and collectively. Problem solving is different than innovation in that an optimal solution is present along with other good enough options during problem solving. In problem solving, the person solving the problem is also given a reference to solve the problem, while innovation is conducted without any assistance or reference. The inventors understand that all people move through fundamental phases of problem solving and the decision making process at different speeds and with varying effectiveness.

Fundamental Phases

Regardless of talent level, everyone moves through distinct phases of problem solving. First, a person generates a solution from previous mental prototypes, then experiments through action, reassesses his effort, and then finally resolves the problem with a solution. Knowing how a person progresses through each phase provides the unique opportunity to develop them to achieve optimal performance when we ask them to solve problems during a performance.

Generation

The first mental phase of problem solving is the generation of a good enough solution for the task at hand. This differs from strategizing during innovation in that a usable solution is selected from mental prototypes in problem solving rather than starting from scratch as one does while innovating. This is because, in problem solving, a person has usually seen a similar problem before.

### Experimentation

After generating a usable solution, a person briefly experiments with the solution. This first motor skill phase is different from the remaining cycles of physical execution conducted later in problem solving.

Reassessment

Just prior to automated mental and physical execution of a solution good enough to solve a problem, people will pause or slightly alter the execution of skill to assess the results of experimentation on their generated solution.

Resolution

After reassessment, people become automated in their mental and physical execution of problem solving. A person will often refer to the resolution phase as if playing a movie out in his/her head. The person is simply doing what he/she has already envisioned himself/herself doing. Some people resolve more quickly, while others are more deliberate and accurate.

Accuracy and Simplicity

There are times when a good enough solution earlier is better than a perfect solution later. Such different solutions are not necessarily better or worse than the other, just different. People problem solve with varying levels of accuracy and simplicity.

The ability to solve simple problems with varying degrees of successful options and courses of action is important for people at all professional positions and sports positions. It is also trainable, but only if you know how a person progresses through the phases of problem solving. Understanding individual strengths and challenges during each phase is critical to developing better problem solvers at the individual and collective level.

With the above in mind, the inventors developed the “three-dimensional structure” exercise. Generally speaking, in this exercise, the participant imagines he is standing facing the front of a structure and uses the user interface to move parts of the structure to build the structure to have prescribed dimensional ratios. The assessment program can receive the participant's inputs attempting to build the structure via the user interface. The “three-dimensional structure” exercise assesses visual acuity, operational thinking and behavior, and can be completed in three parts, for example.

### Example

### Three-Dimensional Structure

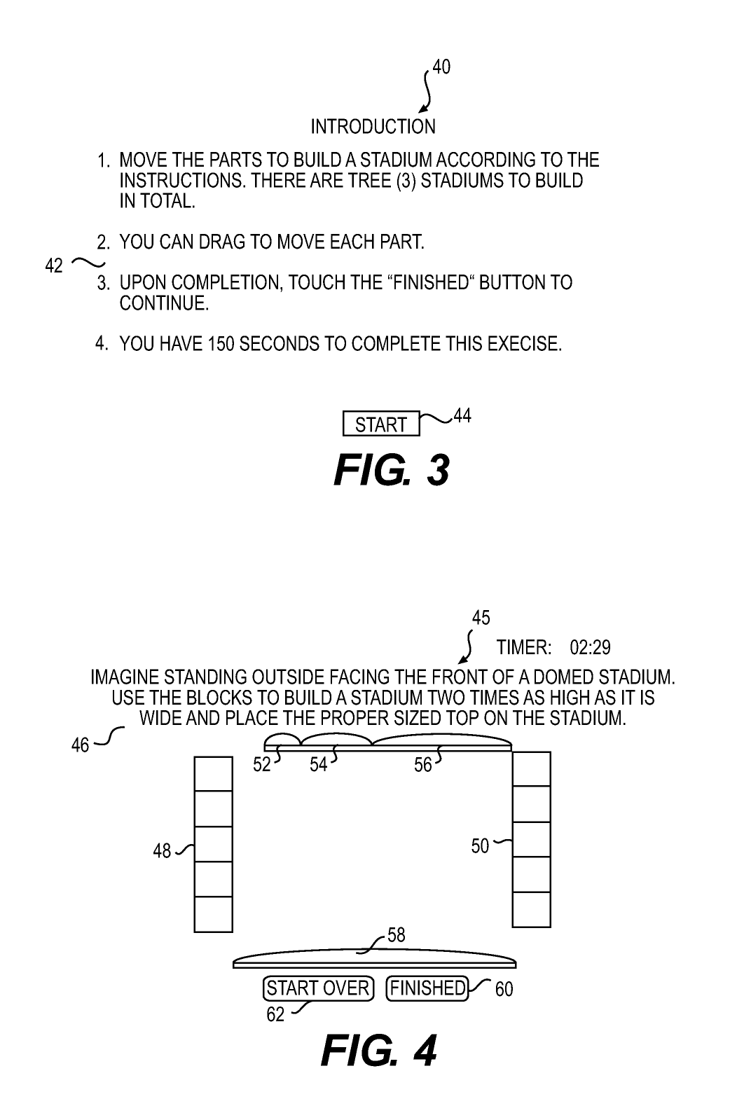

FIGS. 3 and 4 illustrate an exemplary embodiment of the “three-dimensional structure” exercise. The exercise can be divided into three distinct parts. As shown in FIG. 3, at the beginning of the exercise, the assessment program can display a start screen 40 on the display including general instructions 42 and a “start” icon 44. The instructions 42 can instruct the participant to move parts of a structure on the display screen of the computer device according to specific instructions that will be presented after the “start” icon 44 is selected. For example, the participant may be instructed to construct a stadium.

According to an exemplary embodiment, as shown in FIG. 4, once the participant selects the “start” icon 44, a first part of the exercise will begin on an exercise screen 45. Specific instructions 46 can appear on the exercise screen instructing the user to imagine he is standing in front of a stadium and move sidewalls 48, 50 and a correct one of roofs 52, 54, 56, 58 to build the stadium that is two times as high as it is wide. The participant can view the parts 48, 50, 52, 54, 56, 58 and attempt to move the sidewalls 48, 50 and one of the roofs 52, 54, 56, 58 to build the prescribed stadium. If the participant finishes the first part of the exercise prior to the time allotted for the first part, he can indicate that he is finished with the first part of the exercise by selecting a “finished” icon 60 on the screen. Otherwise, the first part of the exercise will end when the time allotted for the first part of the exercise expires.

Once the first part of the exercise is completed, the screen 45 is reset and a second part of the exercise (not shown) can begin in which the participant is instructed to/attempts to build a stadium from the sidewalls 48, 50 and a correct one of roofs 52, 54, 56, 58 that is two times as wide as it is high. If the participant finishes the second part of the exercise prior to the time allotted for the second part, he can indicate that he is finished with the second part of the exercise by selecting the “finished” icon 60 on the screen. Otherwise, the second part of the exercise will end when the time allotted for the second part of the exercise expires.

Once the second part of the exercise is completed, the screen 45 is reset again and a third part of the exercise (not shown) can begin in which the participant is instructed to/attempts to build a stadium from the sidewalls 48, 50 and a correct one of roofs 52, 54, 56, 58 that is two times as long as it is short. If the participant finishes the third part of the exercise prior to the remaining time allotted for the exercise, he can indicate that he is finished with the exercise by selecting the “finished” icon 60 on the screen. Otherwise, the third part of the exercise will end when the time allotted for the third part of the exercise expires.

According to certain embodiments, this exercise can be available for 2½ minutes (150 seconds), for example. The participant can be told/shown how much time is available to complete the exercise. During the exercise, the amount of time left can remain displayed on the display screen and “count down” on the display screen. The time taken to read instructions 42 at the beginning of the exercise, along with the transition time between the first and second parts of the exercise (e.g., 5 seconds) and the second and third parts of the exercise (e.g., 5 seconds) can be subtracted from the time and divided by 3 in order to determine the time allotted to complete each part of the exercise. According to some embodiments, the participant can start the exercise over by selecting a “start over” icon 62 on the display screen during the exercise. If the participant elects to start the exercise over, the time allotted to complete the exercise will not be reset.

In embodiments in which a combination of written and oral instructions are to be provided to the participant, the instructions 42, 46 can be displayed on the screen as well as read aloud via a computerized voice. The written and oral instructions can include the exact same wording. Time breakdown of each part can follow the same format as the written part noted above.

It is envisioned that this exercise can be offered in an advanced version (e.g., for professional/collegiate athletes) and a standard version (e.g., for high school athletes). In the advanced version, the participant could use his finger to draw on a touch screen in order to perform the exercise. In the standard version, the participant could use a touch screen device and, secondarily, a mouse to perform the exercise. Participants must be involved in the exercise (i.e., be hands-on through the drawing of specific parts of a person) to maintain self-involvement. Ideally, choices other than merely showing the parts of the structure to be built may not be displayed on the screen, because providing such choices on screen reduces self-involvement. Participants must be involved in the exercise (i.e., be hands on through the construction of a stadium) to maintain self-involvement.

Data Collection

Timing and accuracy data related to the user inputs can be measured and recorded. This data can be processed to generate assessment scores that measure visual acuity, operational thinking and behavior skills of the participant. Timing and accuracy data measured and recorded by the assessment program can include the following:
Length of time it takes to read instructions;
Length of time (each attempt) it takes to successfully build each structure (i.e. each part will be timed);
Length of time (overall) it takes to successfully build all three (3) structures (i.e. all parts completed will be timed);
Accuracy of each structure construction in accordance with the detailed instructions;
Accuracy of total structure construction (all three structures) in accordance with the detailed instructions.

Instruction comprehension determination is measured by the amount of time is takes to read (written) and/or read/hear (written/oral) the instruction. Comprehension should be quicker with the written/oral instruction (both instruction delivery formats as well as the second time around). Scoring will not be done based on artistry/looks.

Performance is measured by the length of time (amount and within the allotment) and accuracy for each stadium construction.

High-level exercise performance equates to short lengths of instruction time (e.g., less than 15 seconds) to successfully construct each stadium within the time allotted. The fewer the attempts the better the performance.

Mid-level exercise performance equates to a combination of:
Shorts lengths of instruction time (e.g., less than 15 seconds) and two (2) out of three (3) successful stadiums constructions within the time allotted. Fewer attempts indicate better performance;
Middle lengths of instruction time (e.g., greater than 15 seconds but not longer than 45 seconds) and two (2) to three (3) successful stadium constructions within the time allotted. More attempts indicate worse performance.

Low-level exercise performance equates to long lengths of instruction time (i.e. greater than 45 seconds) and two (2) or more unsuccessful stadium constructions and/or not within the time allotted. The more attempts the worse the performance.

It should be understood that the variations of this exercise are possible in which different structures are drawn, based on the profession or activity for which the participant is being assessed. For example: if the participant is an athlete, the structure can be a stadium or an arena; if the participant is someone working in a profession, the structure can be an office building; and if the participant is a student, the structure can be a library or educational building. It should also be understood that a stylus or other input device can be used in place of a participant's finger to perform this exercise.

Exercise No. 3: Route Reconstruction

The “route reconstruction” exercise displays a route (or pattern), instructs the participant to imagine the route flipped over in one or more directions and receives user inputs corresponding to the user attempting to draw the pattern as if the pattern were flipped over in the one or more directions. This exercise assesses visual acuity, operational thinking and behavior, and, according to one embodiment, can be completed in four parts.

### Example

### Route Reconstruction

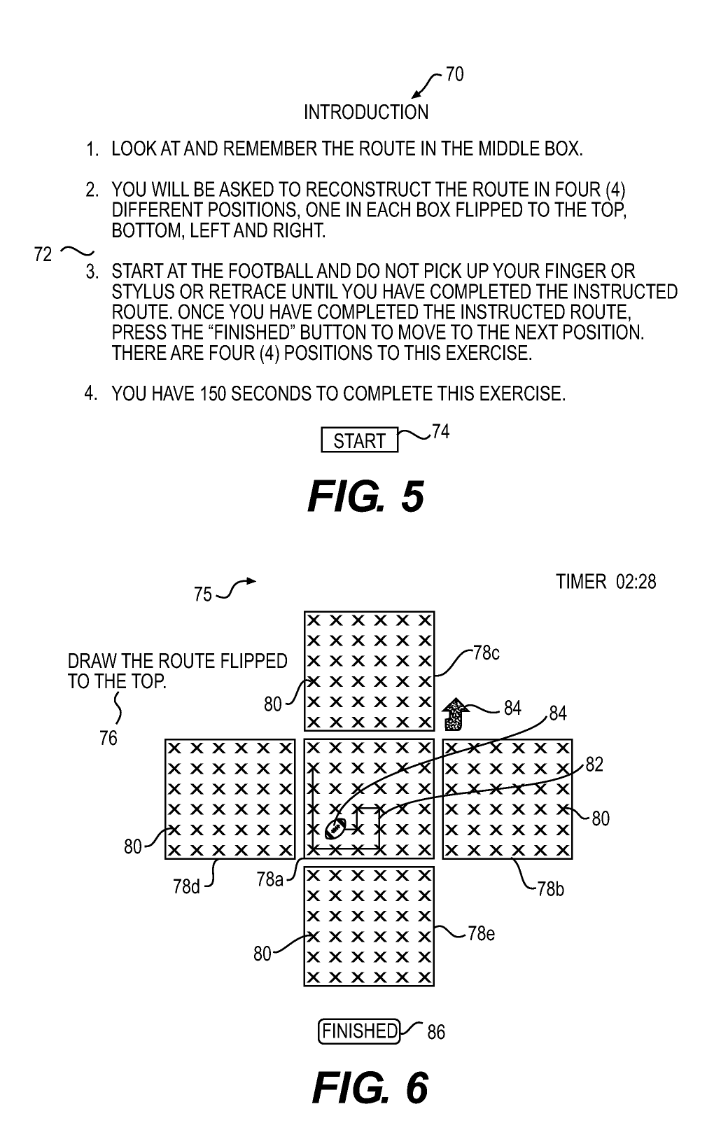

FIGS. 5 and 6 illustrate an exemplary embodiment of the “route reconstruction” exercise. The exercise can be divided into three distinct parts. As shown in FIG. 5, at the beginning of the exercise, the assessment program can display a start screen 70 on the display including general instructions 72 and a “start” icon 74. The instructions 72 can instruct the participant to view a route in the middle of the following screen and draw the route in a number of different positions to be indicated after the participant starts the exercise.

Referring to FIG. 6, once the participant selects the “start” icon 74, a first part of the exercise will begin on an exercise screen 75 displaying separate boxes 78a-78e, each of the boxes 78a-78e containing a plurality of X's 80 (or other indicators/icons) arranged in multiple rows. Specific instructions 76 can be shown on the exercise screen 75/spoken by the assessment program instructing the user to view a route 82 in the middle box 78a, imagine the route 82 flipped in a first direction (e.g., to the top indicated by the arrow 84) and reconstruct (draw using the user interface) the route 82 as if it were flipped in the first direction. The route 82 can be composed of line segments extending between multiple X's 80, and the beginning of the route 82 can be marked by a football icon 84 (or other icon/indicator), for example. The route can flash for a predetermined amount of time (e.g., 5 seconds) before it disappears from the screen 75. The participant can then interact with the user interface to attempt to draw the route 82 as if it were flipped in the first direction. If the participant is using his finger and a touch screen to reconstruct the route 82, the exercise can be configured to require the participant to maintain contact with the touch screen throughout the entire drawing process such that lifting the participants finger from the screen will complete the reconstruction attempt. Likewise, if the participant is using a keyboard key, mouse/trackball button or trackpad, lifting the participant's finger to release the key, button or trackpad can result in completion of the reconstruction attempt. When the participant is attempting reconstruction of the route, the assessment program can mark the beginning and end of the reconstructed route (not shown) with distinct icons. If the participant finishes the first part of the exercise prior to the time allotted for the first part, he can indicate that he is finished with the first part of the exercise by selecting a “finished” icon 86 on the screen 75. Otherwise, the first part of the exercise will end when the time allotted for the first part of the exercise expires.

Once the first part of the exercise is completed, the screen 75 is reset and a second part of the exercise (not shown) can begin in which the participant is instructed to/attempts to reconstruct the route 82 flipped in a second direction (e.g., to the right). Again, the route can be flashed on screen for a predetermined amount of time before disappearing. If the participant finishes the second part of the exercise prior to the time allotted for the second part, he can indicate that he is finished with the second part of the exercise by selecting the “finished” icon 86 on the screen. Otherwise, the second part of the exercise will end when the time allotted for the second part of the exercise expires.

Once the second part of the exercise is completed, the screen 75 is reset and a third part of the exercise (not shown) can begin in which the participant is instructed to/attempts to reconstruct the route 82 flipped in a third direction (e.g., to the left). Again, the route can be flashed on screen for a predetermined amount of time before disappearing. If the participant finishes the third part of the exercise prior to the time allotted for the third part, he can indicate that he is finished with the third part of the exercise by selecting the “finished” icon 86 on the screen. Otherwise, the third part of the exercise will end when the time allotted for the second part of the exercise expires.

Once the third part of the exercise is completed, the screen 75 is reset and a fourth part of the exercise (not shown) can begin in which the participant is instructed to/attempts to reconstruct the route 82 flipped in a fourth direction (e.g., to the bottom). Again, the route can be flashed on screen for a predetermined amount of time before disappearing. If the participant finishes the fourth part of the exercise prior to the time allotted for the fourth part, he can indicate that he is finished with the fourth part of the exercise by selecting the “finished” icon 86 on the screen. Otherwise, the fourth part of the exercise will end when the time allotted for the fourth part of the exercise expires.

According to some embodiments, the participant can be allowed to “start over” as many times as desired; however, time will not reset. Once all four (4) parts are completed once, the participant may go back and retry any one of the previous parts, provided time remains.

According to certain embodiments, this exercise can be available for 2½ minutes (150 seconds), for example. The participant can be told/shown how much time is available to complete the exercise. During the exercise, the amount of time left can remain displayed on the display screen and “count down” on the display screen. The time taken to read instruction at the beginning of the exercise, along with the transition time between the first and second, second and third, and third and fourth parts of the exercise (e.g., 5 seconds each) can be subtracted from the time and divided by 4 in order to determine the time allotted to complete each part of the exercise.

According to some embodiments, instructions 72, 76 can appear on the screen as well as read aloud via a computerized voice. The written and oral instructions can have the exact same wording. Time breakdown of each part will follow the same format as the written noted above.

It is envisioned that this exercise can be offered in an advanced version (e.g., for professional/collegiate athletes) and a standard version (e.g., for high school athletes). In the advanced version, the participant could use his finger to draw on a touch screen in order to perform the exercise. In the standard version, the participant could use a touch screen device and, secondarily, a mouse to perform the exercise. Participants must be involved in the exercise (i.e., be hands-on through the drawing of specific parts of a person) to maintain self-involvement. Ideally, choices other than merely showing the parts of the structure to be built may not be displayed on the screen, because providing such choices on screen reduces self-involvement. Participants must be involved in the exercise (i.e., be hands on through the drawing of the routes) to maintain self-involvement.

Data Collection

Timing and accuracy data related to the user inputs can be measured and recorded. This data can be processed to generate assessment scores that measure visual acuity, operational thinking and behavior skills of the participant. Timing and accuracy data measured and recorded by the assessment program can include the following:
Length of time it takes to read instructions;
Length of time it takes to draw each X Pattern and submit;
Number of X points on each pattern that are accurately drawn;
Number of X points on each pattern that are inaccurately drawn;
Number of patterns that are accurately drawn;
Number of patterns that are inaccurately drawn;
Number of times the participant starts over during each pattern drawing;
Number of times the participant re-tried an X Pattern;
Which X Pattern the participant retried.

Instruction comprehension determination is measured by the amount of time is takes to read (written) and/or read/hear (written/oral) the instruction. Comprehension should be quicker with the written/oral instruction (both instruction delivery formats as well as the second time around).

Performance is measured by the accuracy of the patterns drawn (i.e. to the right, to the left, to the bottom, to the top) and the ability to visualize the pattern in various positions.

High-level exercise performance equates to short lengths of instruction time (i.e. less than 15 seconds), one attempt per each pattern and high accuracy of X points placed and patterns drawn.

Mid-level exercise performance equates to a combination of:
Short lengths of instruction time (e.g., less than 15 seconds), two (2) to three (3) attempts, and low-to-middle accuracy of X points placed and patterns drawn;
Middle lengths of instruction time (e.g., greater than 15 seconds but not longer than 45 seconds) and two (2) to three (3) attempts, and middle accuracy of X points placed and patterns drawn.

Low-level exercise performance equates to long lengths of instruction time (e.g., greater than 45 seconds), four (4) or more attempts, and/or low accuracy of X points placed and patterns drawn.

It should be understood that other letters, symbols or numbers can be used for the patterns instead of an X. It should also be understood that a stylus or other input device can be used in place of a participant's finger to perform this exercise.

Exercise No. 4: Spatial Orientation

The first and most daunting task after draft day for any football player is learning his playbook. Even stalwart college students experience unprecedented challenges while making sense of diagrams, schemes, terms, and packages in an NFL playbook. People in other sports or professions, or in an educational environment, may also need to learn documents involving diagrams, schemes and terms that, like a playbook, involve spatial orientation. For the purposes of this discussion, any such document will be referred to as a “playbook” for the sake of simplicity and conciseness.

The inventors have discovered that different elements of recall are associated with learning plays from a playbook and then executing variations of them on the field. Memory certainly plays a big part of learning a playbook, but how a person uses practical application and iterative repetition is equally important to what a person remembers. The inventors can provide, through the methods and systems disclosed herein, an understanding of how each person recalls the contents of his playbook during preparation, practice and a performance.

Recall Components

Strategy

As people are required to recall what is in their playbook, their first mental step is the most deliberate one as they develop a cognitive strategy to remember a play or scheme they have learned and transfer it in action on the field, in the workplace or in the classroom.

Initiation

After developing a strategy, people initiate the action necessary to implement it. This first mental step is different from all the others and occurs concurrently with a brief mental assessment of whether or not they are correctly performing the play or scheme in their mind on the field, in the workplace or in the classroom.

Recall

Moving forward from strategy and initiation, people conduct mental and physical cycles of assessment and action to ensure they are continuing to perform correctly. As people attempt to sustain these cycles, they do so at different speeds and with varying degrees of accuracy.

Patience

Some people are more deliberate in the initial stages of recall, while others move through them quickly. People who are more deliberate in their strategy development are generally more fluid in their recall stage and experience greater accuracy in the execution of what they have learned. Establishing good strategy methods is a trainable component of recall and the inventions herein provides the data necessary to train and equip all people for better playbook recall.

Location and Directional Recall

The inventors have discovered that some people are able to recall the proper location for themselves and other people in different plays or schemes, yet certain directional components are not recalled as clearly. Likewise other people grasp direction better than proximity and location within complex schemes.

Every person learns his playbook differently. The invention provides the necessary information to develop strategies and learning methods for each person that will best enable and facilitate recall of a playbook.

In view of the above, the inventors have developed the “spatial orientation” exercise. In this exercise, the participant views an image including a first icon marked with a symbol or letter, a second icon, and an object indicating a viewpoint within the image, and is instructed to arrange the first icon so that the symbol or letter is oriented in the particular way arrange the second icon and the third icon in a specified manner. After the participant attempts to arrange the first icon, the second icon and the third icon as instructed, the participant is then instructed to imagine himself being located in a position where the object is and looking at the first, second and third icons as the first, second and third icons have been arranged. The participant then attempts to arrange the first, second and third icons as if the user were located in the position of the object and looking at the first, second and third icons. The “spatial orientation” exercise assesses visual acuity, operational thinking and behavior and, according to one embodiment, can be completed in three parts.

### Example

### Spatial Orientation Exercise

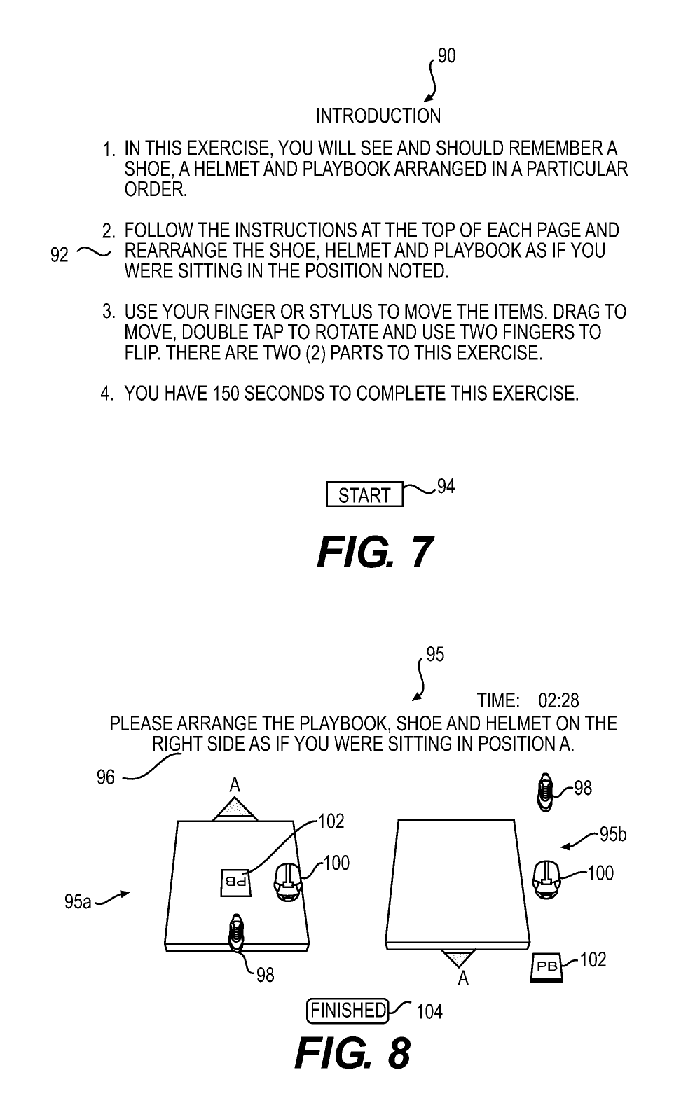

FIGS. 7 and 8 illustrate an exemplary embodiment of the “route reconstruction” exercise. The exercise can be divided into two distinct parts, for example. As shown in FIG. 7, at the beginning of the exercise, the assessment program can display a start screen 90 on the display including general instructions 92 and a “start” icon 94. The instructions 92 can instruct the participant to view and remember a first icon, a second icon and a third icon and arranged in a particular order/configuration and to rearrange the first, second and third icons as instructed on subsequent screens.

Referring to FIG. 8, once the participant selects the “start” icon 94, a first part of the exercise will begin on an exercise screen 95 divided into a left side 95a and a right side 95b. The exercise screen 95 can display/announce (not shown) instructing the participant to notice a first icon 98 (e.g., a shoe), a second icon 100 (e.g., a helmet) and a third icon 102 (e.g., a playbook) marked with a symbol or letters (e.g., “PB”), and arrange the icons 98, 100, 102 in the particular configuration and orientations shown in a first setting on the left side 95a of the screen 95. Once the participant attempts to arrange and orient the icons as directed by the instructions 96, the exercise can display the proper arrangement of the icons 98, 100, 102 on the screen 95 and ask the participant to confirm whether his arrangement and orientation of the icons 98, 100, 102 looks correct. The participant then leaves all of the icons 98, 100, 102 in place on the left side 95a of the screen 95.

Thereafter, the exercise can display/announce instructions 96 asking the participant to imagine himself sitting in the position where the object “A” is located on the left side 95a of the screen, looking down on the icons as they are arranged now on the screen 95. The participant can then be asked to arrange the icons 98, 100, 102 from the first setting in a second setting on the right side 95b of the screen as if he were sitting in the position of the object “A” on the right side 95b of the screen 95 (the object “A” on the right side 95b is positioned opposite of where it is positioned on the left side 95a). In other words, the arrangement and orientation of the icons 98, 100, 102 in the first setting are to be reproduced in the second setting from the perspective of the object “A” in the second setting. Using his fingers or a stylus, the participant can then attempt to arrange the icons 98, 100, 102 on the right side 95b of the screen 95 according to the instructions 96. If the participant finishes the first part of the exercise before the allotted amount of time expires, the participant can select the “finished” icon 104 to conclude the first part of the exercise. Otherwise, the first part of the exercise will terminate once the time allotted for the first part of the exercise expires. When the first part of the exercise concludes, the arrangement/orientation attempted by the participant can be observed and evaluated (by the assessment program and/or an administrator), and the correct arrangement/orientation can be flashed on the screen 95. The participant can then be instructed by the exercise to arrange his items as shown by the correct arrangement/orientation flashed on the screen. The participant's arrangement will have been recorded at that time. Then, the participant can be given the correct answer by the exercise.

In a second part of the exercise, a new (third) setting (not shown) of the icons 98, 100, 102 can appear on the left side 95a of the screen 95 with a second object (e.g., a letter “B”—not shown) placed on the screen 95. The participant can then be asked to arrange the icons 98, 100, 102 from the third setting in a fourth setting (not shown) on the right side 95b of the screen as if he were sitting in the position of the object “B” on the right side 95b of the screen 95 (in similar fashion to the object “A” in the first part of the exercise, the object “B” on the right side 95b is positioned opposite of where it is positioned on the left side 95a). In other words, the arrangement and orientation of the icons 98, 100, 102 in the third setting are to be reproduced in the fourth setting from the perspective of the object “B” in the fourth setting. Using his fingers or a stylus, the participant can then attempt to arrange the icons 98, 100, 102 on the right side 95b of the screen 95 according to the instructions. If the participant finishes the second part of the exercise before the allotted amount of time expires, the participant can select the “finished” icon 104 to conclude the first part of the exercise. Otherwise, the second part of the exercise will terminate once the time allotted for the second part of the exercise expires. When the second part of the exercise concludes, the arrangement/orientation attempted by the participant can be observed and evaluated (by the assessment program and/or an administrator), and the correct arrangement/orientation can be flashed on the screen 95. The participant can then be instructed by the exercise to arrange his items as shown by the correct arrangement/orientation flashed on the screen. The participant's arrangement will have been recorded at that time. Then, the participant can be given the correct answer by the exercise.

According to certain embodiments, this exercise can be available for 2½ minutes (150 seconds), for example. The participant can be told/shown how much time is available to complete the exercise. During the exercise, the amount of time left can remain displayed on the display screen and “count down” on the display screen. The time taken to read instruction at the beginning of the exercise, along with the transition time between the first and second parts of the exercise (e.g., 5 seconds) can be subtracted from the time and divided by 2 in order to determine the time allotted to complete each part of the exercise.

According to some embodiments, instructions 92, 96 can appear on the screen as well as read aloud via a computerized voice. The written and oral instructions can have the exact same wording. Time breakdown of each part will follow the same format as the written noted above.

It is envisioned that this exercise can be offered in an advanced version (e.g., for professional/collegiate athletes) and a standard version (e.g., for high school athletes). In the advanced version, the participant could use his finger to draw on a touch screen in order to perform the exercise. In the standard version, the participant could use a touch screen device and, secondarily, a mouse to perform the exercise. Participants must be involved in the exercise (i.e., be hands-on throughout the arrangement of the icons) to maintain self-involvement. Ideally, choices of pre-rendered arrangements and configurations of icons for the participant to select from may not be displayed on the screen, because providing such choices on screen reduces self-involvement.

Data Collection

Timing and accuracy data related to the user inputs can be measured and recorded. This data can be processed to generate assessment scores that measure visual acuity, operational thinking and behavior skills of the participant. Timing and accuracy data measured and recorded by the assessment program can include the following:
The length of time it takes to read instructions;
The length of time (each attempt) it takes to successfully arrange the items per each position A and B (i.e. each part will be timed);
The length of time (overall) it takes to successfully arrange the items per each position A and B (i.e. each part completed will be timed);
The accuracy of each item arrangement (all three positions of the items) in accordance with the detailed instructions;
The accuracy of total item arrangement (all three positions of the items) in accordance with the detailed instructions.

Instruction comprehension determination is measured by the amount of time is takes to read (written) and/or read/hear (written/oral) the instruction. Comprehension should be quicker with the written/oral instruction (both instruction delivery formats as well as the second time around).

Performance is measured by the length of time (amount and within the allotment) and accuracy for each item/group arrangement.

High-level exercise performance equates to short lengths of instruction time (e.g., less than 15 seconds) to successfully arrange each item/group within the time allotted. Fewer attempts indicate better performance. Mid-level exercise performance equates to a combination of:
Shorts lengths of instruction time (e.g., less than 15 seconds) and two (1) out of two (2) successful arrangements of each item/group within the time allotted. Fewer attempts indicate better performance;
Middle lengths of instruction time (e.g., greater than 15 seconds but not longer than 45 seconds) and one (1) to two (2) successful arrangements of each item/group within the time allotted. More attempts indicate worse performance.
   Low-level exercise performance equates to long lengths of instruction time (e.g. greater than 45 seconds) and one (1) or more unsuccessful arrangements of each item/group and/or not within the time allotted. More attempts indicate worse performance.

It should be understood that other icons may be substituted for the playbook, helmet, football and letters employed in this exercise, depending on the activity or profession for which the participant is being assessed. It should also be understood that a stylus or other input device can be used in place of a participant's finger to perform this exercise.

Exercise No. 5: Pilot's View of a Structure

In the “pilot's view of a structure” exercise, the participant can imagine himself flying over a structure related to a sport, profession or activity, and interacts with the user interface to draw an overhead view of the structure. The “pilot's view of a structure” exercise assesses visual acuity and operational thinking, and, according to one embodiment, can be completed in one part.

### Example

### Pilot's View of a Structure Exercise

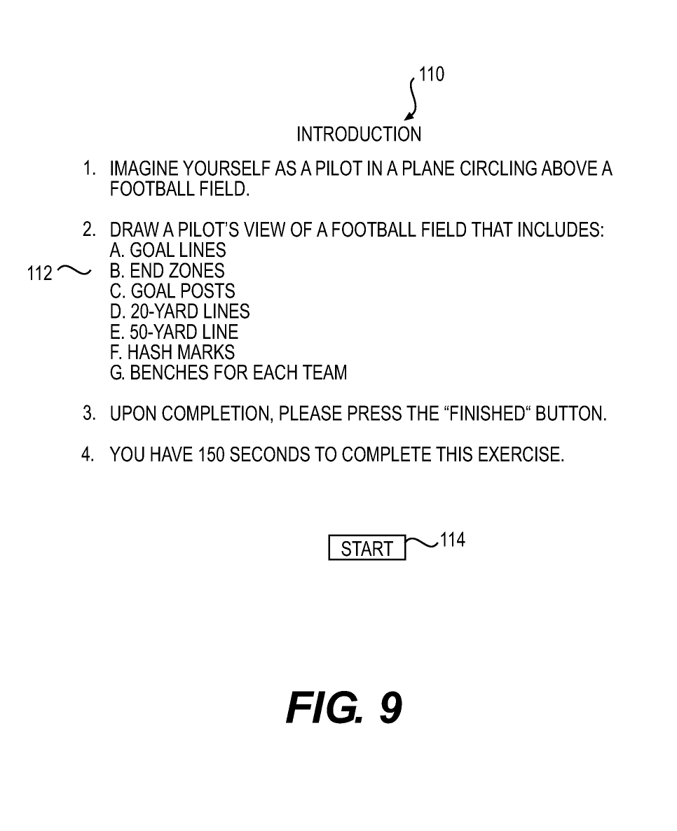

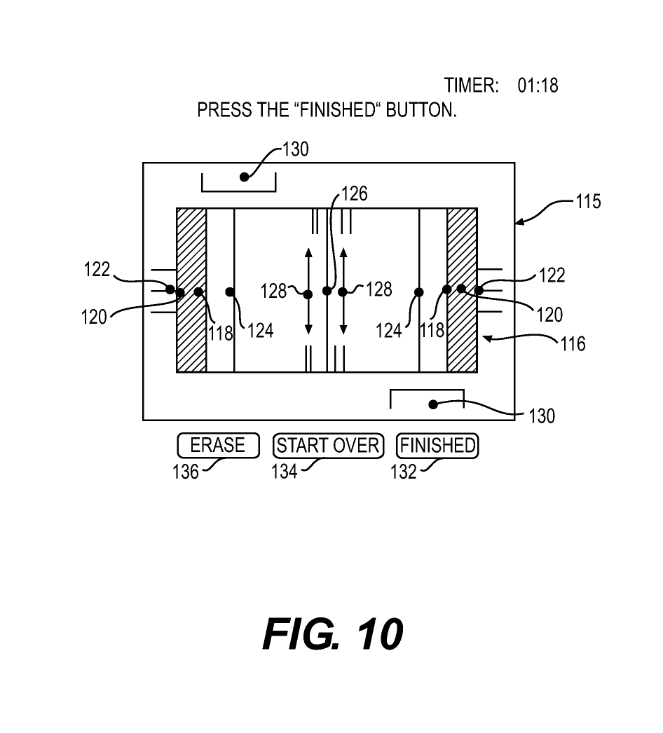

FIGS. 9 and 10 illustrate an exemplary embodiment of the “pilot's view of a structure” exercise. As shown in FIG. 9, at the beginning of the exercise, the assessment program can display a start screen 110 on the display including general instructions 112 and a “start” icon 114. The instructions 112 can instruct the participant to imagine himself flying over a football field, and to draw an overhead view of the football field, including: goal lines, end zones, goal posts, 20-yard lines, a 50-yard line, hash marks and benches for two football teams.

Referring to FIG. 10, once the participant selects the “start” icon 114, the exercise will begin on an exercise screen 115, and the participant can attempt to draw an overhead view of a football field 116, including: goal lines 118, end zones 120, goal posts 122, 20-yard lines 124, a 50-yard line 126 hash marks 128 and benches 130 for two football teams. According to certain embodiments, this exercise can be available for 2½ minutes (150 seconds), for example. The participant can be told/shown how much time is available to complete the exercise. During the exercise, the amount of time left can remain displayed on the display screen and “count down” on the display screen. The time taken to read instructions 112 can be subtracted from the time provided to complete the exercise. If the participant finishes the exercise prior to the time allotted, he can indicate that he is finished with the exercise by selecting a “finished” icon 132 on the display screen. Otherwise, the exercise will end when the predetermined allotted time expires. Optionally, the participant can start the exercise over by selecting a “start over” icon 134 on the display screen during the exercise or erase part of the image drawn by the participant by selecting an “erase” icon 136 and then using the user interface to erase part or all of the drawing on the display screen. If the participant elects to start the exercise over, the time allotted to complete the exercise will not be reset.

In embodiments in which a combination of written and oral instructions are to be provided to the participant, the instructions 112 can be displayed on the screen as well as read aloud via a computerized voice. The written and oral instructions can include the exact same wording. Time breakdown of each part can follow the same format as the written part noted above.

It is envisioned that this exercise can be offered in an advanced version (e.g., for professional/collegiate athletes) and a standard version (e.g., for high school athletes). In the advanced version, the participant could use his finger or a stylus to draw on a touch screen in order to perform the exercise. In the standard version, the participant could use a touch screen device and, secondarily, a mouse to perform the exercise. Participants must be involved in the exercise (i.e., be hands-on through the drawing of the structure) to maintain self-involvement. Ideally, choices of pre-rendered components of the structure to be drawn may not be displayed on the screen, because providing such choices on screen reduces self-involvement.

Data Collection

Timing and accuracy data related to the user inputs can be measured and recorded. This data can be processed to generate assessment scores that measure visual acuity and operational thinking skills of the participant. Timing and accuracy data measured and recorded by the assessment program can include the following:
The length of time it takes to read instructions;
The length of time it takes to complete a pilot's view drawing and submit;
The number of items that are accurately placed on the pilot's view drawing;
The number of items that are inaccurately placed and/or omitted on the pilot's view drawing;
The number of times the participant starts over.

Instruction comprehension determination is measured by the amount of time is takes to read (written) and/or read/hear (written/oral) the instruction. Comprehension should be quicker with the written/oral instruction (both instruction delivery formats as well as the second time around). Performance is measured by the frequency and accuracy of the pilot's view (i.e. perspective) and placement of the field and the items required to be drawn.

High-level exercise performance equates to short lengths of instruction time (e.g., less than 15 seconds), one attempt and high accuracy of pilot view perspective and item placement. Mid-level exercise performance equates to a combination of:
Short lengths of instruction time (e.g., less than 15 seconds), two (2) to three (3) attempts, and low-to-middle accuracy of pilot view perspective and item placement;
Middle lengths of instruction time (e.g., greater than 15 seconds but not longer than 45 seconds) and two (2) to three (3) attempts, and middle accuracy pilot view perspective and item placement.
   Low-level exercise performance equates to long lengths of instruction time (e.g., greater than 45 seconds), four (4) or more attempts, and/or low accuracy of pilot view perspective and item placement.

It should be understood that other structures or scenery may be substituted for the football field employed in this exercise, depending on the activity or profession for which the participant is being assessed. Additionally, it should be understood that variations of this exercise involving views of a structure other than a pilot's overhead view are possible.

Exercise No. 6: Crossword Puzzle

In the crossword puzzle exercise, the participant can be prompted to construct word answers in a puzzle of interconnected columns and rows of letter spaces based on clues for each column and row. The word answers can be related to traditional communication/language (e.g., words commonly known and used in a language) and non-traditional language (e.g., words related to codes and/or signals). The word answers related to non-traditional language can pertain to a sport, profession or activity in which the participant is involved. The crossword puzzle exercise assesses operational thinking and can be completed in one part.

### Example

### Crossword Puzzle Exercise

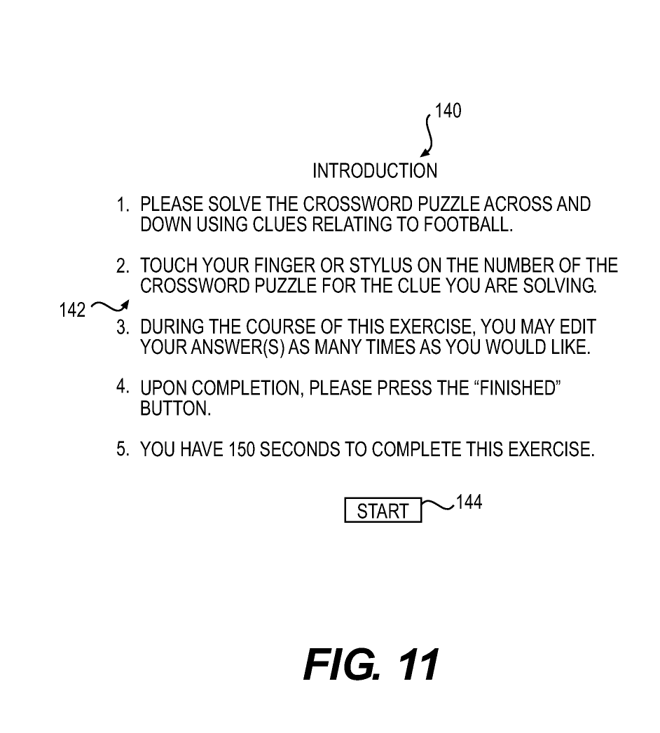

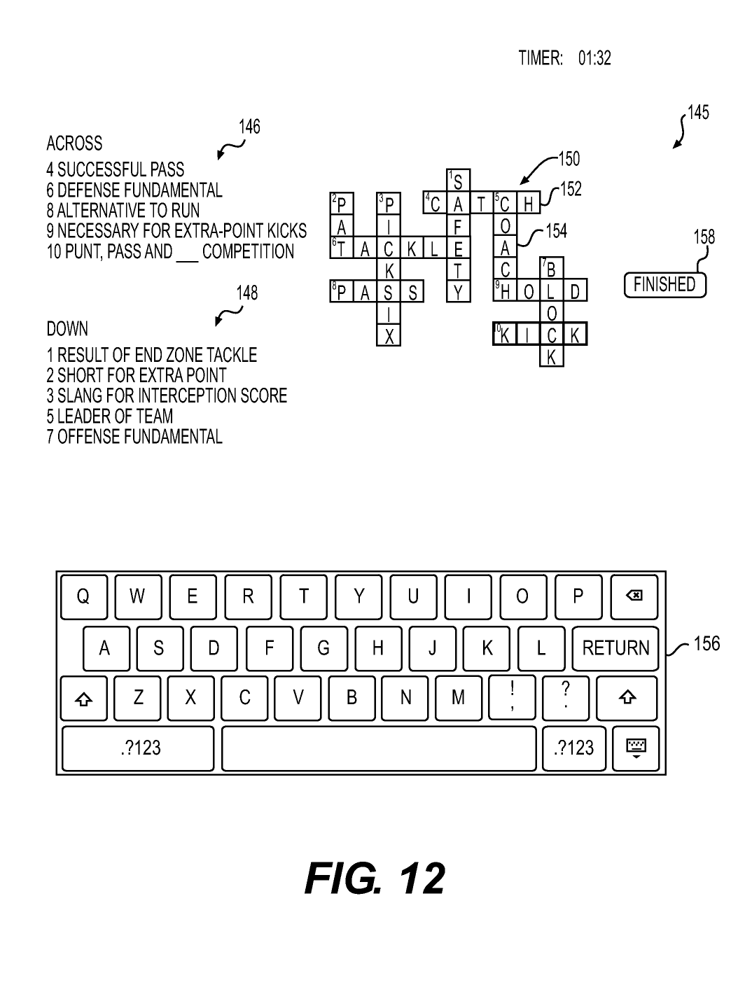

FIGS. 11 and 12 illustrate an exemplary embodiment of the crossword puzzle exercise. As shown in FIG. 11, at the beginning of the exercise, the assessment program can display a start screen 140 on the display including general instructions 142 and a “start” icon 144. The instructions 142 can instruct the participant to complete the following crossword puzzle using clues related to a particular sport, profession or activity (e.g., football).

Referring to FIG. 12, once the participant selects the “start” icon 114, the exercise will begin on an exercise screen 115 which includes a crossword puzzle 150 having rows 152 (“across” fields of letter spaces) and columns 154 (“down” fields of letter spaces). The screen 115 also includes clues 146 for the answers in the rows 152 and clues 148 for the answers in the columns 154. The clues 146, 148 can be related to football terminology. The participant can then attempt to solve the puzzle 150 by typing in answers to the clues 146, 148 in the appropriate rows 152 and columns 154. The answers can be typed in using a touch-sensitive virtual keyboard 156 displayed on the screen 145 or, alternatively with a physical keyboard (not shown). The participant can edit his answers as many times as desired, so long as the time allotted for the exercise has not expired. If the participant completes the puzzle 150, he can select the “finished” icon 158 to conclude the exercise. Otherwise, the exercise will conclude once the time allowed for the exercise expires.

According to some embodiments, the participant can be allotted 2½ minutes (150 seconds) to complete the exercise, for example. The participant can be told/shown how much time is available to complete the exercise. During the exercise, the amount of time left can remain displayed on the display screen and “count down” on the display screen.

In embodiments in which a combination of written and oral instructions are to be provided to the participant, the instructions 142 can be displayed on the screen as well as read aloud via a computerized voice. The written and oral instructions can include the exact same wording. Time breakdown of each part can follow the same format as the written part noted above.

It is envisioned that this exercise can be offered in an advanced version (e.g., for professional/collegiate athletes) and a standard version (e.g., for high school athletes). In the advanced version, the participant could use his finger or a stylus to select fields within the puzzle 150 and to type letters from the virtual keyboard 156 into the fields. In the standard version, the participant could use a mouse to select fields within the puzzle and a keyboard to type letters into the fields. Participants must be involved in the exercise (i.e., be hands-on throughout the exercise) to maintain self-involvement. Ideally, choices of pre-selected answers to the clues may not be displayed on the screen, because providing such choices on screen reduces self-involvement.

Data Collection

Timing and accuracy data related to the user inputs can be measured and recorded. This data can be processed to generate assessment scores that measure operational thinking skills of the participant. Timing and accuracy data measured and recorded by the assessment program can include the following:
The length of time it takes to read instructions;
The length of time (overall) it takes to complete the crossword puzzle;
The number of accurate completed answers in the crossword puzzle.

Instruction comprehension determination is measured by the amount of time is takes to read (written) and/or read/hear (written/oral) the instruction. Comprehension should be quicker with the written/oral instruction (both instruction delivery formats as well as the second time around).

Performance is measured by the number and accuracy of completed words in the crossword puzzle within the allotted time. High-level exercise performance equates to short lengths of instruction time (e.g., less than 15 seconds) and successful completion of the crossword puzzle (e.g., 90% accuracy or greater/nine (9) or more out of ten answers correct) within the time allotted. Mid-level exercise performance equates to a combination of:
Short lengths of instruction time (e.g., less than 15 seconds), and six (6) to eight (8) out of ten (10) successfully completed words in the puzzle within the time allotted, for example;
Middle lengths of instruction time (e.g., greater than 15 seconds but not longer than 45 seconds) and seven (7) or more successfully completed words in the puzzle within the time allotted, for example.
   Low-level exercise performance equates to long lengths of instruction time (e.g., greater than 45 seconds) and five (5) or fewer out of ten (10) successfully completed words in the puzzle within the time allotted the time allotted, for example.

It should be understood that the crossword puzzle can relate to sports, activities and professions other than football, depending on the sport, activity or profession for which the participant is being assessed.

Exercise No. 7: Letter or Symbol Placement

Execution of skill and performance of technique are important. The ability to master the fundamentals and continue to execute them well over time and under increasingly difficult circumstances is essential for success at the individual and team level. A solid foundation in skill and technique is what champion athletes and teams are built on. A solid foundation in skill and technique is also essential to performance in other sports, activities and professions.

The inventors understand that people define, process, and execute the skills and technique of activities (e.g., football) differently at the individual level. This is because, in the fundamentals, there is a simple right way of doing a specific task and although our instructions may come in different forms, feedback is clear, immediate, and standards based. If athletes, employees or other participants are to finish activities as focused as they are when they start the activities, and deliver consistent performance in the skills, one must discover how each person masters and maintains excellence in the execution of skill during the application of technique.

Fundamental Phases

Regardless of talent level, everyone moves through three distinct phases of development in fundamental skills and abilities. First one acclimates, then one performs, and finally one masters the task(s) of a particular activity. Knowing how an athlete, for example, progresses through each phase provides the unique opportunity to lead them to optimal performance when conventional methods of “harder” and “longer” fail.

Acclimation

Once a person is presented with a new fundamental task requiring skills, he makes sense of it and develops mental shortcuts by focusing his attention on mentally understanding the task's basic mental and physical requirements. During this phase the person acclimates through repetition by rapidly reducing the mental energy and time spent thinking about how he should do the activity while maintaining basic or elevated motor skills. This experimentation allows the person to accept fluctuating levels of accuracy as he “gets how to do it.”

Performance

The drive for accuracy and efficiency takes over as a person begins multi-tasking by blending thinking and acting while focusing on “doing it the right way.” So much can be gained by understanding how a person processes and executes the blending of the required mental and physical components of a task, how accurate he is and how long he can sustain performance of the task. Performance is where a person executes automatically.

Mastery

As a person becomes automated after getting the hang of a skill, he will either continue to improve and become more efficient or he may lose focus. The inventions herein provide evaluators with the data needed to sustain a person's grit and continued improvement, or to effectively address his loss of focus and lack of attention to detail in the execution of skill and application of technique in his performance. Whereas some people acclimate slowly, and then perform and master quickly and efficiently, others acclimate quickly then suffer a drastic decline in their processing and execution of skill or technique.

With the above in mind, the inventors have developed the “letter or symbol placement” exercise. In the letter or symbol placement exercise, the participant views a grid of first symbols and second symbols that are randomly colored or shaded and randomly arranged in several rows and several columns. In response to instructions to move designated symbols or letters to designated positions in the grid, the participant interacts with the user interface to attempt to move the designated symbols to the designated positions. The participant then views a target pattern formed by the designated symbols being correctly moved to the designated positions and checks to determine whether the participant's attempts form the target pattern. The letter or symbol placement exercise assesses visual acuity, operational thinking and behavior and, according to one embodiment, can be completed in one part.

### Example

### Letter or Symbol Placement Exercise

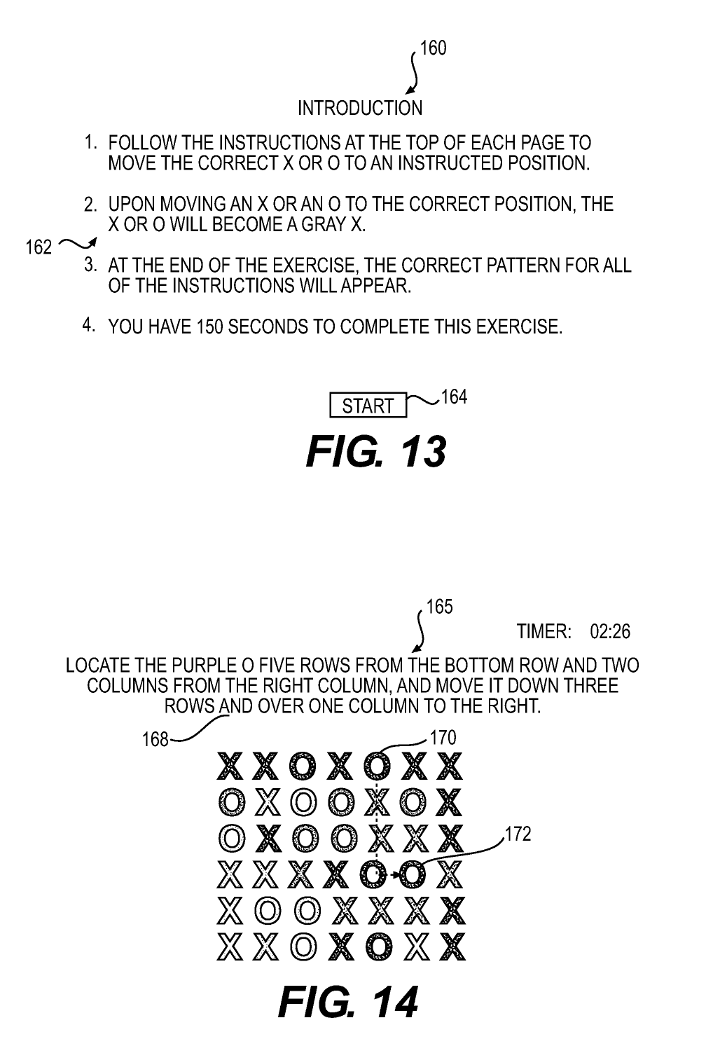

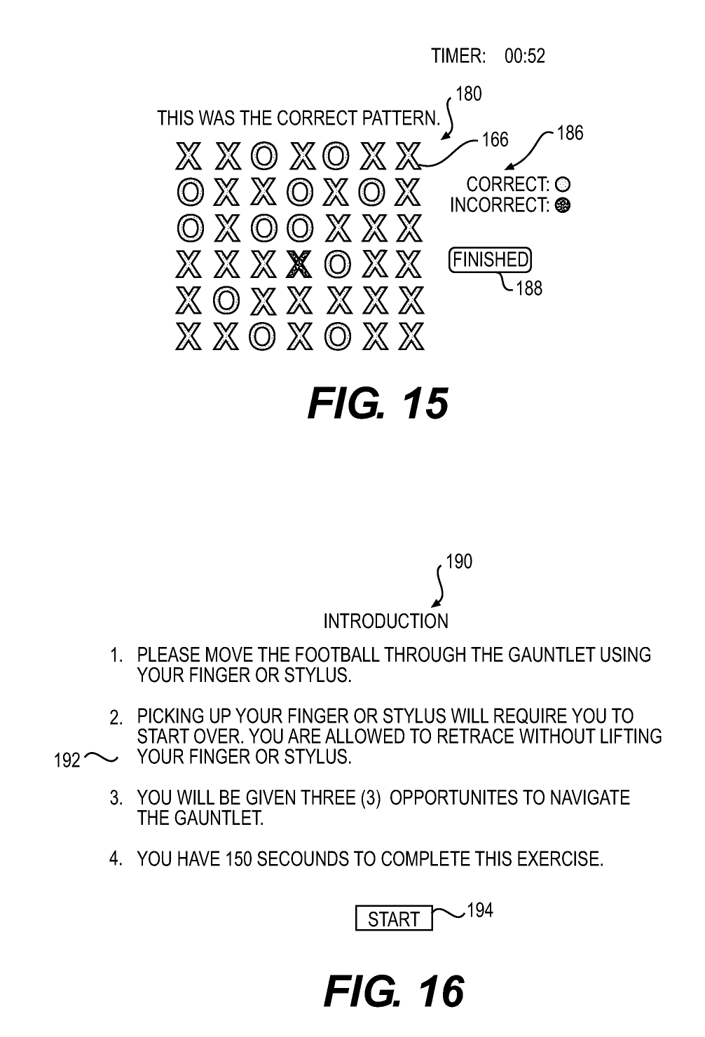

FIGS. 13-15 illustrate an exemplary embodiment of the “pilot's view of a structure” exercise. As shown in FIG. 13, at the beginning of the exercise, the assessment program can display a start screen 160 on the display including general instructions 162 and a “start” icon 164. The instructions 162 can instruct the participant to view a grid of first symbols (X's) and second symbols (O's) that are randomly colored or shaded and randomly arranged in several rows and several columns. The instructions 162 can instruct the participant to move the designated X's and O's according to further instructions that will subsequently be given.

Referring to FIG. 14, once the participant selects the “start” icon 164, the exercise will begin on an exercise screen 165 including a grid 166 of symbols/letters (X's and O's) that are randomly colored or shaded and randomly distributed in the grid 166. Specific instructions 168 can appear on the screen 165/be announced to instruct the participant to move a particular symbol (e.g., the “O” indicated by numeral 170) to a designated position 172 on the grid 166. In this example, the instructions 168 instruct the participant to locate the purple “O” located five (5) rows from the bottom row in the grid 166 and two (2) columns from the right column and move the purple “O” (170) down three columns and over one column to the right (position 172). Using the user interface, the participant can attempt to select the designated “O” (170) and move it to the designated position 172. When the participant selects one of the symbols/letters in the grid 166, the selected symbol/letter can temporarily change in appearance (e.g., turn gray) to indicate it has been selected and then turn back to its original appearance so as not to provide ongoing assistance to the participant. During instruction and throughout the exercise, background noise and sounds such as bands playing and crowd noise can be incorporated into the exercise, if desired.

After the user attempts the move requested by the instructions 162, a subsequent screen can be generated with additional instructions indicating a symbol/letter move for the participant to make. The participant can then attempt the instructed move. This process of instructions and moves can be repeated as many times as desired. According to certain embodiments, this exercise can be available for 2½ minutes (150 seconds), for example. The participant can be told/shown how much time is available to complete the exercise. During the exercise, the amount of time left can remain displayed on the display screen and “count down” on the display screen. Upon selecting the “start” icon 164 at the beginning of the exercise, the time taken to read instructions 162 can be subtracted from the time provided to complete the exercise, and divided by the number of remaining instructions to be provided in order to complete exercise. This rebalancing of remaining time can be applied after each completed instruction.

If the participant completes all move attempts prior to time running out for the exercise, or once time for the exercise runs out, the assessment program will display an ending screen 180 indicating correct and in correct symbol/letter moves by applying different shading/coloring to X's and/or O's on the grid 166 that were correctly moved and incorrectly moved. The shading/coloring of correct and incorrect moves can be indicated in a legend 186 on the screen 180. Optionally, the assessment program can display a target pattern (not shown) formed by the correct movement of X's and/or O's in comparison to the pattern of X's and/or O's formed by the actual moves performed by the participant.

If the participant finishes reviewing the correct moves/target pattern prior to the time allotted, he can indicate that he is finished with the exercise by selecting a “finished” icon 188 on the screen 180. Otherwise, the exercise will end when the predetermined allotted time expires.

In embodiments in which a combination of written and oral instructions are to be provided to the participant, the instructions 162, 168 can be displayed on the screen as well as read aloud via a computerized voice. The written and oral instructions can include the exact same wording. Time breakdown of each part can follow the same format as the written part noted above.

It is envisioned that this exercise can be offered in an advanced version (e.g., for professional/collegiate athletes) and a standard version (e.g., for high school athletes). In the advanced version, the participant could use his finger or a stylus to execute moves on a touch screen in order to perform the exercise. In the standard version, the participant could use a touch screen device and, secondarily, a mouse to perform the exercise. Participants must be involved in the exercise (i.e., be hands-on through the movements) to maintain self-involvement. Ideally, preselected choices indicating possible moves may not be displayed on the screen, because providing such choices on screen reduces self-involvement.

Data Collection

Timing and accuracy data related to the user inputs can be measured and recorded. This data can be processed to generate assessment scores that measure visual acuity, operational thinking and behavior skills of the participant. Timing and accuracy data measured and recorded by the assessment program can include the following:
The length of time it takes to read instructions;
The length of time (each attempt) it takes to successfully place the items per each X and O position (i.e. each of the 7 instructions will be timed);
The length of time (overall) it takes to successfully place the items per each X and O position (i.e. how long it takes to complete the overall pattern/design);
The accuracy of each X and O placement in accordance with the detailed instructions;
The accuracy of total X and O placement (the overall pattern/design) in accordance with the detailed instructions.
The accuracy in determining the pattern.

Instruction comprehension determination is measured by the amount of time is takes to read (written) and/or read/hear (written/oral) the instruction. Comprehension should be quicker with the written/oral instruction (both instruction delivery formats as well as the second time around).

Performance is measured by the length of time (amount and within the allotment) and accuracy for each X and O placement. High-level exercise performance equates to short lengths of instruction time (e.g., less than 20 seconds for initial instruction and less than 10 seconds per X and O instruction) to successfully place each X and O within the time allotted (i.e., the X and O pattern/design was successfully completed). Mid-level exercise performance equates to a combination of:
Short lengths of instruction time (e.g., less than 20 seconds) and six (6) to seven (7) out of seven (7) placements successfully placed within the time allotted;
Middle lengths of instruction time (e.g., greater than 20 seconds but not longer than 45 seconds) and four (4) to five (5) out of seven (7) placements successfully placed within the time allotted.
   Low-level exercise performance equates to long lengths of instruction time (i.e. greater than 45 seconds) and three (3) or fewer out of seven (7) placements successfully placed within the time allotted.

It should be understood that other letters, symbols or numbers can be used in this exercise instead of X's and O's.

Exercise No. 8: Letter or Symbol Pattern Maze

The “letter or symbol pattern maze” exercise involves a participant interacting with the user interface to attempt to move an icon throughout a maze of symbols. In this exercise, the participant attempts to move the icon from a beginning of the maze to an end of the maze, without disrupting contact between the participant's finger or stylus and the touch screen. The “letter or symbol pattern maze” exercise assesses visual acuity, operational thinking and behavior, and, according to one embodiment, can be completed in one part.

### Example

### Letter or Symbol Maze Pattern

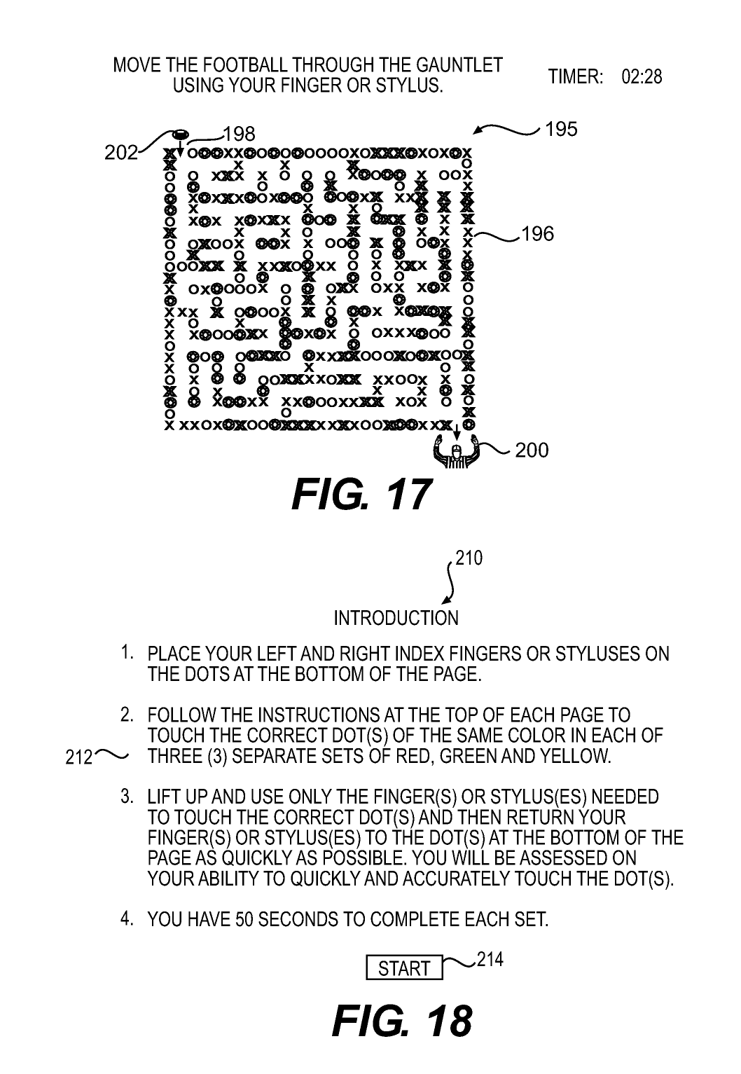

FIGS. 16 and 17 illustrate an exemplary embodiment of the “letter or symbol pattern maze” exercise. As shown in FIG. 16, at the beginning of the exercise, the assessment program can display a start screen 190 on the display including general instructions 192 and a “start” icon 194. The instructions 192 can instruct the participant to move an icon on the following screen through a maze (or gauntlet). The participant is further instructed that he must maintain contact between his finger or a stylus and the touch screen while moving the icon (with backtracking or retracing through the maze being allowed) because lifting his finger or the stylus from the touch screen will require him to restart the exercise at the beginning of the maze. After reading the instructions 192, the participant can select the “start” icon 194 to begin execution of the exercise.

Referring to FIG. 17, after the participant selects the “start” icon 194, an exercise screen 195 is generated. The exercise screen 195 includes a maze 196 defined by walls composed of symbols (such as X's and O's) and including a beginning point 198 and an ending point 2000. An icon 202 (e.g., a football) is positioned at the beginning point 198. The user can interact with the user interface to attempt to move (or drag) the icon 202 through the maze 196 from the beginning point 198 to the ending point 200, while maintaining contact between his finger and the touch screen or his stylus and the touch screen. In alternate embodiments in which the participant uses a keyboard or a mouse, the participant must attempt to maintain actuation of a key on the keyboard or a button on the mouse. As long as appropriate contact with the user interface is maintained, the participant can back track his movement path through the maze 196.

According to an embodiment, the participant can be given a limited number of opportunities (e.g., three (3)) to succeed within a time limit. According to an embodiment, the time limit can be 2½ minutes (150 seconds). The participant can be told/shown how much time is available to complete the exercise. During the exercise, the amount of time left can remain displayed on the display screen and “count down” on the display screen. Each time the participant lifts his finger or stylus from the touch screen, a sound can be generated by the assessment program, which will signal that the finger or stylus has been lifted and the participant has to start over. The exercise will conclude when the participant successfully moves the icon 202 through the maze 196, runs out of attempts or runs out of time.

In embodiments in which a combination of written and oral instructions are to be provided to the participant, the instructions 192 can be displayed on the screen as well as read aloud via a computerized voice. The written and oral instructions can include the exact same wording. Time breakdown of each part can follow the same format as the written part noted above.

It is envisioned that this exercise can be offered in an advanced version (e.g., for professional/collegiate athletes) and a standard version (e.g., for high school athletes). In the advanced version, the participant could use his finger or a stylus to execute moves on a touch screen in order to perform the exercise. In the standard version, the participant could use a touch screen device and, secondarily, a mouse to perform the exercise. Participants must be involved in the exercise (i.e., be hands-on through the movements) to maintain self-involvement.

Data Collection

Timing and accuracy data related to the user inputs can be measured and recorded. This data can be processed to generate assessment scores that measure visual acuity, operational thinking and behavior skills of the participant. Timing and accuracy data measured and recorded by the assessment program can include the following:
The length of time it takes to read instructions;
The length of time (each attempt) finger remains on the screen;
The length of time (overall) it takes to reach the end of the maze or exercise takes without successful navigation;
The number of attempts to complete the maze (e.g., maximum of three (3) opportunities).

It should be understood that other letters, symbols or numbers can be used in this exercise instead of X's and O's.

Exercise No. 9: Finger Reaction and Placement

Players at every position in a sport must be able to read and react appropriately. Raw speed and power are important, but what separates the great from the good is their ability to apply athletic ability accurately and efficiently. Certain players always seem to be in the right place at the right time, and their ability to read a situation and react correctly consistently gives them the edge over a stronger and faster opponent. The skills ability to read and react appropriately is also important to many activities other than sports.

The inventors understand that athletes define, process, and execute the dynamic elements of their environment differently at the individual level. The critical components of reading and reacting are hand-eye coordination, pattern matching, vigilance and response. The inventors have also discovered an empirical evidence linking an athlete's competitiveness and the rate and accuracy at which the read and react over time.

Critical Components

Regardless of raw physical or cognitive ability, everyone encounters the same challenges to reading and reacting. Emerging cues from our environment are identified and classified, and patterns are recognized. A person's competitiveness can also be measured, as can the accuracy of their reading and reaction in a dynamic environment. The inventions provide the data necessary to understanding how a person reads and reacts, specifically in terms of their performance within the critical components of reading and reacting.

Capture

As new elements of a dynamic environment emerge, we must ignore the clutter and capture those cues that are meaningful. While some people capture an initial cue quickly and accurately, they may be slower to react to subsequent new cues. Likewise some people might capture cues more deliberately over time but never miss a new one.

Pattern Recognition

Learning to read and react more efficiently involves pattern recognition. Some people learn patterns more quickly than others and the disclosed methods and systems are able to measure whether an athlete's pattern recognition improves or degrades as the need for stamina and increased vigilance is introduced over time.

Reaction

Hand-eye coordination and the ability to maintain it are essential to performance after reading cues from the environment. After reading initially reacting, some people sustain their performance in a dynamic environment while others lose concentration from the strain of the vigilance required to keep up with emerging patterns and cues that must be read.

Competitiveness

Complacency kills performance. People must be prepared mentally, physically, and emotionally for every play in an athletic competition or every task in a professional or educational activity. A person who can read and react efficiently and accurately, yet is not competitive may be too easily satisfied with methods of execution that are no longer effective. This is deadly in a dynamic environment where adjustments are constantly made by an opponent.

Accuracy

Reading and reacting correctly is essential. Without accuracy, energy is wasted and misdirected. Some people with extreme levels of competition may read and react very quickly but without accuracy. This is often confused with hustle until the results have stacked up in favor of the opponent.

The ability to read and react efficiently is vital for all positions in sports and for many professional and educational activities. It is also trainable, but only if you know how a person reads and reacts by identifying strengths and challenges in the components of reading and reacting at the individual level then discovering how each person individually improves.

With the above in mind, the inventors have developed the “finger reaction and placement exercise.” In this exercise, the participant places a left finger or left stylus on a left finger starting icon displayed on the touch screen and places a right finger or right stylus on a right finger starting icon displayed on the touch screen. The participant views a set of additional icons generated by the reaction and placement exercise—the set of additional icons includes one or more matching icons that match the left finger starting icon and/or the right finger starting icon. The participant then attempts to touch the one or more matching icons with at least one of the left finger or left stylus and the right finger or right stylus in response to the one or more matching icons appearing on the touch screen. The “finger reaction and placement exercise” assesses visual acuity, operational thinking and behavior. According to one embodiment, the exercise can be completed in three sets.

### Example

### Finger Reaction and Placement Exercise

FIGS. 18-20 illustrate an exemplary embodiment of the “finger reaction and placement” exercise. As shown in FIG. 18, at the beginning of the exercise, the assessment program can display a start screen 210 on the display including general instructions 212 and a “start” icon 214. The instructions 212 can instruct the participant to place his left and right fingers or styluses on the corresponding left finger icon and right finger icons (e.g., dots) on the following screen. The participant is further instructed to touch the designated dots (e.g., flashing) matching (e.g., in design, color and/or markings) the left finger icon and/or the right finger icon with the correct finger, and return the correct finger to the left finger icon and/or the right finger icon as quickly as possible after touching the correct dots. The participant is advised that he should only lift the finger(s) or stylus(es) needed to touch the designated icons. After reading the instructions 212, the participant can select the “start” icon 214 to begin execution of the exercise.

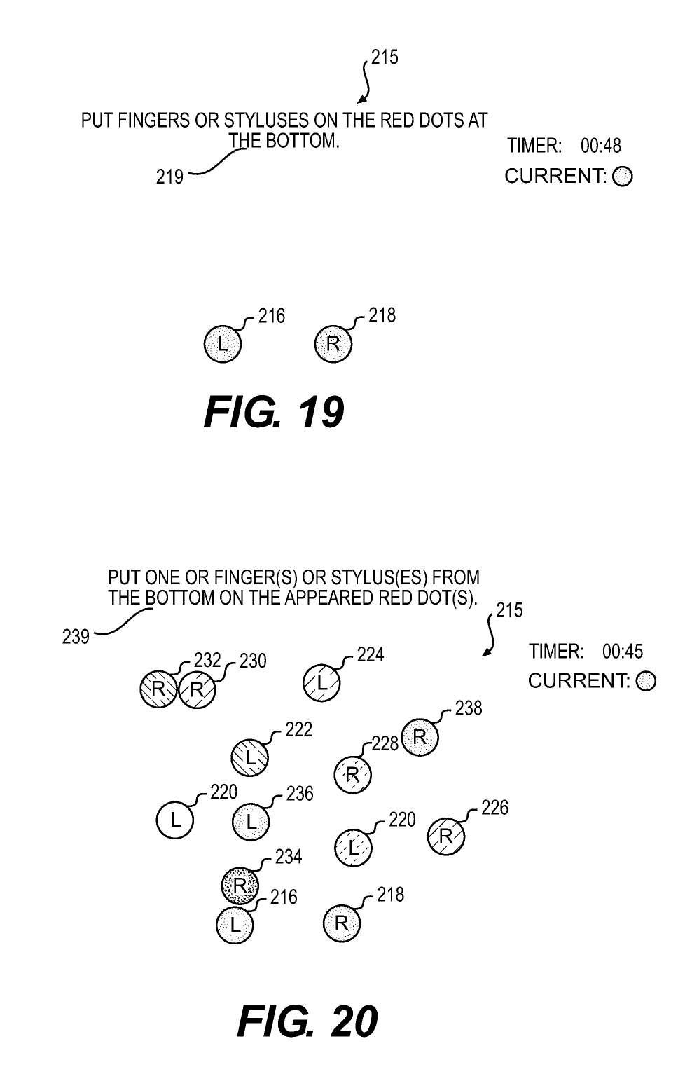

As shown in FIG. 19, after the participant selects the “start” icon 214, an exercise screen 215 including an initial left finger icon (dot) 216, an initial right finger icon (dot) 218 and instructions 219 directing the participant to place his left finger or stylus on the initial left finger icon 216 and place his right finger or stylus on the initial right finger icon 218. The initial left finger icon 216 and the initial right finger icon 218 can be marked with the letters “L” and “R” (or other letter(s) or symbol(s)), respectively so that the participant can visually distinguish the icons 216, 218.

As shown in FIG. 20, once the participant's fingers or styluses are correctly placed on the initial right and left icons 216, 218, multiple additional icons will appear on the screen 215, including icons 220, 222, 224, 226, 228, 230, 232, 234 similar to the initial icons 216, 218 but having different colors, and one or more icons matching icons 236, 238 matching (same color) the initial left finger icon 216 and/or the initial right finger icon 218. The participant is then instructed via instructions 239 to place his left finger or stylus and/or his right finger or stylus on the matching icon 236, 238. According to an embodiment, the matching icons 236, 238 for the initial icons 216, 218 will begin to flash. When the participant sees the icons 236, 238 flash, the participant is to attempt to remove the correct fingers from their respective initial icons 216, 218 and correctly touch only the matching icons 236, 238 before the matching icons 236, 238 disappear (e.g., after two seconds) from the screen 215. Then, the participant is to attempt to return his fingers that he used to the initial icons 216, 218.

Once the matching icons 236, 238 are touched or disappear due to time lapse, one or more new matching icons will appear on the screen. Matching icons will continue to display and disappear on the screen 215 until the time allotted for a set of the exercise expires. The quicker the participant's responses are, the more attempts there will be to complete. Therefore, the participant should attempt to touch matching icons and return his fingers or styluses to the initial icons 216, 218 as quickly do this as quickly as possible once matching icons begin to flash.

According to an embodiment, this exercise can be done in three (3) sets using different colored (e.g., red, green and yellow) initial icons 216, 218 in each set (color-blind-neutral colors can be used).

According to a preferred embodiment, the participant is only to touch the matching icons that are requested during the exercise. For example, in such an embodiment, there can be six (6) different positions possible for matching icons (right-to-right across, right-to-right crossover, left-to-left across, left-to-left crossover, both-to-both across, and both-to-both crossover).

According to an exemplary embodiment, the time limit can be 2½ minutes (150 seconds). The participant can be told/shown how much time is available to complete the exercise. During the exercise, the amount of time left can remain displayed on the display screen and “count down” on the screen. The time taken to read instructions 219, 239 will be subtracted, along with 5 seconds of transition time for the second and third sets of the exercise (total of 10 seconds) to engage, from the time provided to complete the exercise (e.g., 2½ minutes) and divided by three (3) to determine the length of time for each set.

In embodiments in which a combination of written and oral instructions are to be provided to the participant, the instructions 219, 239 can be displayed on the screen as well as read aloud via a computerized voice. The written and oral instructions can include the exact same wording. Time breakdown of each part can follow the same format as the written part noted above.

It is envisioned that this exercise can be offered in an advanced version (e.g., for professional/collegiate athletes) and a standard version (e.g., for high school athletes). In the advanced version, the participant could use his finger or a stylus to execute moves on a touch screen in order to perform the exercise. In the standard version, the participant could use a touch screen device and, secondarily, a mouse to perform the exercise. Participants must be involved in the exercise (i.e., be hands-on through the movements) to maintain self-involvement.

Data Collection

Timing and accuracy data related to the user inputs can be measured and recorded. This data can be processed to generate assessment scores that measure visual acuity, operational thinking and behavior skills of the participant. Timing and accuracy data measured and recorded by the assessment program can include the following:
The length of time it takes to read instructions;
The length of time (each attempt) it takes to successfully match a finger (or fingers) during each Set;
The length of time (overall) it takes to successfully match a finger (or fingers) during each Set;
The number of attempts to match a finger (or fingers) during each set;
The accuracy of each finger(s) match during each set;
The accuracy of total finger(s) match during all three (3) sets.

Instruction comprehension determination is measured by the amount of time is takes to read (written) and/or read/hear (written/oral) the instruction. Comprehension should be quicker with the written/oral instruction (both instruction delivery formats as well as the second time around).

Performance is measured by the length of time (amount and within the allotment) and accuracy for each item/group arrangement. High-level exercise performance equates to short lengths of instruction time (e.g., less than 15 seconds), quick response time during each finger(s) match (e.g., less than 2 seconds) and set; high number of attempts to finger(s) match within the allotted time (e.g., 13 or more attempts each set); and accuracy level during the finger(s) match (e.g., 90% or better). Mid-level exercise performance equates to a combination of:
Short lengths of instruction time (e.g., less than 15 seconds) and fairly quick response time during each finger(s) match (e.g., less than 5 seconds) and set; fairly high number of attempts to finger(s) match within the allotted time (e.g., 9-12 attempts each set); and accuracy level during the finger(s) match (i.e. 70% or better).
Middle lengths of instruction time (i.e. greater than 15 seconds but not longer than 45 seconds), average response time during each finger(s) match (e.g., 5-10 seconds) and set; average number of attempts to finger(s) match within the allotted time (6-8 attempts each set); and accuracy level during the finger(s) match (e.g., 80% or better).
   Low-level exercise performance equates to long lengths of instruction time (e.g., greater than 45 seconds) and slow response time during each finger(s) match (e.g., greater than 10 seconds) and set; low number of attempts to finger(s) match within the allotted time (e.g., 5 or fewer attempts each set); and accuracy level during the finger(s) match (e.g., 70% or lower).

Exercise No. 10: Icon Interception

In the “icon interception” exercise, the participant first places a left finger or left stylus on an initial left finger icon displayed on the touch screen and places a right finger or right stylus on an initial right finger icon displayed on the touch screen. Additional icons are then displayed on the touch screen and, in accordance with instructions provided by the exercise, the participant then attempts to correctly move at least one of the left finger/left stylus and the right finger/right stylus to move a designated icon among the additional icons to intercept (or move into) a matching icon that matches the designated icon (e.g., same color, design and/or marking) in a particular location. The “icon interception exercise” assesses visual acuity, operational thinking and behavior. According to one embodiment, the exercise can be completed in four sets.

### Example

### Icon Interception Exercise

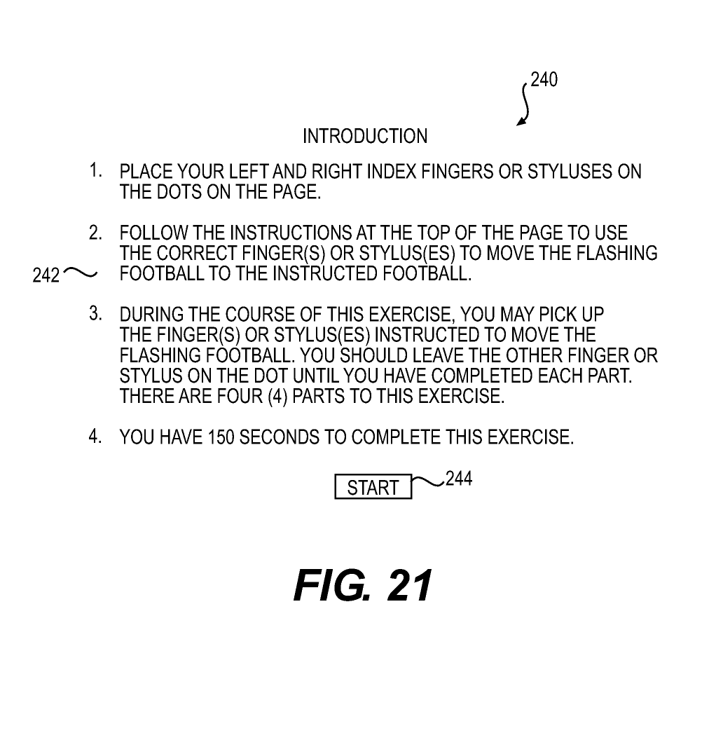

FIGS. 21-23 illustrate an exemplary embodiment of the “icon interception exercise.” As shown in FIG. 21, at the beginning of the exercise, the assessment program can display a start screen 240 on the display including general instructions 242 and a “start” icon 244. The instructions 242 can instruct the participant to place his left and right fingers or styluses on the corresponding initial left finger icon (e.g., dot) and initial right finger icon (e.g., dot) on the following screen. The participant is also instructed to use the correct finger or stylus to move a designated (e.g., flashing) icon to intercept a matching icon (e.g., in design, color and/or markings) as described by further instructions. The participant is advised that he should only lift the finger(s) or stylus(es) needed to move the designated icon. After reading the instructions 242, the participant can select the “start” icon 244 to begin execution of the exercise.

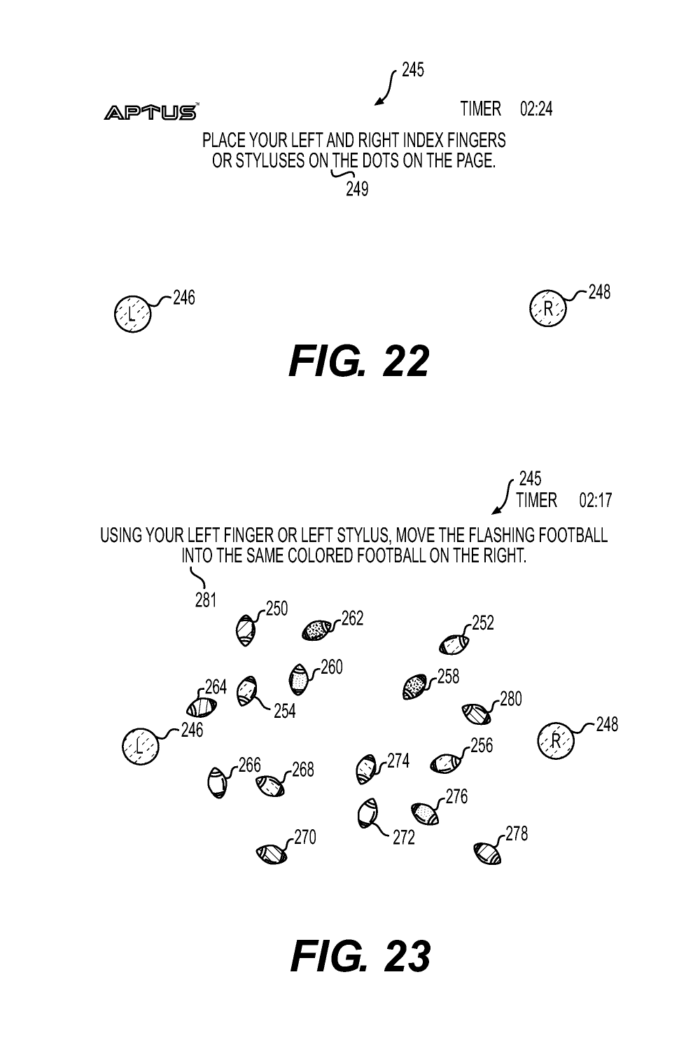

Referring to FIG. 22, after the participant selects the “start” icon 244, an exercise screen 245 including an initial left finger icon 246, an initial right finger icon 248 and instructions 249 directing the participant to place his left finger or stylus on the initial left finger icon 246 and place his right finger or stylus on the initial right finger icon 248. The initial left finger icon 246 and the initial right finger icon 220 can be marked with the letters “L” and “R” (or other letter(s) or symbol(s)), respectively so that the participant can visually distinguish the icons 218, 220.

As shown in FIG. 20, once the participant's fingers or styluses are correctly placed on the initial right and left icons 246, 248, multiple icons 250, 252, 254, 256, 258, 260, 262, 264, 266, 268, 270, 272, 274, 276, 278, 280 (e.g., footballs) having a variety of colors will appear on the screen 245. The participant is then instructed via instructions 239 use his left finger or stylus to move a designated icon 254 to intercept a matching icon 256 (e.g., same color) according to instructions 281 specifying the color match and location of the matching icon 256. According to an embodiment, the designated icon 254 will flash. When the participant sees the designated icon 254 flash, the participant is to attempt to remove only the correct (left) finger from its respective initial icon (initial left icon 246) and correctly move the designated icon 254 to intercept the matching icon 256. Then, the participant is to attempt to return the correct (left) finger that he used to the correct initial icon (initial left finger icon 246). In performing this exercise, the participant is to leave the other, unused (right) finger or stylus on its respective initial icon (initial right finger icon 248). The participant should attempt to perform movements as quickly as possible once the designated icon 254 begins to flash.

According an embodiment, as the participant is moving the designated icon 254, one or more of the additional icons 250, 252, 256, 258, 260, 262, 264, 266, 268, 270, 272, 274, 276, 278, 280 and/or the designated icon 254 may move about the screen 245 to provide additional challenge in intercepting the designated icon. Additionally movements of the designate icon 254 may not necessarily correspond directly (in direction or distance) to the participant's finger movements in order to provide additional challenge.

According to an exemplary embodiment, the time limit can be 2½ minutes (150 seconds). The participant can be told/shown how much time is available to complete the exercise. During the exercise, the amount of time left can remain displayed on the display screen and “count down” on the screen. The time taken to read instructions 249, 281 will be subtracted, along with 5 seconds of transition time for the second, third and fourth sets of the exercise (total of 15 seconds) to engage, from the time provided to complete the exercise (e.g., 2½ minutes) and divided by four (4) to determine the length of time for each set. If the participant successfully intercepts a matching icon with a designated icon within the time allotted for the set, the screen 245 resets with new additional icons and instructions for making an additional interception using a designated icon. This process will be repeated until the segment of time allowed for the set expires. Once a segment of time for a set expires, a new set begins.

In embodiments in which a combination of written and oral instructions are to be provided to the participant, the instructions 249, 281 can be displayed on the screen as well as read aloud via a computerized voice. The written and oral instructions can include the exact same wording. Time breakdown of each part can follow the same format as the written part noted above.

It is envisioned that this exercise can be offered in an advanced version (e.g., for professional/collegiate athletes) and a standard version (e.g., for high school athletes). In the advanced version, the participant could use his finger or a stylus to execute moves on a touch screen in order to perform the exercise. In the standard version, the participant could use a touch screen device and, secondarily, a mouse to perform the exercise. Participants must be involved in the exercise (i.e., be hands-on through the movements) to maintain self-involvement.

Data Collection

Timing and accuracy data related to the user inputs can be measured and recorded. This data can be processed to generate assessment scores that measure visual acuity, operational thinking and behavior skills of the participant. Timing and accuracy data measured and recorded by the assessment program can include the following:
The length of time it takes to read instructions;
The length of time (each attempt) it takes to successfully intercept a designated icon during each set;
The length of time (overall) it takes to successfully intercept a designated icon during each set;
The number of attempts to intercept an icon during each set;
The accuracy of each interception during each set;
The accuracy of total interceptions during all four (4) sets.

Instruction comprehension determination is measured by the amount of time is takes to read (written) and/or read/hear (written/oral) the instruction. Comprehension should be quicker with the written/oral instruction (both instruction delivery formats as well as the second time around).

Performance is measured by the length of time (amount and within the allotment) and accuracy for each item/group arrangement. High-level exercise performance equates to short lengths of instruction time, quick response time during each interception and set; high number of attempts to perform an interception within the allotted time; and accuracy level during the interception. Mid-level exercise performance equates to a combination of:
Shorts lengths of instruction time (e.g., less than 15 seconds) and fairly quick response time during each interception and set; fairly high number of attempts to intercept within the allotted time; and accuracy level during the interception.

Middle lengths of instruction time, average response time during each interception and set; average number of attempts to intercept within the allotted time; and accuracy level during the interception

Low-level exercise performance equates to long lengths of instruction time and slow response time during interception and set; low number of attempts to intercept within the allotted time; and accuracy level during the interception.

It should be understood that various other types of icons other than footballs can be used in this exercise.

Assessment Analysis and Reporting

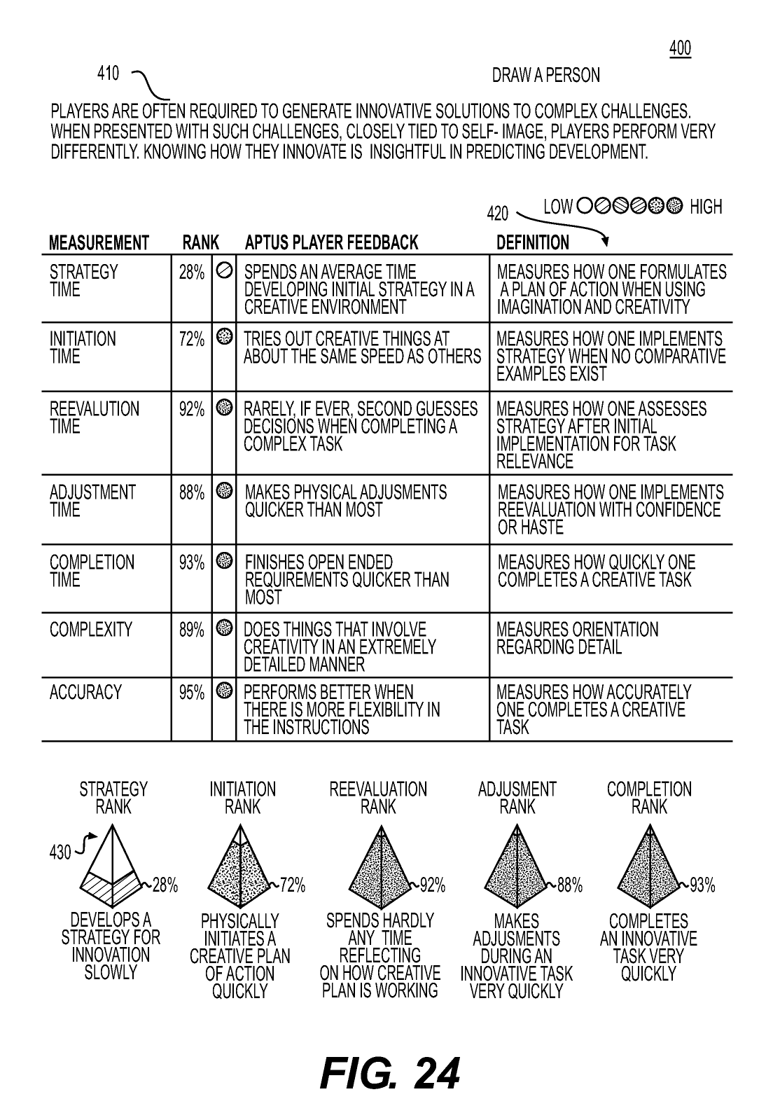

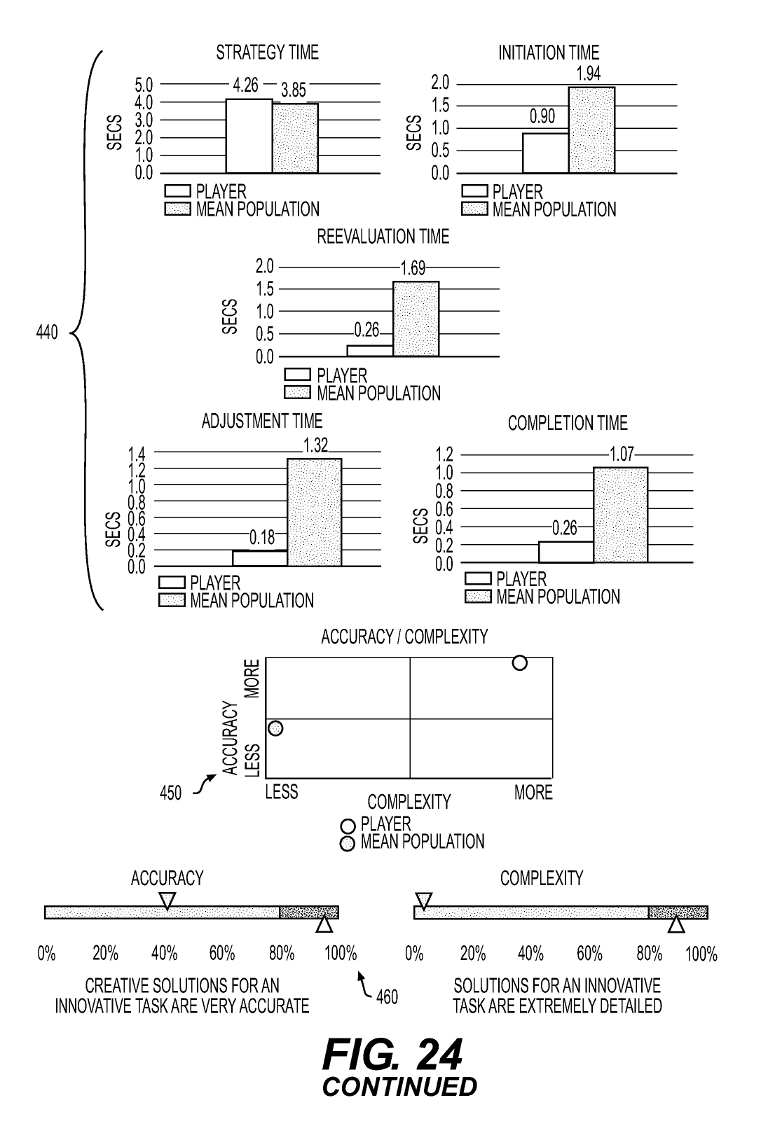

As indicated in the preceding exercise descriptions, the participant's performance in each assessment exercise can be analyzed individually and reported in an assessment report. The assessment reports can be a computer-generated report displayed on the display of the user device used by the participant being assessed. Additionally, the assessment report can be stored on a memory device for viewing on any PC or other computer device. A printed assessment report can also be provided. As discussed above, the assessment report can provide scores in specific measurement categories that, based on processing of timing and accuracy data recorded by the assessment software, measure visual acuity, operational thinking and behavior skills of the participant. The assessment report can provide percentile rankings of the participant with respect to other participants (e.g., peers in the participant's sport, profession or activity). Percentile rankings can be calculated based on the general population assessed, or based participants grouped by sport, profession or educational fields, for example. An exemplary assessment report, including a detailed report section for each exercise, is shown in FIGS. 24-34.

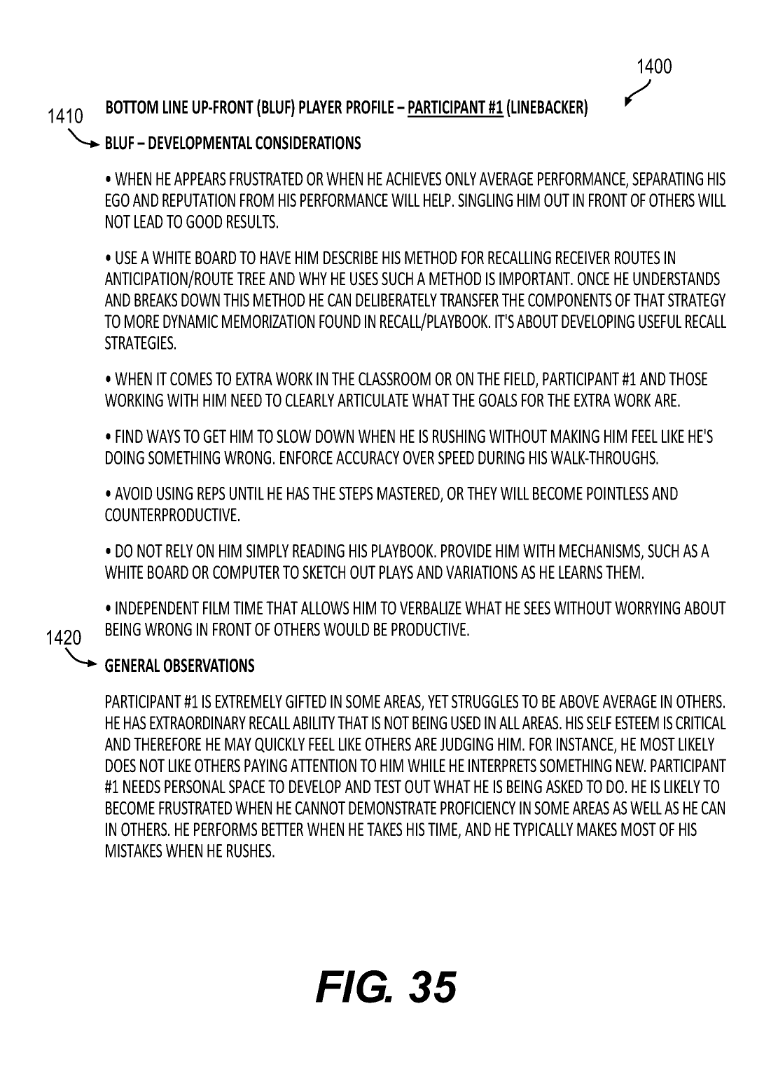

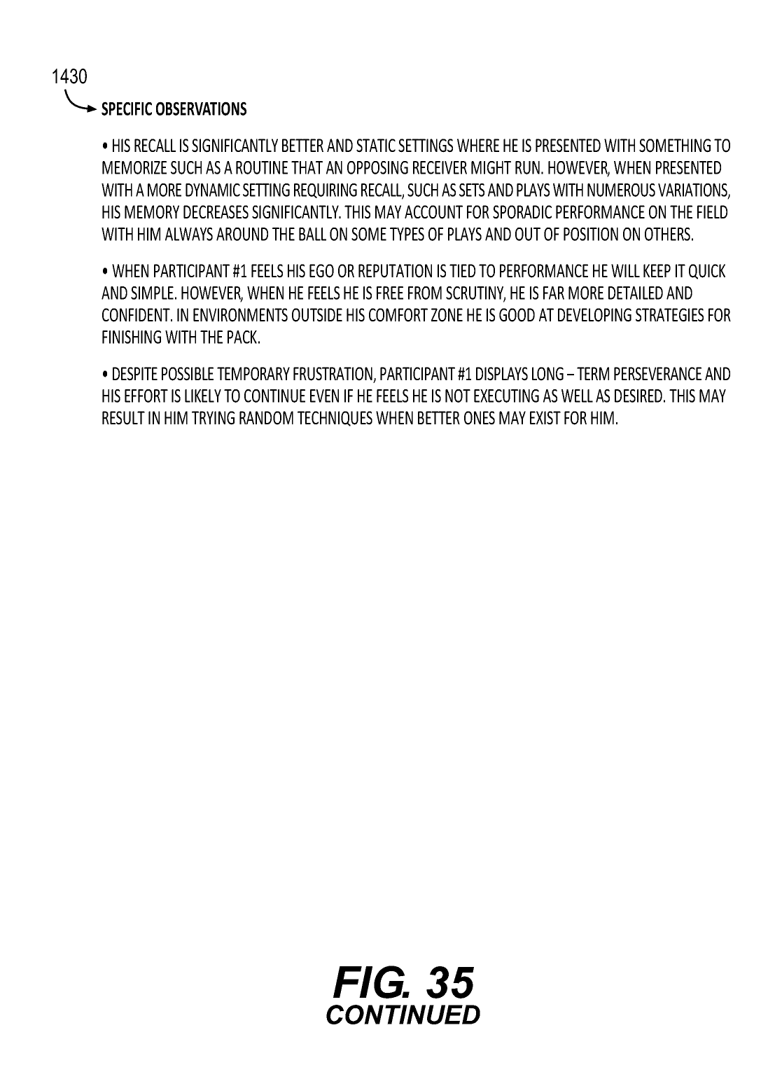

Additionally, exemplary personalized assessment summaries that can be prepared based on assessment reports are shown in FIGS. 35-37. The personalized assessment summaries summarize participants' performance characteristics, identify the participants' areas of strength and weakness, and provide suggestions for facilitating the participants' learning and development.

Assessment Report: Draw a Person Exercise

FIG. 24 shows an exemplary report section 400 for the “draw a person” exercise. The report section 400 includes a statement 410 explaining the objective of the exercise and a measurement chart 420. The measurement chart 420 lists and defines measurement categories for the exercise associated with the participant's collected performance data, and provides participant rankings (in comparison to a population of other participants) and feedback statements related to the measurement categories. The measurement categories in the chart 420 include the following:
1) Strategy time (measures how one formulates a plan of action when using imagination and creativity);
2) Initiation time (measures how one implements strategy when no comparative examples exist);
3) Reevaluation time (measures how one assesses strategy after initial implementation for task relevance);
4) Adjustment time (measures how one implements reevaluation with confidence or haste);
5) Completion time (measures how quickly one completes a creative task);
6) Complexity (measures orientation regarding detail); and
7) Accuracy (measures how accurately one completes a creative task)

The report section 400 also includes graphical representations 430 of the participant rankings, graphs 440 including recorded timing data associated with time-based measurement categories in the chart 420, a graph 450 illustrating the participant's accuracy vs. complexity performance (related to the accuracy and complexity measurement categories in the chart 420) in comparison to the performance of a mean population, and line graphs 460 reflecting the participant's accuracy and complexity measurement rankings in comparison to a mean population.

Assessment Report: Three-Dimensional Structure Exercise

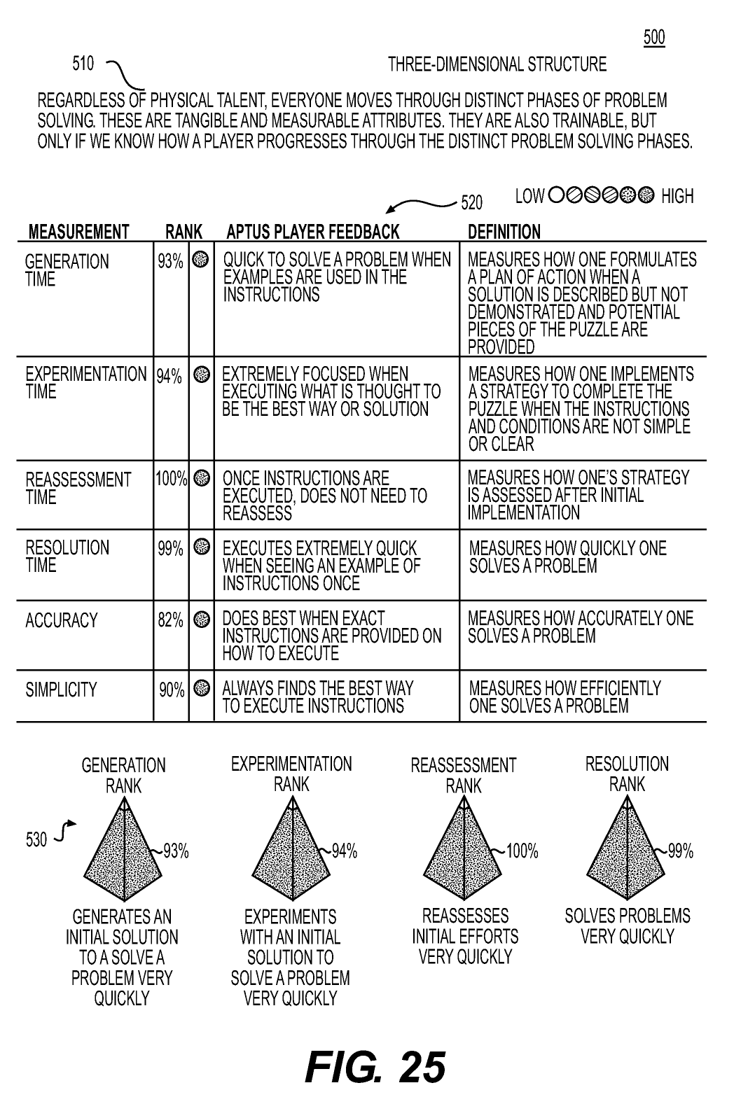

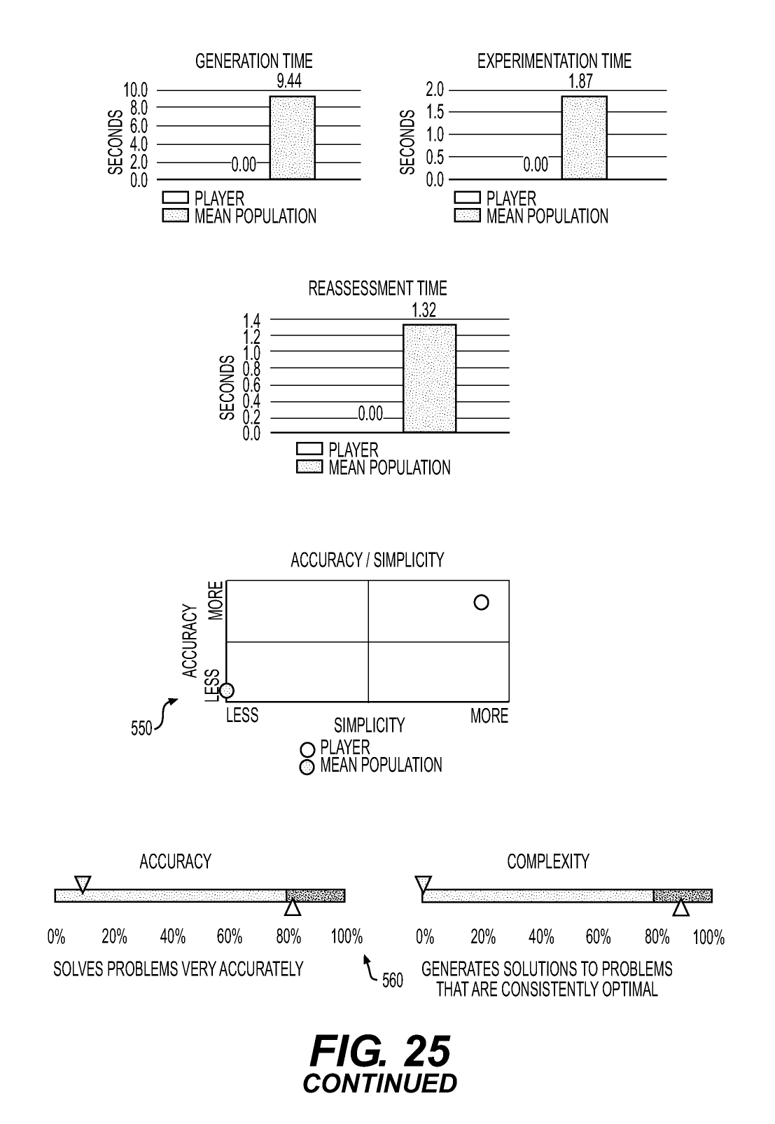

FIG. 25 shows an exemplary report section 500 for the “three-dimensional structure” exercise. The report section 500 includes a statement 510 explaining the objective of the exercise and a measurement chart 520. The measurement chart 520 lists and defines measurement categories for the exercise associated with the participant's collected performance data, and provides participant rankings (in comparison to a population of other participants) and feedback statements related to the measurement categories. The measurement categories in the chart 520 include the following:
1) Generation time (measures how one formulates a plan of action when a solution is described but not demonstrated and potential pieces of a puzzle are provided);
2) Experimentation time (measures how one implements strategy to complete a puzzle when the instructions and conditions are not simple or clear);
3) Reassessment time (measures how one's strategy is assessed after initial implementation);
4) Resolution time (measures how one implements reevaluation with confidence or haste);
5) Accuracy time (measures how quickly one solves a problem); and
6) Simplicity (measures how efficiently one solves a problem);

The report section 500 also includes graphical representations 530 of the participant rankings, graphs 540 including recorded timing data associated with time-based measurement categories in the chart 520, a graph 550 illustrating the participant's accuracy vs. simplicity performance (related to the accuracy and simplicity measurement categories in the chart 520) in comparison to the performance of a mean population, and line graphs 560 reflecting the participant's accuracy and simplicity measurement rankings in comparison to a mean population.

Assessment Report: Route Reconstruction Exercise

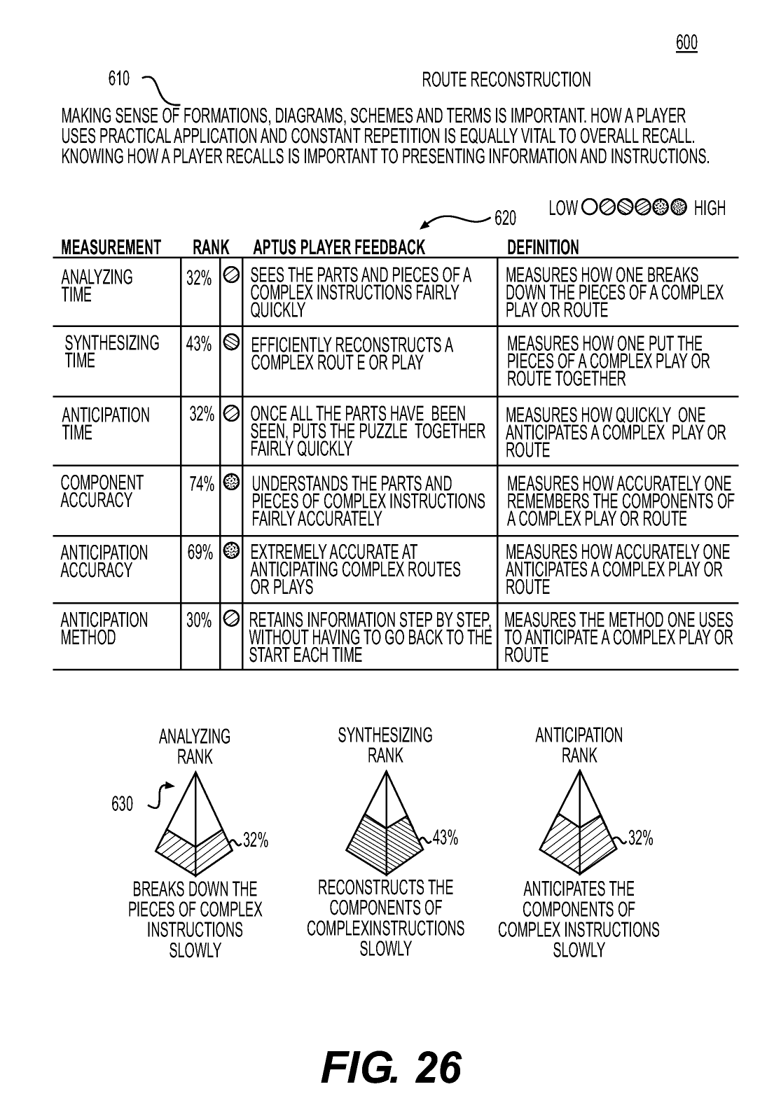

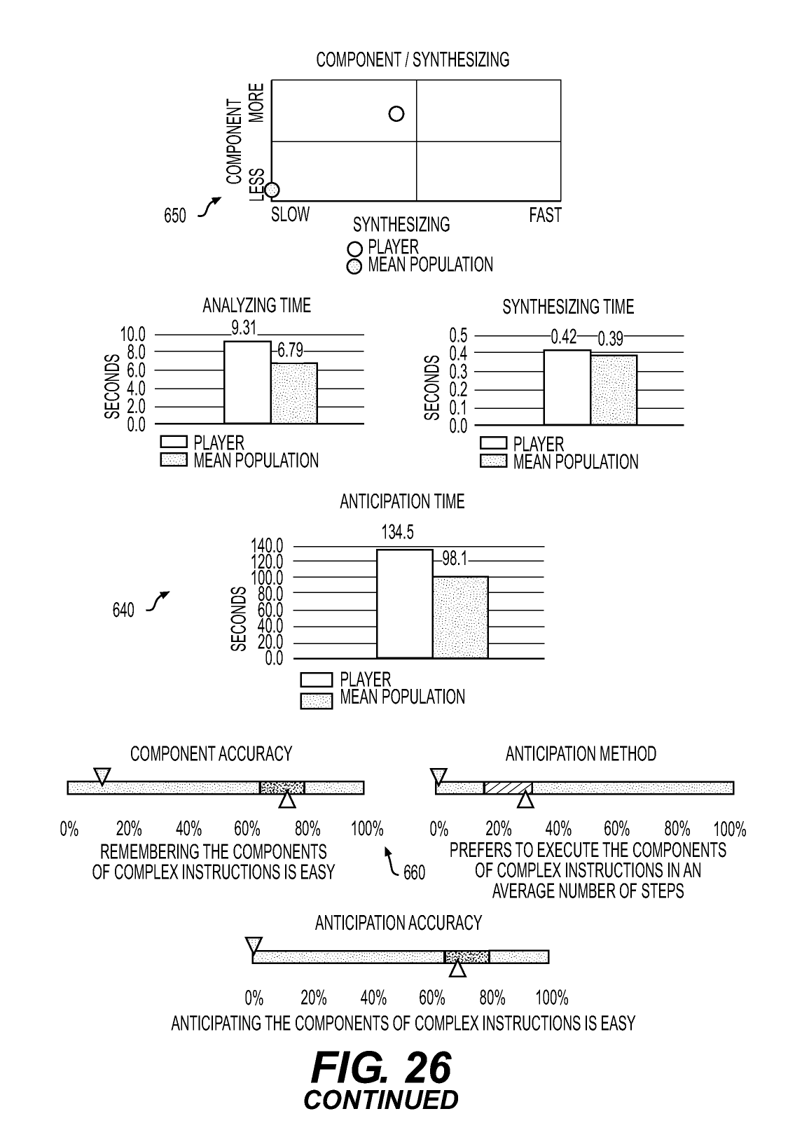

FIG. 26 shows an exemplary report section 600 for the “route reconstruction” exercise. The report section 600 includes a statement 610 explaining the objective of the exercise and a measurement chart 620. The measurement chart 620 lists and defines measurement categories for the exercise associated with the participant's collected performance data, and provides participant rankings (in comparison to a population of other participants) and feedback statements related to the measurement categories. The measurement categories in the chart 620 include the following:
1) Analyzing time (measures how one breaks down the pieces of a complex play or route);
2) Synthesizing time (measures how one put the pieces of a complex play or route together);
3) Anticipation time (measures how one quickly one anticipates a complex play or route);
4) Component accuracy (measures how accurately one remembers the components of a complex play or route);
5) Anticipation accuracy (measures how accurately one anticipates a complex play route); and
6) Anticipation method (measures the method one uses to anticipate a complex play or route);

The report section 600 also includes graphical representations 630 of the participant rankings, graphs 640 including recorded timing data associated with time-based measurement categories in the chart 620, a graph 650 illustrating the participant's component vs. synthesizing performance (related to the component and synthesizing measurement categories in the chart 620) in comparison to the performance of a mean population, and line graphs 660 reflecting the participant's component accuracy, anticipation method and anticipation accuracy and simplicity measurement rankings in comparison to a mean population.

Assessment Report: Spatial Orientation Exercise

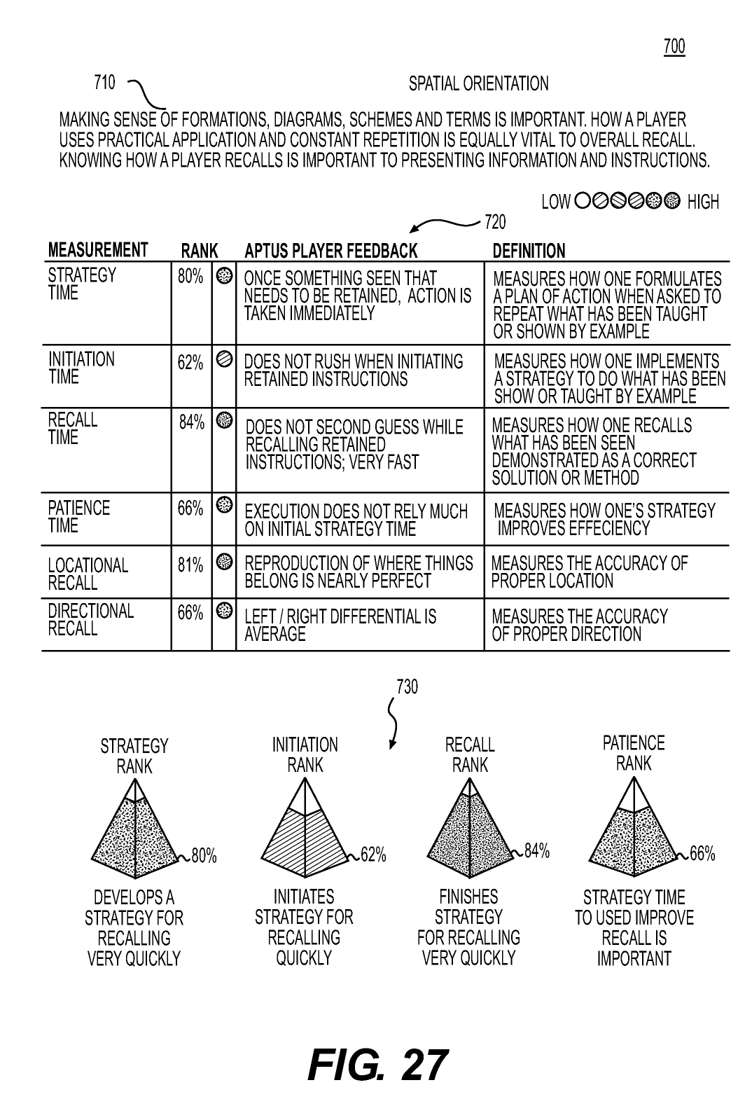

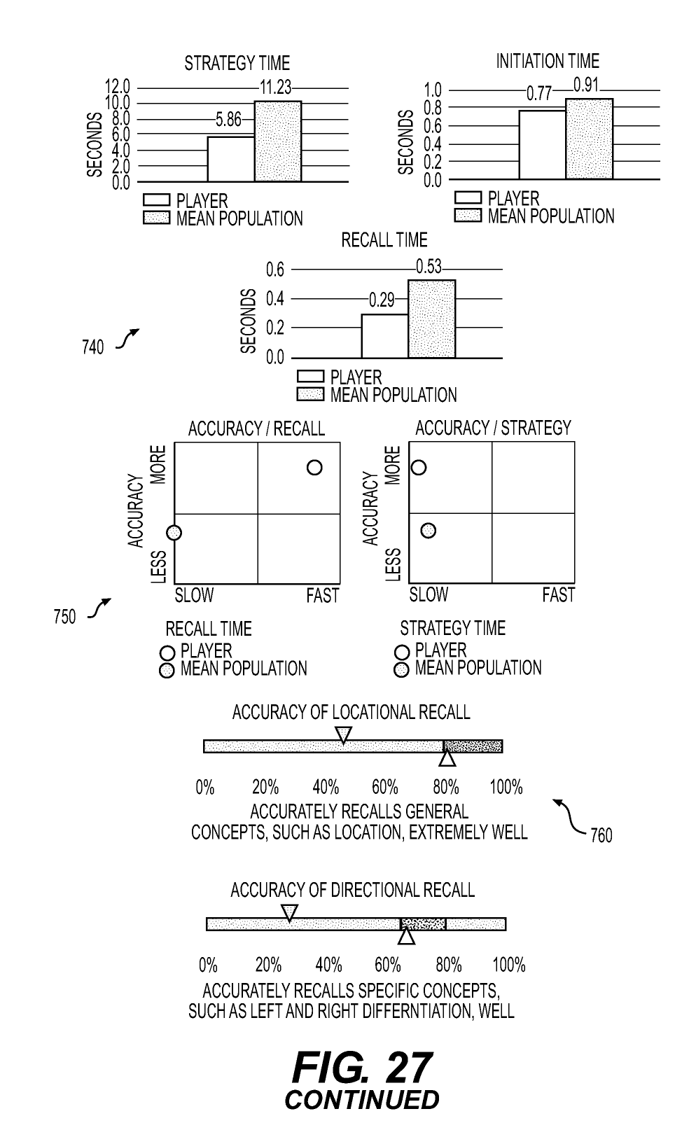

FIG. 27 shows an exemplary report section 600 for the “spatial orientation” exercise. The report section 700 includes a statement 710 explaining the objective of the exercise and a measurement chart 720. The measurement chart 720 lists and defines measurement categories for the exercise associated with the participant's collected performance data, and provides participant rankings (in comparison to a population of other participants) and feedback statements related to the measurement categories. The measurement categories in the chart 720 include the following:
1) Strategy time (measures how one formulates a plan of action when asked to repeat what has been taught or shown by example);
2) Initiation time (measures how one implements a strategy to do what has been shown or taught by example);
3) Recall time (measures how one recalls what has been seen demonstrated as a correct solution or method);
4) Patience time (measures how one's strategy improves efficiency);
5) Locational recall (measures the accuracy of proper location); and
6) Directional recall (measures the accuracy of proper direction);

The report section 700 also includes graphical representations 730 of the participant rankings, graphs 740 including recorded timing data associated with time-based measurement categories in the chart 720, graphs 750 illustrating the participant's accuracy vs. recall time performance and accuracy vs. strategy time performance in comparison to the performance of a mean population, and line graphs 760 reflecting the participant's accuracy of locational recall and accuracy of directional recall rankings in comparison to a mean population.

Assessment Report: Pilot's View of a Structure Exercise

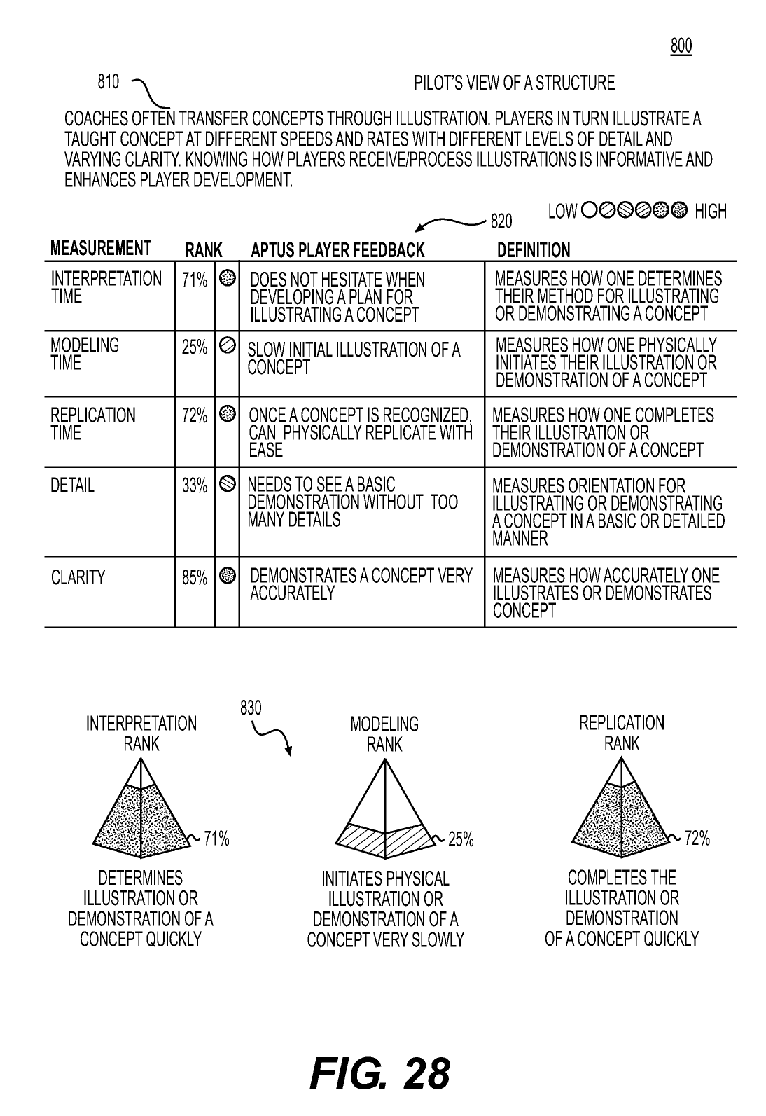

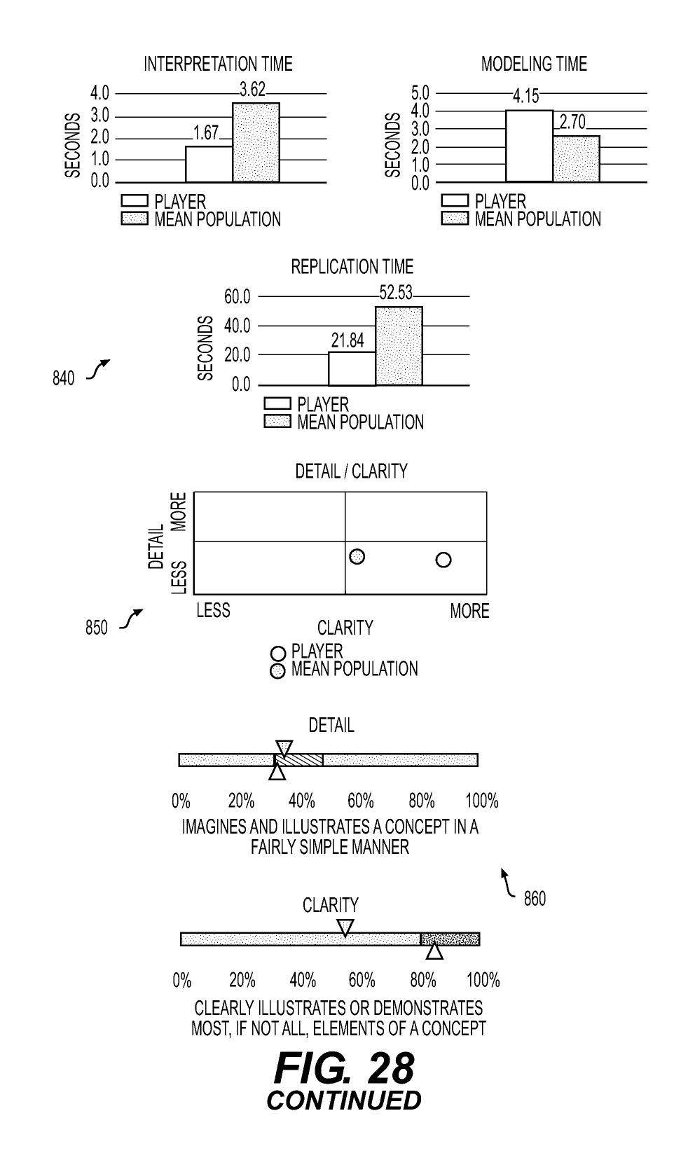

FIG. 28 shows an exemplary report section 800 for the “pilot's view of a structure” exercise. The report section 800 includes a statement 810 explaining the objective of the exercise and a measurement chart 820. The measurement chart 820 lists and defines measurement categories for the exercise associated with the participant's collected performance data, and provides participant rankings (in comparison to a population of other participants) and feedback statements related to the measurement categories. The measurement categories in the chart 820 include the following:
1) Interpretation time (measures how one determines their method for illustrating or demonstrating a concept);
2) Modeling time (measures how one physically initiates their illustration or demonstration of a concept);
3) Replication time (measures how one completes their illustration or demonstration of a concept);
4) Detail time (measures orientation for illustrating or demonstrating a concept in a basic or detailed manner); and
5) Clarity (measures how accurately one illustrates or demonstrates a concept)

The report section 800 also includes graphical representations 830 of the participant rankings, graphs 840 including recorded timing data associated with time-based measurement categories in the chart 820, a graph 850 illustrating the participant's detail vs. clarity performance in comparison to the performance of a mean population, and line graphs 860 reflecting the participant's detail and clarity rankings in comparison to a mean population.

Assessment Report: Crossword Puzzle Exercise

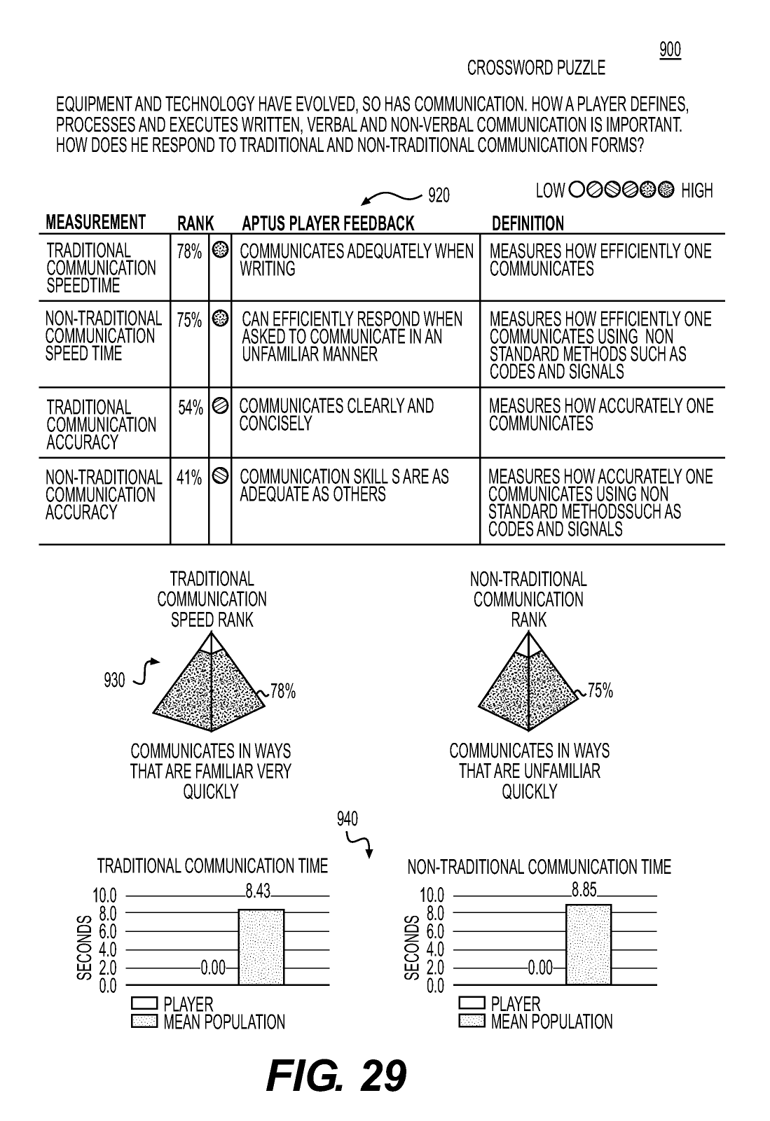

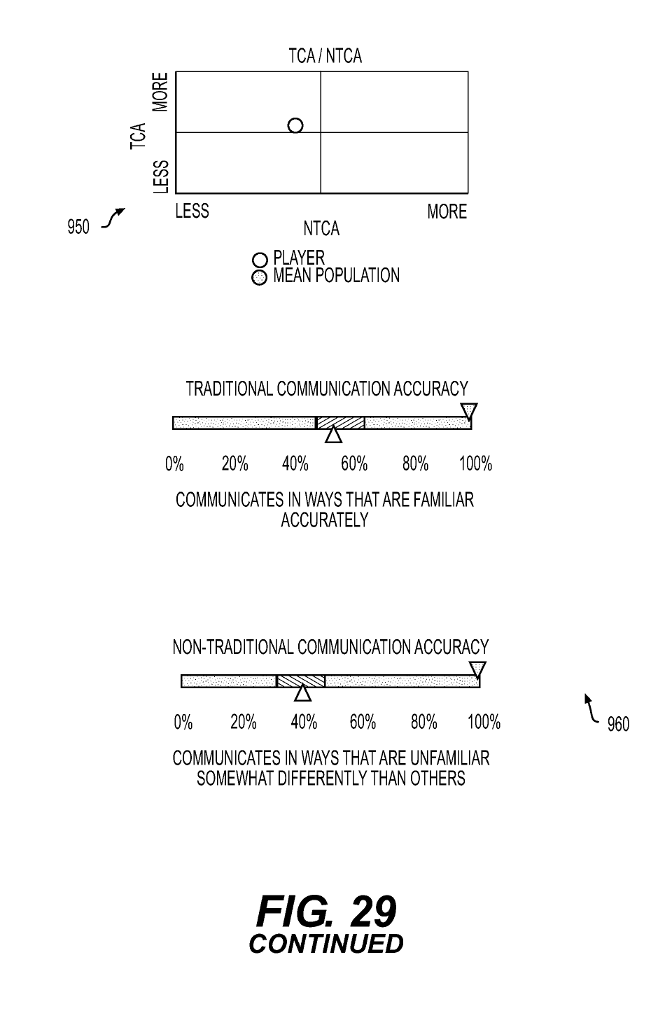

FIG. 29 shows an exemplary report section 900 for the “crossword puzzle” exercise. The report section 900 includes a statement 910 explaining the objective of the exercise and a measurement chart 920. The measurement chart 920 lists and defines measurement categories for the exercise associated with the participant's collected performance data, and provides participant rankings (in comparison to a population of other participants) and feedback statements related to the measurement categories. The measurement categories in the chart 920 include the following:
1) Traditional communication speed time (measures how efficiently one communicates);
2) Non-traditional communication speed (measures how efficiently one communicates using non-standard methods such as codes and signals);
3) Traditional communication accuracy (measures how accurately one communicates); and
4) Non-traditional communication accuracy (measures how accurately one communicates using non-standard methods such as codes and signals)

The report section 900 also includes graphical representations 930 of the participant rankings, graphs 940 including recorded timing data associated with time-based measurement categories in the chart 920, a graph 950 illustrating the participant's traditional communication accuracy vs. non-traditional communication accuracy performance in comparison to the performance of a mean population, and line graphs 960 reflecting the participant's traditional communication accuracy and non-traditional communication accuracy performance rankings in comparison to a mean population.

Assessment Report: Letter or Symbol Placement Exercise

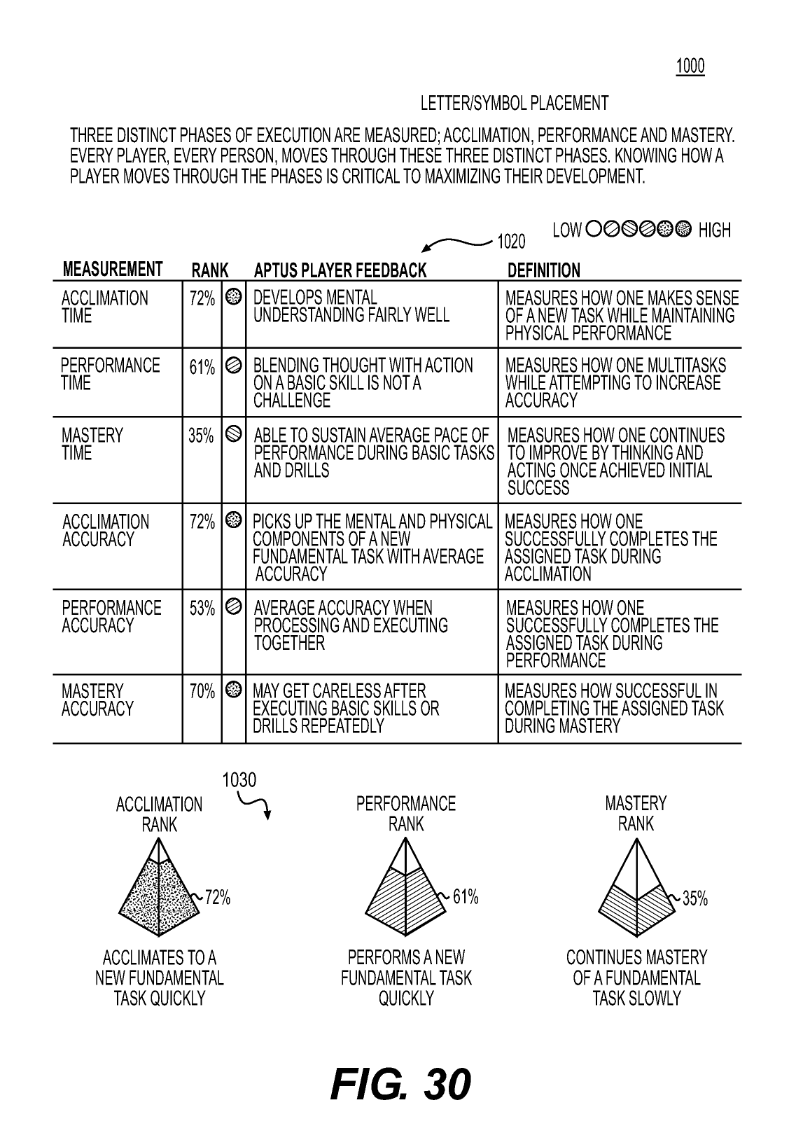

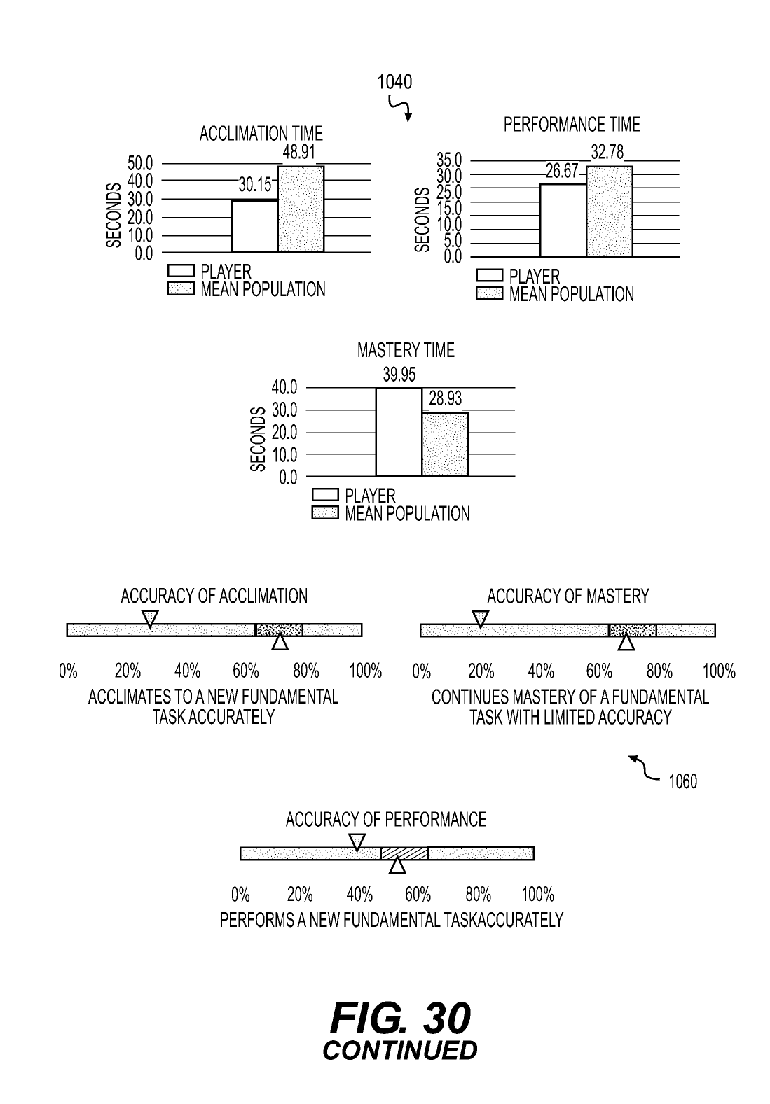

FIG. 30 shows an exemplary report section 1000 for the “letter or symbol placement” exercise. The report section 1000 includes a statement 1010 explaining the objective of the exercise and a measurement chart 1020. The measurement chart 1020 lists and defines measurement categories for the exercise associated with the participant's collected performance data, and provides participant rankings (in comparison to a population of other participants) and feedback statements related to the measurement categories. The measurement categories in the chart 1020 include the following:
1) Acclimation time (measures how one makes sense of a new task while maintaining physical performance);
2) Performance time (measures how one multi-tasks while attempting to increase accuracy);
3) Mastery time (measures how one continues to improve thinking and acting once achieved initial success);
4) Acclimation accuracy (measures how one successfully completes the assigned task during acclimation);
5) Performance accuracy (measures how one successfully completes the assigned task during performance); and
6) Mastery accuracy (measures how successful in completing the assigned task during mastery)

The report section 1000 also includes graphical representations 1030 of the participant rankings, graphs 1040 including recorded timing data associated with time-based measurement categories in the chart 1020, and line graphs 1060 reflecting the participant's accuracy of acclimation, accuracy of mastery and accuracy of performance.

Assessment Report: Letter or Symbol Pattern Maze Exercise

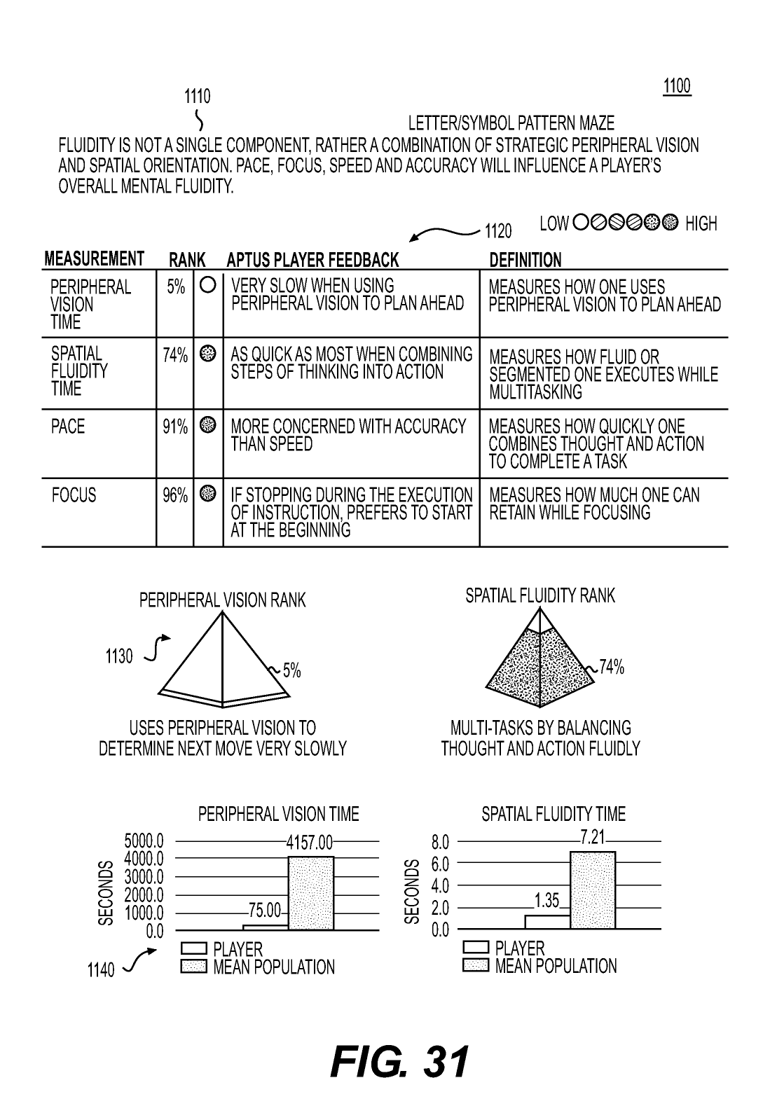

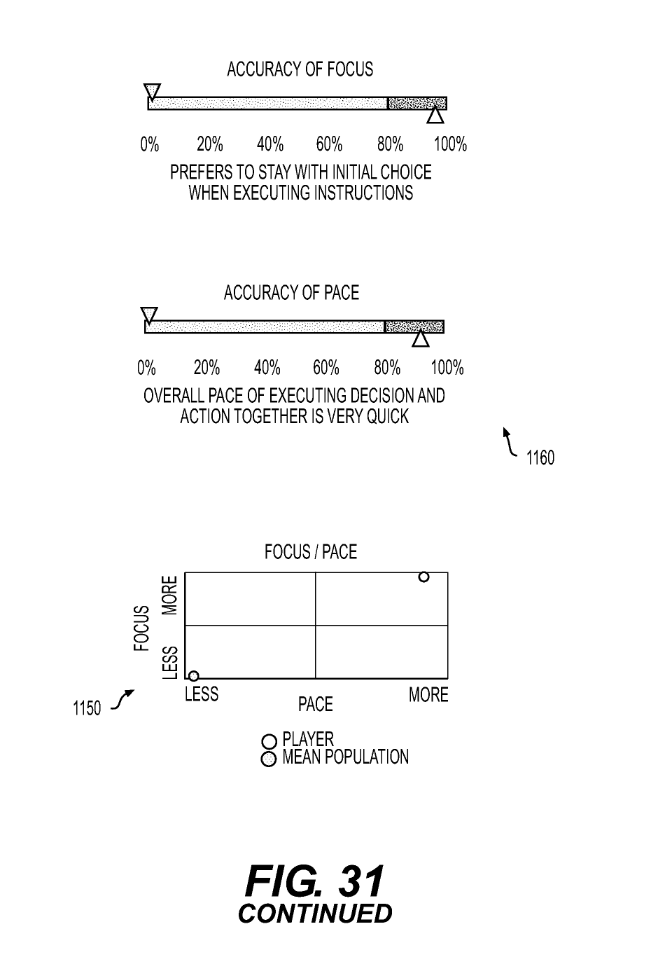

FIG. 31 shows an exemplary report section 1100 for the “letter or symbol pattern maze” exercise. The report section 1100 includes a statement 1110 explaining the objective of the exercise and a measurement chart 1120. The measurement chart 1120 lists and defines measurement categories for the exercise associated with the participant's collected performance data, and provides participant rankings (in comparison to a population of other participants) and feedback statements related to the measurement categories. The measurement categories in the chart 1120 include the following:
1) Peripheral vision time (measures how one uses peripheral vision to plan ahead);
2) Spatial fluidity time (measures how fluid or segmented one executes while multi-tasking);
3) Pace (measures how quickly one combines thought and action to complete a task); and
4) Focus (measures how much one can retain while focusing)

The report section 1100 also includes graphical representations 1130 of the participant rankings, graphs 1140 including recorded timing data associated with time-based measurement categories in the chart 1120, a graph 1150 showing the participant's focus vs. pace performance in comparison to the performance of a mean population, and line graphs 1160 reflecting the participant's accuracy of focus and accuracy of pace in comparison to a mean population.

Assessment Report: Finger Reaction and Placement Exercise

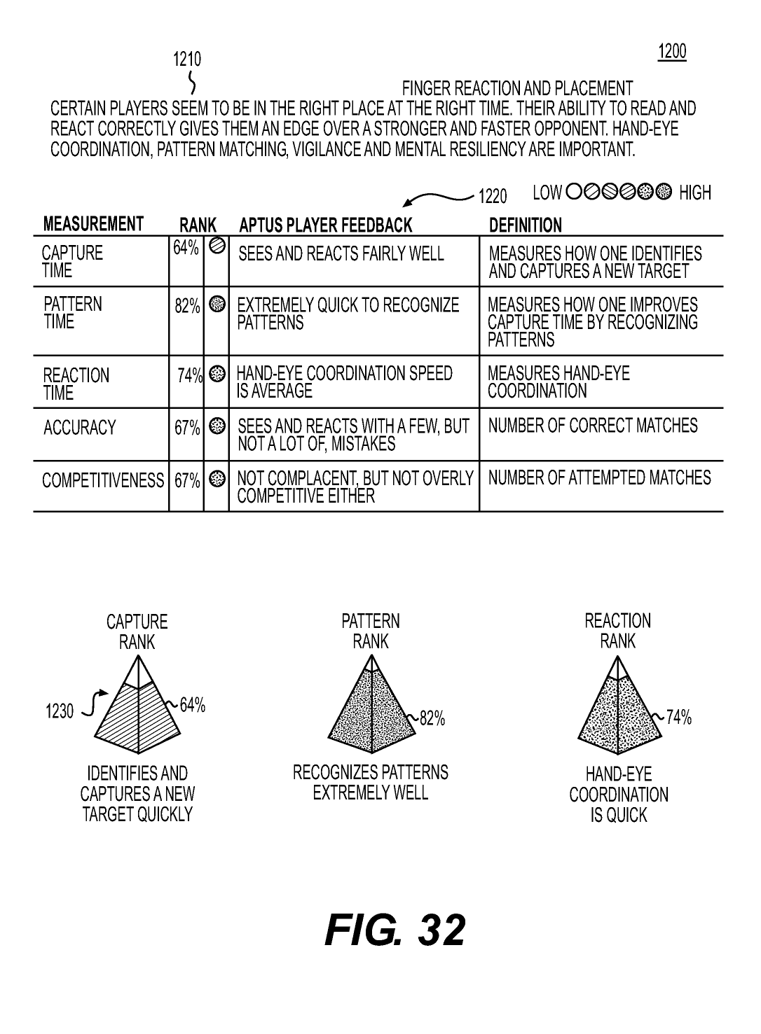

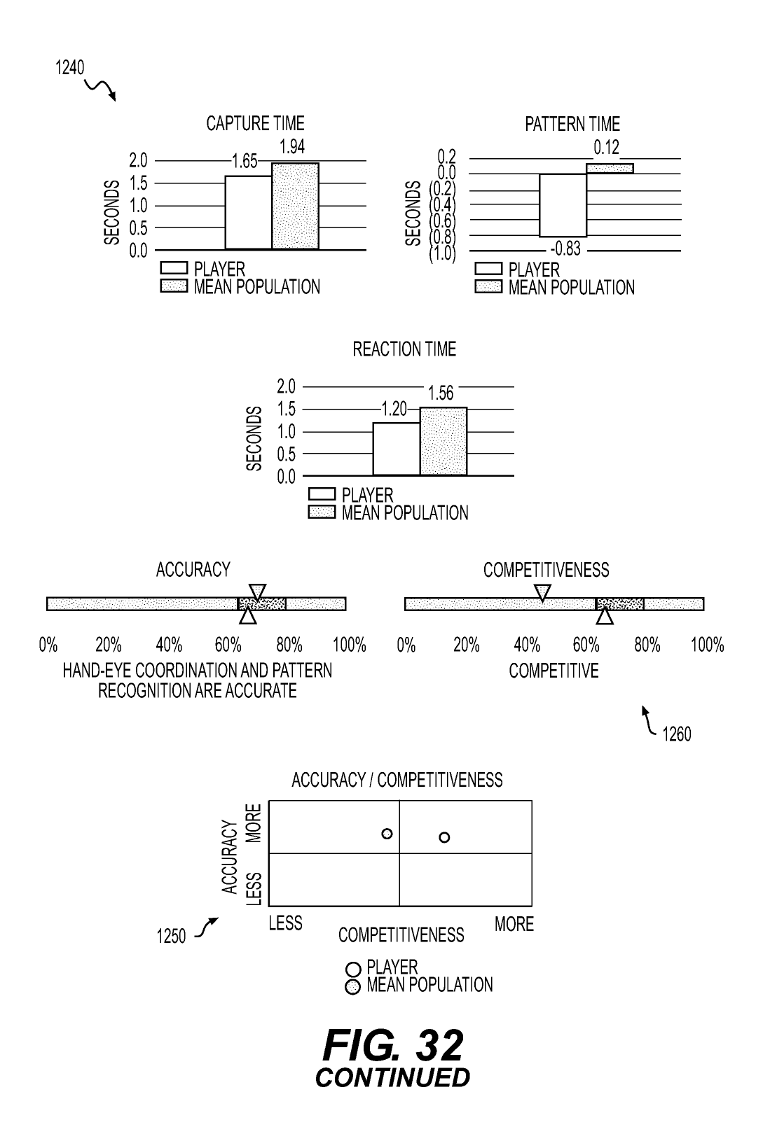

FIG. 32 shows an exemplary report section 1200 for the “finger reaction and placement” exercise. The report section 1200 includes a statement 1210 explaining the objective of the exercise and a measurement chart 1220. The measurement chart 1220 lists and defines measurement categories for the exercise associated with the participant's collected performance data, and provides participant rankings (in comparison to a population of other participants) and feedback statements related to the measurement categories. The measurement categories in the chart 1220 include the following:
1) Capture time (measures how one identifies and captures a new target);
2) Pattern time (measures how one improves capture time by recognizing patterns);
3) Reaction time (measures hand-eye coordination);
4) Accuracy (measures number of correct matches); and
5) Competitiveness (measures number of attempted matches)

The report section 1200 also includes graphical representations 1230 of the participant rankings, graphs 1240 including recorded timing data associated with time-based measurement categories in the chart 1220, a graph 1250 showing the participant's accuracy vs. competitiveness performance in comparison to the performance of a mean population, and line graphs 1260 reflecting the participant's accuracy and competitiveness performance in comparison to a mean population.

Assessment Report: Icon Interception Exercise

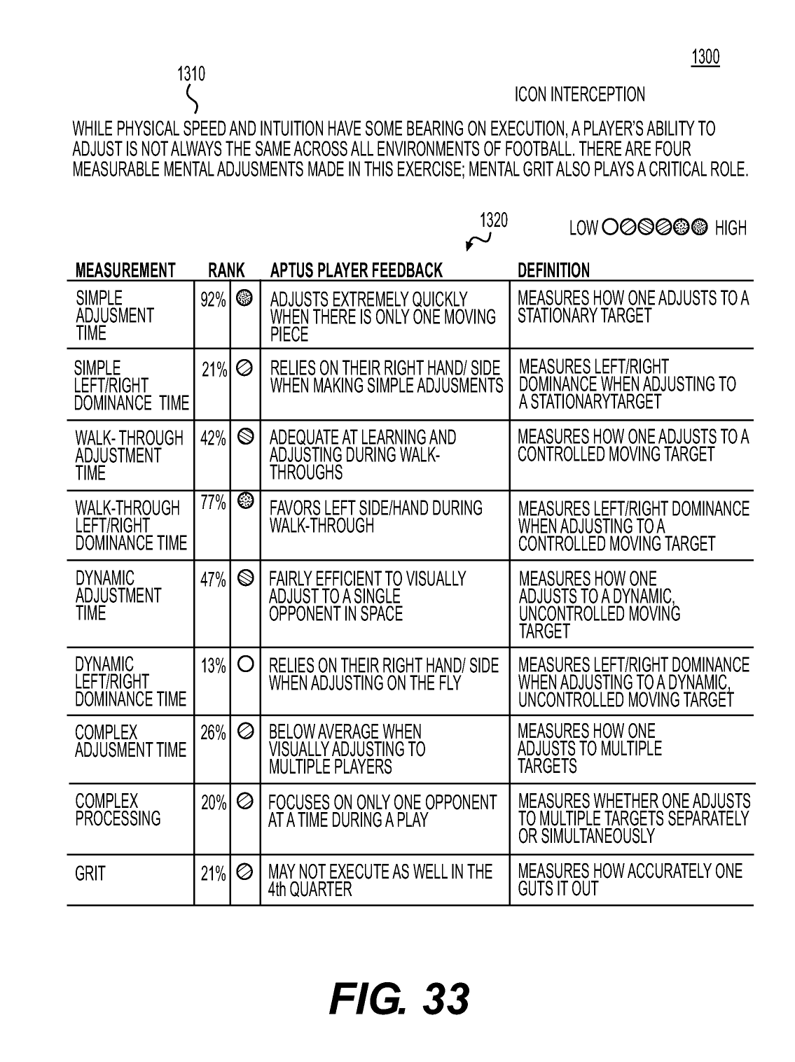

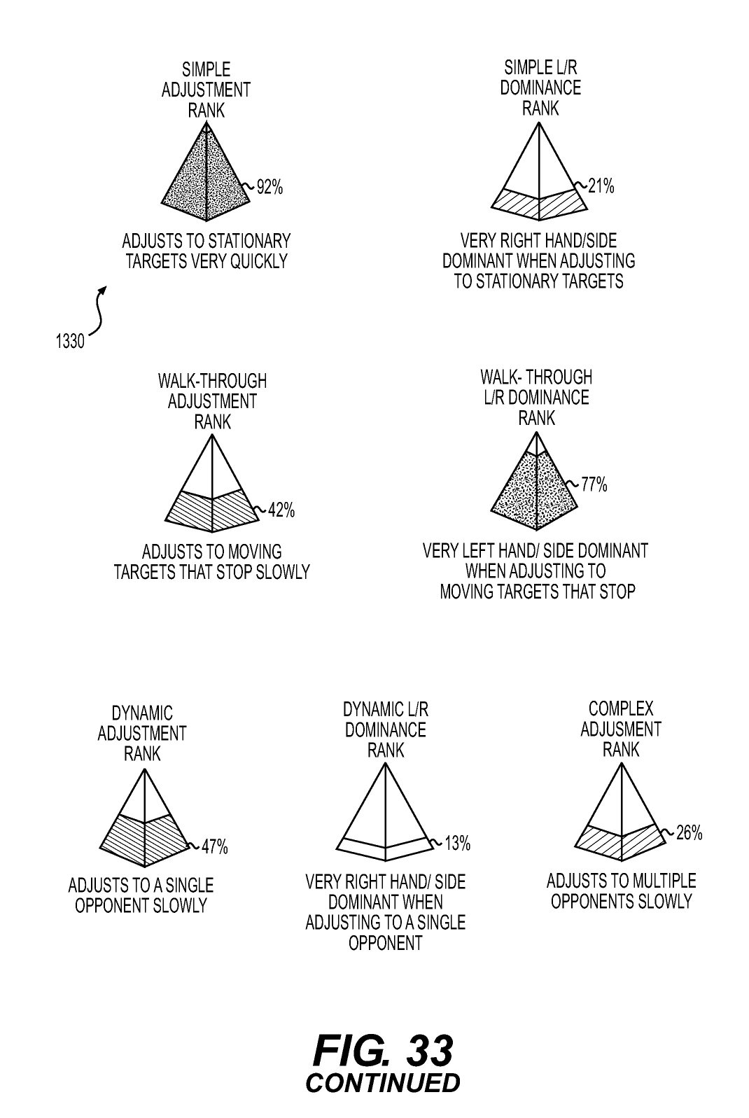

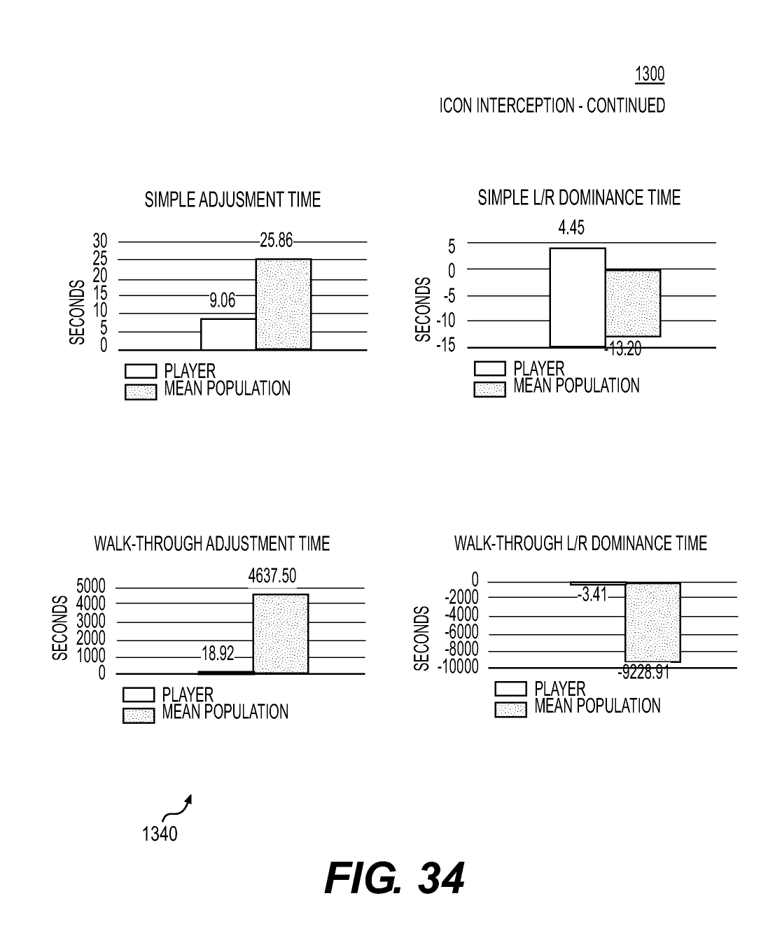

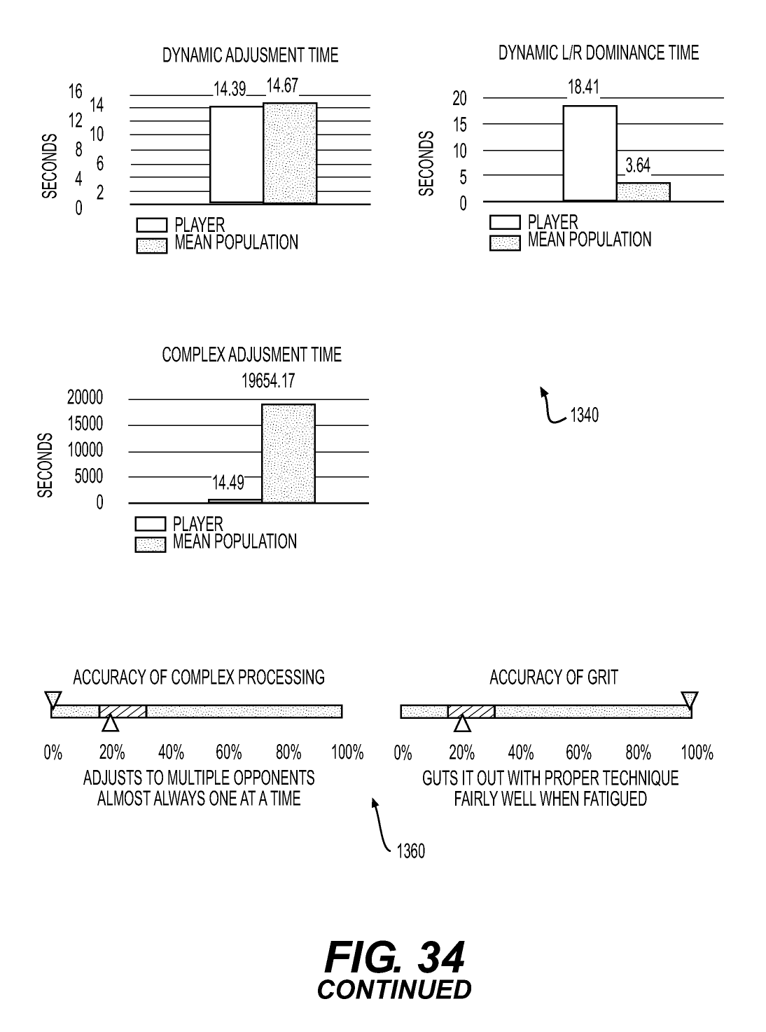

FIGS. 33 and 34 show an exemplary report section 1200 for the “icon interception” exercise. The report section 1300 includes a statement 1310 explaining the objective of the exercise and a measurement chart 1320. The measurement chart 1320 lists and defines measurement categories for the exercise associated with the participant's collected performance data, and provides participant rankings (in comparison to a population of other participants) and feedback statements related to the measurement categories. The measurement categories in the chart 1320 include the following:
1) Simple adjustment time (measures how one adjusts to a stationary target);
2) Simple left/right dominance time (measures left/right dominance when adjusting to a stationary target);
3) Walk-through adjustment time (measures how one adjusts to a controlled-moving target);
4) Walk-through left/right dominance time (measures left/right dominance when adjusting to a controlled moving target);
5) Dynamic adjustment time (measures how one adjusts to a dynamic, uncontrolled moving target)
6) Complex adjustment time (measures how one adjusts to multiple targets);
7) Complex processing (measures whether one adjusts to multiple targets separately or simultaneously); and
8) Grit (measures how accurately one guts it out)

The report section 1300 also includes graphical representations 1330 of the participant rankings, graphs 1340 (FIG. 34) including recorded timing data associated with time-based measurement categories in the chart 1220, and line graphs 1360 (FIG. 34) reflecting the participant's accuracy of completion performance and accuracy of grit performance in comparison to a mean population.

Personalized Assessment Summaries

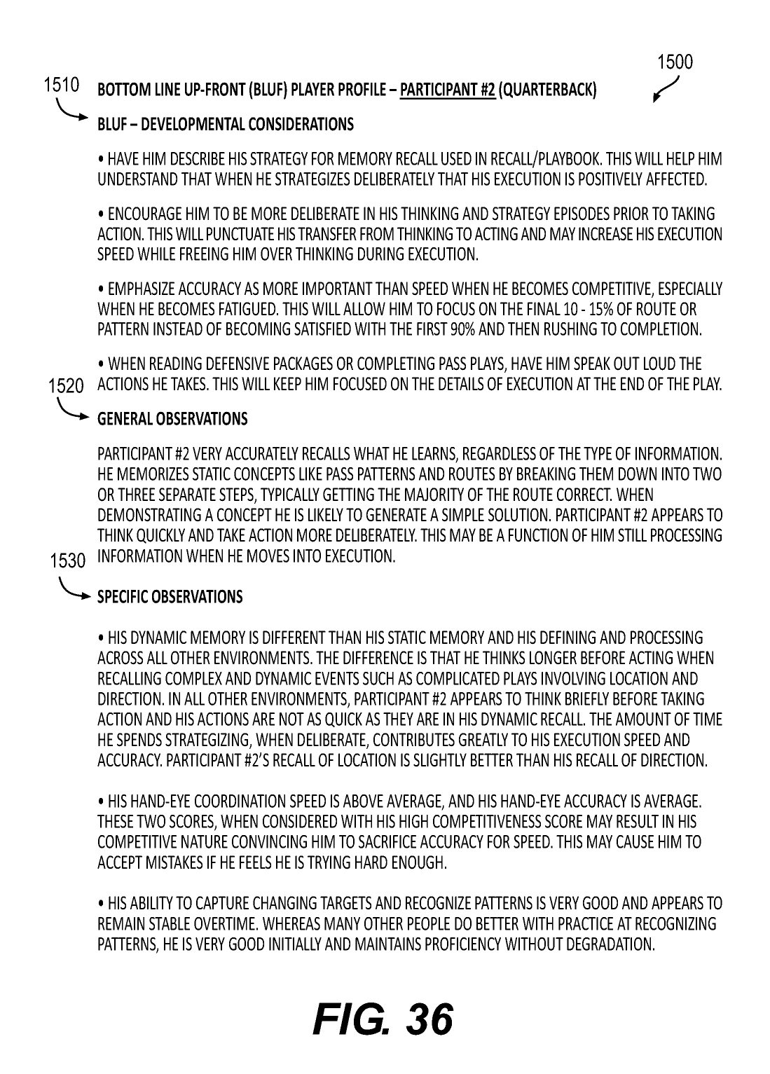

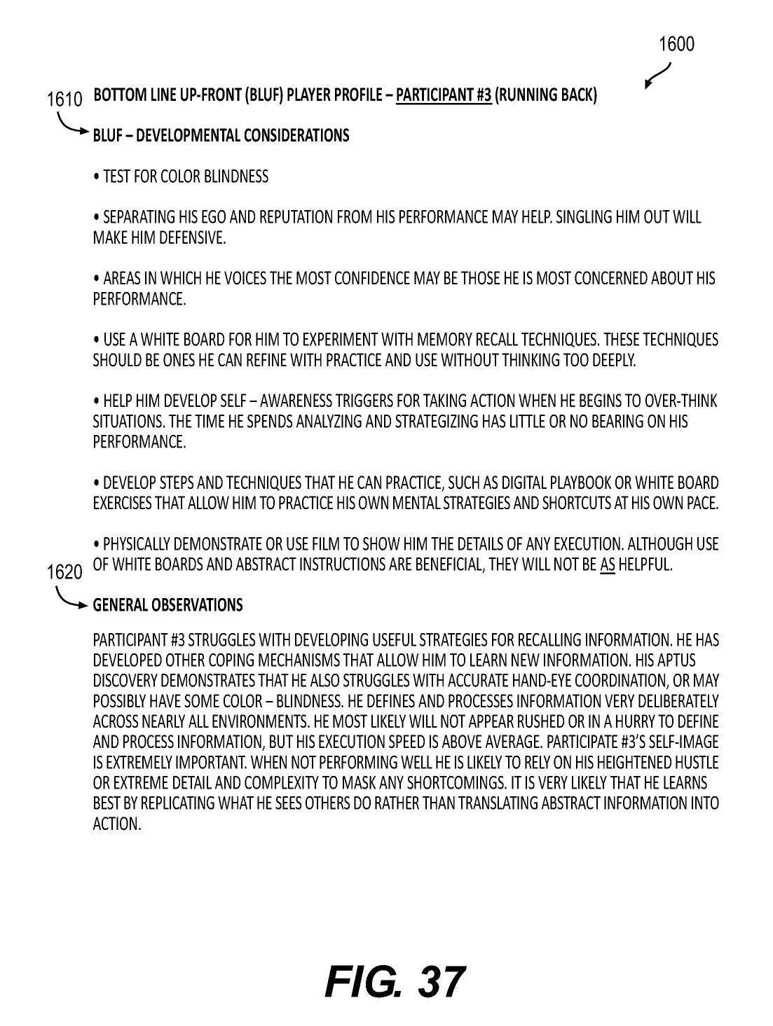

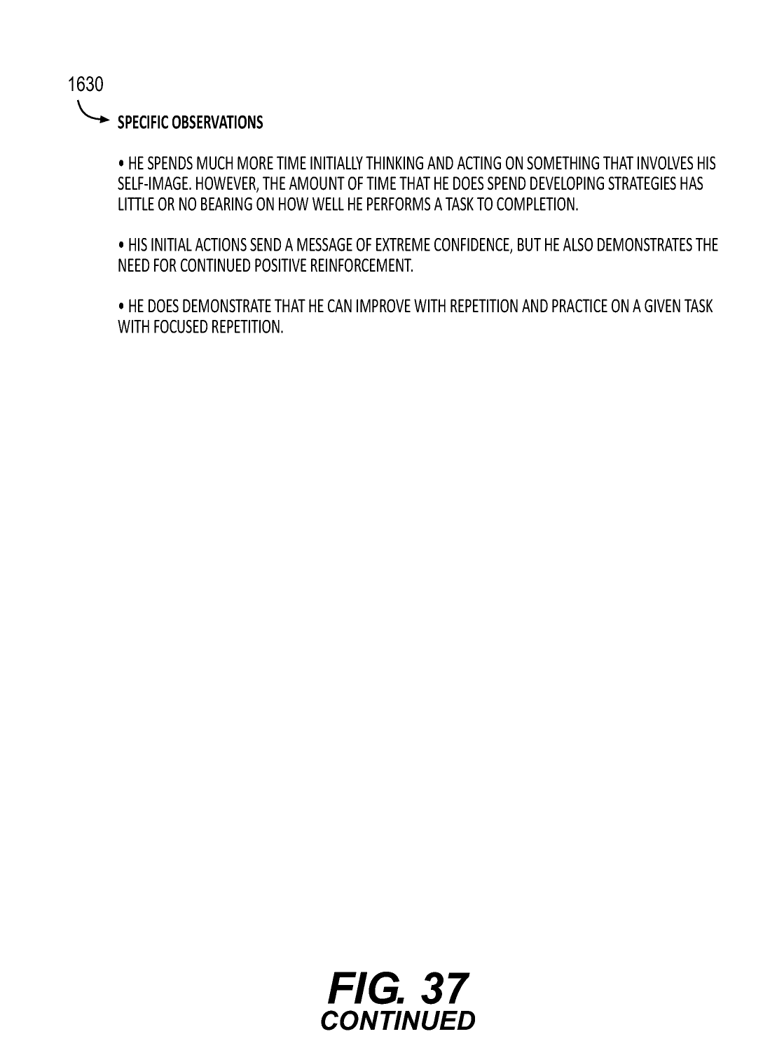

FIGS. 35-37 show personalized assessment summaries 1400 (FIG. 35), 1500 (FIG. 36) and 1600 (FIG. 37) that can be created based on the information generated in an assessment report. As shown in FIGS. 35-37, the assessment summaries 1400, 1500, 1600 each include a developmental considerations section 1410, 1510, 1610 which includes a discussion of how to assist the participant develop his skills, a general observations section 1420, 1520, 1620 including general comments about the participant's skills and characteristics, and a specific analysis section 1430, 1530, 1630 including more specific comments regarding the participant's skills and characteristics

Once an assessment of a participant is completed, one can understand how the participant is best able to learn, as well as the participant's strengths and weakness related to observing and processing information and performing based on processed information. Data and reports associated with an assessment can be securely stored in a computer database. Optionally, assessments can be encrypted, and all pertinent information can be treated confidentially and provided only to those who are authorized in writing.

According to a further embodiment, based on findings (or, “discoveries”) in an assessment, a measurable, interactive developmental improvement application or tool can be provided in order to further develop the assessed person's skills. Accordingly, specific developmental games and/or exercises can be provided to the participant following the assessment in order to address the participant's weaknesses and further develop his skills.

Although much of the disclosure includes specific embodiments discussed in the context of football or athletic performance, it can be appreciated that the inventions are also applicable to other activities, including, but not limited to, job performance and educational performance. Furthermore, although the exemplary exercises disclosed herein are described as having a certain number of parts or sets, it should be understood that variations of the exercises having a lesser number or greater number parts or sets are envisioned. Although exemplary time limits are provided for the exercises disclosed herein, it should be understood that other time limits, or no time limits, can be employed in alternate embodiments. Still further, while particular types of icons, symbols and letters are discussed in the exemplary exercises herein, it is possible for the exercises to employ different icons, symbols and letters. Additionally, while specific types of input devices and user interfaces are referenced throughout the specification, it should be understood that other suitable input devices can be used to perform the disclosed exercises.

It should be understood that changes and variations can be made to the assessment methods, systems and exercises disclosed herein without departing from the spirit and scope of the inventions as set forth in the appended claims.

We claim:

1. A method of assessing mental acuity and character, comprising:
using a computer system, executing user interactive exercises involving the use of visual acuity skills, operational thinking skills and behavioral skills of a user;
during execution of each user interactive exercise, receiving user inputs including body movement of the user and touch interaction between the user and a user interface in communication with the computer system;
using the computer system, measuring and recording performance data related to timing and accuracy of the user inputs in each user interactive exercise; and
processing the performance data to generate scores in assessment categories that provide measurements of the visual acuity skills, operational thinking skills and behavioral skills of the user.

2. The method of claim 1, further comprising:
generating a report including suggestions for developing the visual acuity skills, operational thinking skills and behavioral skills of the user, and observations related to the visual acuity skills, operational thinking skills and behavioral characteristics of the user.

3. The method of claim 1, wherein the user interface comprises a touch screen.

4. The method of claim 1, wherein the user interface comprises a touch screen, and wherein the user interactive exercises include a reaction and placement exercise in which the user:
is directed to place a left finger or left stylus on a left finger starting icon displayed on the touch screen and places a right finger or right stylus on a right finger starting icon displayed on the touch screen;
is directed to view a set of additional icons generated by the reaction and placement exercise, wherein the set of additional icons includes one or more matching icons that match the left finger starting icon and/or the right finger starting icon; and
is directed to attempt to touch the one or more matching icons with at least one of the left finger or left stylus and the right finger or right stylus in response to the one or more matching icons appearing on the touch screen.

5. The method of claim 4, wherein the performance data comprises data measured and recorded during execution of the reaction and placement exercise, and wherein the data measured and recorded during execution of the reaction and placement exercise includes: a length of time the user takes to receive instructions; a length of time the user takes to successfully touch each of the one or more matching icons; an overall length of time the user takes to successfully match all of the one or more matching icons; a number of attempts the user takes to match each of the one or more matching icons; an accuracy of each attempt made by the user to match each of the one or more matching icons; and a total accuracy of attempts made by the user to match the one or more matching icons.

6. The method of claim 1, wherein the user interactive exercises include a drawing exercise in which the user is directed to imagine himself as a person involved with a particular activity and directed to interact with the user interface to draw:
a physical form of the person on a screen; and
clothing or equipment on the physical form that would be worn for the particular activity.

7. The method of claim 1, wherein the user interactive exercises include a drawing exercise in which the user is directed to view a display showing parts of a structure, imagine the user is standing facing the front of a structure and is further directed to use the user interface to attempt to move the parts to build the structure to have dimensional ratios specified by the drawing exercise.

8. The method of claim 1, wherein the user interactive exercises include a route recreation exercise in which the user:
is directed to view an image generated by the route recreation exercise including separate boxes, each of the boxes containing indicators arranged in multiple rows;
is directed to view a pattern located in a middle box of the separate boxes for a first time, wherein the pattern is composed of line segments connecting several of the indicators;
is directed to imagine the middle box with the pattern flipped over in at least one direction and interacts with the user interface to attempt to draw the pattern as if the pattern were flipped over in the at least one direction.

9. The method of claim 1, wherein the user interactive exercises include a spatial orientation exercise in which the user:
a) is directed to view a screen image including a first icon marked with a symbol or letter, a second icon, a third icon and an object indicating a viewing position within the image;
b) is directed to interact with the user interface to attempt to arrange the first icon so that the symbol or letter on the first icon is oriented in a particular way specified by the spatial orientation exercise,
c) is directed to interact with the user interface to attempt to arrange the second icon and the third icon as specified by the spatial orientation exercise;
d) is directed to imagine the user being located in a position where the object is and looking at the first, second and third icons as the first, second and third icons are arranged after step c); and
e) is directed to interact with the user interface to attempt to arrange the first, second and third icons as if the user were located in the position of the object and looking at the first, second and third icons.

10. The method of claim 1, wherein the user interactive exercises include an overhead view exercise in which the user is directed to imagine himself flying over a structure related to a sport, profession or activity, and is further directed to interact with the user interface to draw an overhead view of the structure.

11. The method of claim 1, wherein the user interactive exercises include a crossword puzzle exercise in which the user is directed to interact with the user interface to attempt to fill out a crossword puzzle.

12. The method of claim 1, wherein the user interactive exercises include a symbol placement exercise in which the user:
is directed to view a grid of first symbols and second symbols arranged in several rows and several columns, wherein the first and second symbols are randomly colored and randomly placed within the rows and columns;
in response to instructions to move designated symbols among the first symbols and second symbols to designated positions in the grid, is directed to interact with the user interface to attempt to move the designated symbols to the designated positions;
receives instructions from the symbol placement exercise to view a target pattern outlined by the designated symbols being correctly moved to the designated positions; and
is directed to compare the target pattern to a pattern generated by moves of the first symbols or second symbols actually executed by the user.

13. The method of claim 1, wherein the user interface comprises a touch screen, and wherein the user interactive exercises include a maze exercise in which the user is directed to interact with the touch screen using a finger of the user or a stylus to attempt to move an icon throughout a maze of symbols, from a beginning of the maze to an end of the maze, without disrupting contact between the finger or stylus and the touch screen.

14. A programmable computer memory comprising stored instructions executable to:
conduct user interactive exercises involving the use of visual acuity skills, operational thinking skills and behavioral skills of a user;
while each user interactive exercise is conducted, process user inputs including body movement of the user and touch interaction between the user and a user interface in communication with a computer system;
for each user interactive exercise, measure and record performance data related to the timing and accuracy of the user inputs; and
process the performance data to generate scores in assessment categories that provide measurements of the visual acuity skills, operational thinking skills and behavioral skills of the user.

15. The computer memory of claim 14, wherein the performance data comprises information for:
making suggestions for developing visual acuity skills, operational thinking skills and behavioral skills of the user; and
making observations related to the visual acuity skills, operational thinking skills and behavioral characteristics of the user.

16. The computer memory of claim 14, wherein the user interface comprises a touch screen, and wherein the user interactive exercises further comprise stored instructions executable to conduct a reaction and placement exercise that is operable to:
instruct the user to place a left finger or left stylus on a left finger starting icon displayed on the touch screen and place a right finger or right stylus on a right finger starting icon displayed on the touch screen;
display a set of additional icons generated by the reaction and placement exercise, wherein the set of additional icons includes one or more matching icons that match the left finger starting icon and/or the right finger starting icon;
instruct the user to touch the one or more matching icons with at least one of the left finger or left stylus and the right finger or right stylus in response to the one or more matching icons appearing on the touch screen; and
receive user inputs from the user attempting to touch the one or more matching icons with at least one of the left finger or left stylus and the right finger or right stylus.

17. The computer memory of claim 16, wherein the performance data comprises data measured and recorded during execution of the reaction and placement exercise, and wherein the data measured and recorded during execution of the reaction and placement exercise includes: a length of time the user takes to receive instructions; a length of time the user takes to successfully touch each of the one or more matching icons; an overall length of time the user takes to successfully match all of the one or more matching icons; a number of attempts the user takes to match each of the one or more matching icons; an accuracy of each attempt made by the user to match each of the one or more matching icons; and a total accuracy of attempts made by the user to match the one or more matching icons.

18. The computer memory of claim 14, wherein the user interactive exercises include a drawing exercise in which the user is directed to imagine himself as a person involved with a particular activity and directed to interact with the user interface to draw:
a physical form of the person on a screen; and
clothing or equipment on the physical form that would be worn for the particular activity.

19. The computer memory of claim 14, wherein the user interactive exercises include a drawing exercise in which the user is directed to view a display showing parts of a structure, imagine the user is standing facing the front of a structure and is further directed to use the user interface to attempt to move the parts to build the structure to have dimensional ratios specified by the drawing exercise.

20. The computer memory of claim 14, wherein the user interactive exercises include a route recreation exercise in which the user:
is directed to view an image generated by the route recreation exercise including separate boxes, each of the boxes containing indicators arranged in multiple rows;
is directed to view a pattern located in a middle box of the separate boxes for a first time, wherein the pattern is composed of line segments connecting several of the indicators;
is directed to imagine the middle box with the pattern flipped over in at least one direction and interacts with the user interface to attempt to draw the pattern as if the pattern were flipped over in the at least one direction.

21. A computer system comprising a user interface, one or more processors and one or more memories, wherein the computer system is configured to:
execute user interactive exercises involving the use of visual acuity skills, operational thinking skills and behavioral skills of a user;
for each user interactive exercise, measure and record performance data related to timing and accuracy of user inputs; and
process the performance data to generate scores in assessment categories that provide measurements of the visual acuity skills, operational thinking skills and behavioral skills of the user.

22. The computer system of claim 21, wherein the performance data comprises information for:
making suggestions for developing visual acuity skills, operational thinking skills and behavioral skills of the user; and
making observations related to the visual acuity skills, operational thinking skills and behavioral characteristics of the user.

23. The computer system of claim 21, wherein the user interface comprises a touch screen.

24. The computer system of claim 21, wherein the user interface comprises a touch screen, and wherein the user interactive exercises include a reaction and placement exercise configured to:
instruct the user to place a left finger or left stylus a left finger starting icon displayed on the touch screen and place a right finger or right stylus on a right finger starting icon displayed on the touch screen;
display a set of additional icons generated by the reaction and placement exercise, wherein the set of additional icons includes one or more matching icons that match the left finger starting icon and/or the right finger starting icon;
instruct the user to touch the one or more matching icons with at least one of the left finger or left stylus and the right finger or right stylus in response to the one or more matching icons appearing on the touch screen; and
receive user inputs from the user attempting to touch the one or more matching icons with at least one of the left finger or left stylus and the right finger or right stylus.

25. The computer system of claim 24, wherein the performance data comprises data measured and recorded during execution of the reaction and placement exercise, and wherein the data measured and recorded during execution of the reaction and placement exercise includes: a length of time the user takes to receive instructions; a length of time the user takes to successfully touch each of the one or more matching icons; an overall length of time the user takes to successfully match all of the one or more matching icons; a number of attempts the user takes to match each of the one or more matching icons; an accuracy of each attempt made by the user to match each of the one or more matching icons; and a total accuracy of attempts made by the user to match the one or more matching icons.

26. A method of assessing performance abilities and tendencies of an athlete, comprising:
using a computer system, executing user interactive exercises involving the use of visual acuity skills, operational thinking skills and behavioral skills of an athlete;
during execution of each user interactive exercise, receiving user inputs including body movement of a user and touch interaction between the athlete and a user interface in communication with the computer system;
using the computer system, measuring and recording performance data related to timing and accuracy of the user inputs in each user interactive exercise; and
processing the performance data to generate scores in assessment categories that provide measurements of the visual acuity skills, operational thinking skills and behavioral skills of the athlete.

27. The method of claim 26, comprising:
generating a report including suggestions for developing the visual acuity skills, operational thinking skills and behavioral skills of the athlete, and observations related to the visual acuity skills, operational thinking skills and behavioral characteristics of the athlete.

28. The method of claim 26, wherein the user interface comprises a touch screen.

29. The method of claim 26, wherein the user interface comprises a touch screen, and wherein the user interactive exercises include a reaction and placement exercise in which the athlete:
is directed to place a left finger or left stylus on a left finger starting icon displayed on the touch screen and places a right finger or right stylus on a right finger starting icon displayed on the touch screen;
is directed to view a set of additional icons generated by the reaction and placement exercise, wherein the set of additional icons includes one or more matching icons that match the left finger starting icon and/or the right finger starting icon; and
is directed to attempt to touch the one or more matching icons with at least one of the left finger or left stylus and the right finger or right stylus in response to the one or more matching icons appearing on the touch screen.

30. The method of claim 29, wherein the performance data comprises data measured and recorded during execution of the reaction and placement exercise, and wherein the data measured and recorded during execution of the reaction and placement exercise includes: a length of time the athlete takes read instructions; a length of time the athlete takes to successfully touch each of the one or more matching icons; an overall length of time the athlete takes to successfully match all of the one or more matching icons; a number of attempts the athlete takes to match each of the one or more matching icons; an accuracy of each attempt made by the athlete to match each of the one or more matching icons; and a total accuracy of attempts made by the athlete to match the one or more matching icons.
